(19) United States
(12) Patent Application Publication
(10) Pub. No.: US 2011/0257898 A1
(43) Pub. Date: Oct. 20, 2011

(54) THERMAL DIFFUSIVITY MEASURING SYSTEM, CONCENTRATION OF CALORIC COMPONENT MEASURING SYSTEM, AND FLOW RATE MEASURING SYSTEM

(75) Inventor: Yasuharu Ooishi, Tokyo (JP)

(73) Assignee: YAMATAKE CORPORATION, Tokyo (JP)

(21) Appl. No.: 13/090,602

(22) Filed: Apr. 20, 2011

(30) Foreign Application Priority Data
Apr. 20, 2010 (JP) 2010-097139

(51) Int. Cl. G01K 17/00; G06F 19/00; G01F 1/00

(52) U.S. Cl. 702/23; 702/136; 702/45

(57) ABSTRACT

A thermal diffusivity measuring system including a measuring mechanism for measuring a radiation coefficient or a value for thermal conductivity for a mixed gas measured when the heater element has produced heat at a plurality of temperatures; a thermal diffusivity calculating equation storing device storing a thermal diffusivity calculating equation using the radiation coefficients or the thermal conductivities for a plurality of heat producing temperatures as independent variables and uses the thermal diffusivity as the dependent variable; and a thermal diffusivity calculating portion calculating a value for the thermal diffusivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the thermal diffusivity calculating equation.

### CROSS REFERENCE TO RELATED APPLICATIONS

The present application claims priority under 35 U.S.C. §119 to Japanese Patent Application No. 2010-097139, filed Apr. 20, 2010, which is incorporated herein by reference.

### FIELD OF TECHNOLOGY

The present invention relates to a thermal diffusivity measuring system, a concentration of caloric component measuring system, and a flow rate measuring system in relation to a gas inspection technology.

### BACKGROUND OF THE INVENTION

Conventionally, it has been necessary to use costly gas chromatography equipment, or the like, to analyze the compliments of a mixed gas when calculating the amount of heat production of a mixed gas. Additionally, there have been proposals for a method for calculating the amount of heat production from a mixed gas by calculating the ratio of methane (CH₄), propane (C₃H₈), nitrogen (N₂), and carbon dioxide gas (CO₂) components included in the mixed gas through measuring the thermal conductivity of the mixed gas and the speed of sound in the mixed gas (See, for example, Japanese Examined Patent Application Publication 2004-514138 (“JP '138”). However, the method disclosed in JP '138 requires a costly speed-of-sound sensor to measure the speed of sound, in addition to a sensor for measuring the thermal conductivity. Because of this, measuring the amount of heat production by a mixed gas has not been easy.

Conventionally, not only has the measurement of the amount of heat production of a mixed gas been difficult, but also the measurement of properties of a mixed gas, such as the thermal diffusivity and the concentration of caloric component, and the like, has been difficult as well. Given this, the object of the present invention is to provide a thermal diffusivity measuring system, a concentration of caloric component measuring system, and a flow rate measuring system wherein the characteristics of a gas can be measured easily.

### SUMMARY OF THE INVENTION

A form of the present invention provides a thermal diffusivity calculating equation generating system that includes (a) a heater element for heating each of a plurality of mixed gases; (b) a measuring mechanism for measuring a radiation coefficient or a value for thermal conductivity for each of the plurality of mixed gases when the heater element has produced heat at a plurality of heat producing temperatures; and (c) a thermal diffusivity calculating equation generating portion for generating a thermal diffusivity calculating equation, based on known values for the thermal diffusivities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the thermal diffusivity as the dependent variable.

Another form of the present invention provides a method for generating a thermal diffusivity calculating equation having the steps of preparing a plurality of mixed gases including gas components of a plurality of types; measuring a radiation coefficient or a value for thermal conductivity for each of the plurality of mixed gases when the heater element has produced heat at a plurality of heat producing temperatures; and generating a thermal diffusivity calculating equation, based on known values for the thermal diffusivities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the thermal diffusivity as the dependent variable.

Another form of the present invention provides a thermal diffusivity measuring system, including (a) a measuring mechanism for measuring a radiation coefficient or a value for thermal conductivity for a mixed gas being measured when the heater element has produced heat at a plurality of heat producing temperatures; (b) a thermal diffusivity calculating equation storing device for storing a thermal diffusivity calculating equation that uses the radiation coefficients or the thermal conductivities for a plurality of heat producing temperatures as independent variables and uses the thermal diffusivity as the dependent variable; and (c) a thermal diffusivity calculating portion for calculating a value for the thermal diffusivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the thermal diffusivity calculating equation.

Another form of the present invention provides a method for measuring a thermal diffusivity, having the steps of measuring a radiation coefficient or a value for thermal conductivity for a mixed gas being measured when the heater element has produced heat at a plurality of heat producing temperatures; preparing a thermal diffusivity calculating equation that uses the radiation coefficients or the thermal conductivities for a plurality of heat producing temperatures as independent variables and uses the thermal diffusivity as the dependent variable; and calculating a value for the thermal diffusivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the thermal diffusivity calculating equation.

Another form of the present invention provides a flow rate measuring system having (a) a measuring mechanism for measuring a radiation coefficient or a value for thermal conductivity for a mixed gas being measured when the heater element has produced heat at a plurality of heat producing temperatures; (b) a thermal diffusivity calculating equation storing device for storing a thermal diffusivity calculating equation that uses the radiation coefficients or the thermal conductivities for a plurality of heat producing temperatures as independent variables and uses the thermal diffusivity as the dependent variable; (c) a thermal diffusivity calculating portion for calculating a value for the thermal diffusivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the thermal diffusivity calculating equation; (d) a flow rate sensor, for detecting a flow rate of a mixed gas being measured, calibrated using a calibration gas; and (e) a correcting portion for correcting detection error in the flow rate due to a difference between the value for the thermal diffusivity of the calibration gas and the value for the thermal diffusivity of the mixed gas being measured.

Another form of the present invention provides a method for measuring a flow rate, including the steps of measuring a radiation coefficient or a value for thermal conductivity for a mixed gas being measured when the heater element has produced heat at a plurality of heat producing temperatures; preparing a thermal diffusivity calculating equation that uses the radiation coefficients or the thermal conductivities for a plurality of heat producing temperatures as independent variables and uses the thermal diffusivity as the dependent variable; calculating a value for the thermal diffusivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the thermal diffusivity calculating equation; detecting a flow rate of a mixed gas being measured, by a flow rate sensor that is calibrated using a calibration gas; and correcting the detection error in the flow rate due to a difference between the value for the thermal diffusivity of the calibration gas and the value for the thermal diffusivity of the mixed gas being measured.

Another form of the present invention provides a thermal diffusivity calculating equation generating system, having (a) containers for the injection of each of a plurality of mixed gases; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of each of a plurality of mixed gases, and a value for an electric signal from a heater element at each of a plurality of heat producing temperatures; and (e) a thermal diffusivity calculating equation generating portion for generating a thermal diffusivity calculating equation, based on known values for the thermal diffusivities for a plurality of mixed gases, on a value of an electric signal from a temperature measuring element, and on values for electric signals from a heater element at a plurality of heat producing temperatures, using the electric signal from the temperature measuring element and the electric signals from the heater element at the plurality of heat producing temperatures as independent variables and using the thermal diffusivity as the dependent variable.

Another form of the present invention provides a method for generating a thermal diffusivity calculating equation, including the steps of preparing a plurality of mixed gases; acquiring a value for an electric signal from a temperature measuring element that is dependent on the temperature of each of a plurality of mixed gases; causing the heater elements that are in contact with each of the plurality of mixed gases to produce heat at a plurality of heat producing temperatures; acquiring a value for an electric signal from a heater element at each of a plurality of heat producing temperatures; and generating a thermal diffusivity calculating equation, based on known values for the thermal diffusivities for a plurality of mixed gases, on a value of an electric signal from a temperature measuring element, and on values for electric signals from a heater element at a plurality of heat producing temperatures, using the electric signal from the temperature measuring element and the electric signals from the heater element at the plurality of heat producing temperatures as independent variables and using the thermal diffusivity as the dependent variable.

Another form of the present invention provides a thermal diffusivity measuring system, having (a) a container for the injection of a mixed gas being measured for which the thermal diffusivity is unknown; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of a mixed gas being measured, and a value for an electric signal from a heater element at each of a plurality of heat producing temperatures; (e) a thermal diffusivity calculating equation storing device for storing a thermal diffusivity calculating equation that uses an electric signal from a temperature measuring element and electric signals from a heater element at a plurality of heat producing temperatures as independent variables and uses the thermal diffusivity as the dependent variable; and (f) a thermal diffusivity calculating portion for calculating the value for the thermal diffusivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation.

Another form of the present invention provides a method for measuring a thermal diffusivity, having the steps of preparing a plurality of a mixed gas being measured for which the thermal diffusivity is unknown; acquiring a value for an electric signal from a temperature measuring element that is dependent on the temperature of a mixed gas being measured; causing the heater element that is in contact with a mixed gas being measured to produce heat at a plurality of heat producing temperatures; acquiring a value for an electric signal from a heater element at each of a plurality of heat producing temperatures; preparing a thermal diffusivity calculating equation that uses an electric signal from a temperature measuring element and electric signals from a heater element at a plurality of heat producing temperatures as independent variables and uses the thermal diffusivity as the dependent variable; and calculating the value for the thermal diffusivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation.

Another form of the present invention provides a flow rate measuring system, having (a) a container for the injection of a mixed gas being measured for which the thermal diffusivity is unknown; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of a mixed gas being measured, and a value for an electric signal from a heater element at each of a plurality of heat producing temperatures; (e) a thermal diffusivity calculating equation storing device for storing a thermal diffusivity calculating equation that uses an electric signal from a temperature measuring element and electric signals from a heater element at a plurality of heat producing temperatures as independent variables and uses the thermal diffusivity as the dependent variable; (f) a thermal diffusivity calculating portion for calculating the value for the thermal diffusivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation; (g) a flow rate sensor, for detecting a flow rate of a mixed gas being measured, calibrated using a calibration gas; and (h) a correcting portion for correcting detection error in the flow rate due to a difference between the value for the thermal diffusivity of the calibration gas and the value for the thermal diffusivity of the mixed gas being measured.

Another form of the present invention provides a method for measuring a flow rate, including the steps of (a) the preparation of a plurality of a mixed gas being measured for which the thermal diffusivity is unknown; (b) the acquisition of a value for an electric signal from a temperature measuring element that is dependent on the temperature of a mixed gas being measured; (c) the heater element that is in contact with a mixed gas being measured being caused to produce heat at a plurality of heat producing temperatures; (d) the acquisition of a value for an electric signal from a heater element at each of a plurality of heat producing temperatures; (e) the preparation of a thermal diffusivity calculating equation that uses an electric signal from a temperature measuring element and electric signals from a heater element at a plurality of heat producing temperatures as independent variables and uses the thermal diffusivity as the dependent variable; (f) the calculation of the value for the thermal diffusivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation; (g) the detection of a flow rate of a mixed gas being measured, by a flow rate sensor that is calibrated using a calibration gas; and (h) the correction of detection error in the flow rate due to a difference between the value for the thermal diffusivity of the calibration gas and the value for the thermal diffusivity of the mixed gas being measured.

Another form of the present invention provides a concentration of caloric component calculating equation generating system, having (a) a heater element for heating each of a plurality of mixed gases; (b) a measuring mechanism for measuring a radiation coefficient or a value for thermal conductivity for each of the plurality of mixed gases when the heater element has produced heat at a plurality of heat producing temperatures; and (c) a concentration of caloric component calculating equation generating portion for generating a concentration of caloric component calculating equation, based on known values for the caloric component densities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the concentration of caloric component as the dependent variable.

Another form of the present invention provides a method for generating a concentration of caloric component calculating equation, having the steps of preparing a plurality of mixed gases including gas components of a plurality of types; measuring a radiation coefficient or a value for thermal conductivity for each of the plurality of mixed gases when the heater element has produced heat at a plurality of heat producing temperatures; and generating a concentration of caloric component calculating equation, based on known values for the caloric component densities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the concentration of caloric component as the dependent variable.

Another form of the present invention provides a concentration of caloric component measuring system, including a measuring mechanism for measuring a radiation coefficient or a value for thermal conductivity for a mixed gas being measured when the heater element has produced heat at a plurality of heat producing temperatures; a concentration of caloric component calculating equation storing device for storing a concentration of caloric component calculating equation that uses the radiation coefficients or the thermal conductivities for a plurality of heat producing temperatures as independent variables and uses the caloric component as the dependent variable; and a concentration of caloric component calculating portion for calculating a value for the concentration of caloric component of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the concentration of caloric component calculating equation.

Another form of the present invention provides a method for measuring a concentration of caloric component, having the steps of measuring a radiation coefficient or a value for thermal conductivity for a mixed gas being measured when the heater element has produced heat at a plurality of heat producing temperatures; preparing a concentration of caloric component calculating equation that uses the radiation coefficients or the thermal conductivities for a plurality of heat producing temperatures as independent variables and uses the concentration of caloric component as the dependent variable; and calculating a value for the concentration of caloric component of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the concentration of caloric component calculating equation.

Another form of the present invention provides a flow rate measuring system, including (a) a measuring mechanism for measuring a radiation coefficient or a value for thermal conductivity for a mixed gas being measured when the heater element has produced heat at a plurality of heat producing temperatures; (b) a concentration of caloric component calculating equation storing device for storing a concentration of caloric component calculating equation that uses the radiation coefficients or the thermal conductivities for a plurality of heat producing temperatures as independent variables and uses the caloric component as the dependent variable; (c) a concentration of caloric component calculating portion for calculating a value for the concentration of caloric component of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the concentration of caloric component calculating equation; (d) a flow rate sensor, for detecting a flow rate of the mixed gas being measured; and (e) a calorific flow rate calculating portion for calculating the flow rate of a caloric component in the mixed gas being measured, based on a detection value for the flow rate of the mixed gas being measured and a calculated value for the concentration of caloric component of the mixed gas being measured.

Another form of the present invention provides a method for measuring a flow rate, including the steps of (a) the measurement of a radiation coefficient or a value for thermal conductivity for a mixed gas being measured when the heater element has produced heat at a plurality of heat producing temperatures; (b) the preparation of a concentration of caloric component calculating equation that uses the radiation coefficients or the thermal conductivities for a plurality of heat producing temperatures as independent variables and uses the concentration of caloric component as the dependent variable; (c) the calculation of a value for the concentration of caloric component of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the concentration of caloric component calculating equation; (d) the detection of the flow rate of the mixed gas being measured; and (e) the calculation of the flow rate of a caloric component in the mixed gas being measured, based on a detection value for the flow rate of the mixed gas being measured and a calculated value for the concentration of caloric component of the mixed gas being measured.

Another form of the present invention provides a concentration of caloric component calculating equation generating system, having (a) containers for the injection of each of a plurality of mixed gases; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of each of a plurality of mixed gases, and a value for an electric signal from a heater element at each of a plurality of heat producing temperatures; and (e) a concentration of caloric component calculating equation generating portion for generating a concentration of caloric component calculating equation, based on known values for the caloric component densities for a plurality of mixed gases, on a value of an electric signal from a temperature measuring element, and on values for electric signals from a heater element at a plurality of heat producing temperatures, using the electric signal from the temperature measuring element and the electric signals from the heater element at the plurality of heat producing temperatures as independent variables and using the concentration of caloric component as the dependent variable.

Another form of the present invention provides a method for generating a concentration of caloric component calculating equation, having the steps of (a) preparing a plurality of mixed gases; (b) acquiring a value for an electric signal from a temperature measuring element that is dependent on the temperature of each of a plurality of mixed gases; (c) causing the heater elements that are in contact with each of the plurality of mixed gases to produce heat at a plurality of heat producing temperatures; (d) acquiring a value for an electric signal from a heater element at each of a plurality of heat producing temperatures; and (e) generating a concentration of caloric component calculating equation, based on known values for the caloric component densities for a plurality of mixed gases, on a value of an electric signal from a temperature measuring element, and on values for electric signals from a heater element at a plurality of heat producing temperatures, using the electric signal from the temperature measuring element and the electric signals from the heater element at the plurality of heat producing temperatures as independent variables and using the concentration of caloric component as the dependent variable.

Another form of the present invention provides a concentration of caloric component measuring system, including a container for the injection of a mixed gas being measured for which the concentration of caloric component is unknown; a temperature measuring element disposed in the container; a heater element, disposed in the container, for producing heat at a plurality of heat producing temperatures; a measuring portion for measuring a value for an electric signal from a temperature measuring element that is dependent on the temperature of a mixed gas being measured, and a value for an electric signal from a heater element at each of a plurality of heat producing temperatures; a concentration of caloric component calculating equation storing device for storing a concentration of caloric component calculating equation that uses an electric signal from a temperature measuring element and electric signals from a heater element at a plurality of heat producing temperatures as independent variables and uses the concentration of caloric component as the dependent variable; and a concentration of caloric component calculating portion for calculating the value for the concentration of caloric component of the mixed gas being measured by substituting the value of an electric signal from the temperature measuring element and the value of an electric signal from the heater element into the independent variable that is the electric signal from the temperature measuring element and the independent variable that is the electric signal from the heater element, in the concentration of caloric component calculating equation.

Another form of the present invention provides a method for measuring a concentration of caloric component, including the steps of preparing a plurality of a mixed gas being measured for which the concentration of caloric component is unknown; acquiring a value for an electric signal from a temperature measuring element that is dependent on the temperature of a mixed gas being measured; causing the heater element that is in contact with a mixed gas being measured being caused to produce heat at a plurality of heat producing temperatures; acquiring a value for an electric signal from a heater element at each of a plurality of heat producing temperatures; preparing a concentration of caloric component calculating equation that uses an electric signal from a temperature measuring element and electric signals from a heater element at a plurality of heat producing temperatures as independent variables and uses the concentration of caloric component as the dependent variable; and calculating the value for the concentration of caloric component of the mixed gas being measured by substituting the value of an electric signal from the temperature measuring element and the value of an electric signal from the heater element into the independent variable that is the electric signal from the temperature measuring element and the independent variable that is the electric signal from the heater element, in the concentration of caloric component calculating equation.

Another form of the present invention provides a flow rate measuring system, having a container for the injection of a mixed gas being measured for which the concentration of caloric component is unknown; a temperature measuring element disposed in the container; a heater element, disposed in the container, for producing heat at a plurality of heat producing temperatures; a measuring portion for measuring a value for an electric signal from a temperature measuring element that is dependent on the temperature of a mixed gas being measured, and a value for an electric signal from a heater element at each of a plurality of heat producing temperatures; a concentration of caloric component calculating equation storing device for storing a concentration of caloric component calculating equation that uses an electric signal from a temperature measuring element and electric signals from a heater element at a plurality of heat producing temperatures as independent variables and uses the concentration of caloric component as the dependent variable; a concentration of caloric component calculating portion for calculating the value for the concentration of caloric component of the mixed gas being measured by substituting the value of an electric signal from the temperature measuring element and the value of an electric signal from the heater element into the independent variable that is the electric signal from the temperature measuring element and the independent variable that is the electric signal from the heater element, in the concentration of caloric component calculating equation; and a flow rate sensor, for detecting a flow rate of the mixed gas being measured; and a calorific flow rate calculating portion for calculating the flow rate of a caloric component in the mixed gas being measured, based on a detection value for the flow rate of the mixed gas being measured and a calculated value for the concentration of caloric component of the mixed gas being measured.

Another form of the present invention provides a method for measuring a flow rate, having the steps of preparing a plurality of a mixed gas being measured for which the concentration of caloric component is unknown; acquiring a value for an electric signal from a temperature measuring element that is dependent on the temperature of a mixed being measured; causing the heater element that is in contact with a mixed gas being measured being caused to produce heat at a plurality of heat producing temperatures; acquiring a value for an electric signal from a heater element at each of a plurality of heat producing temperatures; preparing a concentration of caloric component calculating equation that uses an electric signal from a temperature measuring element and electric signals from a heater element at a plurality of heat producing temperatures as independent variables and uses the concentration of caloric component as the dependent variable; calculating the value for the concentration of caloric component of the mixed gas being measured by substituting the value of an electric signal from the temperature measuring element and the value of an electric signal from the heater element into the independent variable that is the electric signal from the temperature measuring element and the independent variable that is the electric signal from the heater element, in the concentration of caloric component calculating equation; detecting the flow rate of the mixed gas being measured; and calculating the flow rate of a caloric component in the mixed gas being measured, based on a detection value for the flow rate of the mixed gas being measured and a calculated value for the concentration of caloric component of the mixed gas being measured.

Another form of the present invention provides a specific heat capacity calculating equation generating system, having:

(a) a heater element for heating each of a plurality of mixed gases;

(b) a measuring mechanism for measuring a radiation coefficient or a value for thermal conductivity for each of the plurality of mixed gases when the heater element has produced heat at a plurality of heat producing temperatures; and

(c) a specific heat capacity calculating equation generating portion for generating a specific heat capacity calculating equation, based on known values for specific heat capacities divided by thermal conductivities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the specific heat capacity divided by the thermal conductivity as the dependent variable.

Another form of the present invention provides a method for generating a specific heat capacity calculating equation, having the steps of:

(a) the preparation of a plurality of mixed gases including gas components of a plurality types;

(b) the measurement of a radiation coefficient or a value for thermal conductivity for each of the plurality of mixed gases when the heater element has produced heat at a plurality of heat producing temperatures; and

(c) the generation of a specific heat capacity calculating equation, based on known values for specific heat capacities divided by thermal conductivities for each of a plurality of mixed gases and on values for radiation coefficients and thermal conductivities measured at a plurality of heat producing temperatures, using the radiation coefficients or the thermal conductivities for the plurality of heat producing temperatures as independent variables and using the specific heat capacity divided by the thermal conductivity as the dependent variable.

Another form of the present invention provides a specific heat capacity measuring system, including:

(a) a measuring mechanism for measuring a radiation coefficient or a value for thermal conductivity for a mixed gas being measured when the heater element has produced heat at a plurality of heat producing temperatures;

(b) a specific heat capacity calculating equation storing device for storing a specific heat capacity calculating equation that uses the radiation coefficients or the thermal conductivities for a plurality of heat producing temperatures as independent variables and uses the specific heat capacity, divided by the thermal conductivity, as the dependent variable; and

(c) a specific heat capacity calculating portion for calculating a value for the specific heat capacity divided by the thermal conductivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the specific heat capacity calculating equation.

Another form of the present invention provides a method for measuring a specific heat capacity, including the steps of:

(a) the measurement of a radiation coefficient or a value for thermal conductivity for a mixed gas being measured when the heater element has produced heat at a plurality of heat producing temperatures;

(b) the preparation of a specific heat capacity calculating equation that uses the radiation coefficients or the thermal conductivities for a plurality of heat producing temperatures as independent variables and uses the specific heat capacity, divided by the thermal conductivity, as the dependent variable; and

(c) the calculation of a value for the specific heat capacity divided by the thermal conductivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the specific heat capacity calculating equation.

Another form of the present invention provides a flow rate measuring system, having (a) a measuring mechanism for measuring a radiation coefficient or a value for thermal conductivity for a mixed gas being measured when the heater element has produced heat at a plurality of heat producing temperatures; (b) a specific heat capacity calculating equation storing device for storing a specific heat capacity calculating equation that uses the radiation coefficients or the thermal conductivities for a plurality of heat producing temperatures as independent variables and uses the specific heat capacity, divided by the thermal conductivity, as the dependent variable; (c) a specific heat capacity calculating portion for calculating a value for the specific heat capacity divided by the thermal conductivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the specific heat capacity calculating equation; (d) a flow rate sensor, for detecting a volumetric flow rate of the mixed gas being measured; and (e) a mass flow rate calculating portion for calculating a mass flow rate of the gas being measured, based on the calculated value for the specific heat capacity divided by the thermal conductivity and the detected value for the volumetric flow rate of the mixed gas being measured.

Another form of the present invention provides a method for measuring a flow rate, having the steps of (a) measuring a radiation coefficient or a value for thermal conductivity for a mixed gas being measured when the heater element has produced heat at a plurality of heat producing temperatures; (b) preparing a specific heat capacity calculating equation that uses the radiation coefficients or the thermal conductivities for a plurality of heat producing temperatures as independent variables and uses the specific heat capacity, divided by the thermal conductivity, as the dependent variable; (c) calculating a value for the specific heat capacity divided by the thermal conductivity of the mixed gas being measured through substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the specific heat capacity calculating equation; (d) detecting the volumetric flow rate of the mixed gas being measured; and (e) calculating a mass flow rate of the gas being measured, based on the calculated value for the specific heat capacity divided by the thermal conductivity and the detected value for the volumetric flow rate of the mixed gas being measured.

Another form of the present invention provides a specific heat capacity calculating equation generating system, including:

(a) containers for the injection of each of a plurality of mixed gases;

(b) a temperature measuring element disposed in the container;

(c) a heater element, disposed in the container, for producing heat at a plurality of heat producing temperatures;

(d) a measuring portion for measuring a value for an electric signal from a temperature measuring element that is dependent on the temperature of each of a plurality of mixed gases, and a value for an electric signal from a heater element at each of a plurality of heat producing temperatures; and

(e) a specific heat capacity calculating equation generating portion for generating a specific heat capacity calculating equation, based on known values for the specific heat capacities divided by thermal conductivities for a plurality of mixed gases, on a value of an electric signal from a temperature measuring element, and on values for electric signals from a heater element at a plurality of heat producing temperatures, using the electric signal from the temperature measuring element and the electric signals from the heater element at the plurality of heat producing temperatures as independent variables and using the specific heat capacity divided by the thermal conductivity as the dependent variable.

Another form of the present invention provides a method for generating a specific heat capacity calculating equation, utilizing (a) the preparation of a plurality of mixed gases; (b) the acquisition of a value for an electric signal from a temperature measuring element that is dependent on the temperature of each of a plurality of mixed gases; (c) the heater elements that are in contact with each of the plurality of mixed gases being caused to produce heat at a plurality of heat producing temperatures; (d) the acquisition of a value for an electric signal from a heater element at each of a plurality of heat producing temperatures; and (e) the generation of a specific heat capacity calculating equation, based on known values for the specific heat capacities divided by thermal conductivities for a plurality of mixed gases, on a value of an electric signal from a temperature measuring element, and on values for electric signals from a heater element at a plurality of heat producing temperatures, using the electric signal from the temperature measuring element and the electric signals front the heater element at the plurality of heat producing temperatures as independent variables and using the specific heat capacity divided by the thermal conductivity as the dependent variable.

Another form of the present invention provides a specific heat capacity measuring system, including (a) a container for the injection of a mixed gas being measured for which the specific heat capacity divided by the thermal conductivity is unknown; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of a mixed gas being measured, and a value for an electric signal from a heater element at each of a plurality of heat producing temperatures; (e) a specific heat capacity calculating equation storing device for storing a specific heat capacity calculating equation that uses an electric signal from a temperature measuring element and electric signals from a heater element at a plurality of heat producing temperatures as independent variables and uses the specific heat capacity divided by the thermal conductivity as the dependent variable; and (f) a specific heat capacity calculating portion for calculating the value for the specific heat capacity divided by the thermal conductivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation.

Another form of the present invention provides a method for measuring a specific heat capacity, having the steps of preparing a plurality of a mixed gas being measured for which the specific heat has to divided by the thermal conductivity is unknown; acquiring a value for an electric signal from a temperature measuring element that is dependent on the temperature of a mixed gas being measured; causing the heater element that is in contact with a mixed gas being measured being caused to produce heat at a plurality of heat producing temperatures; acquiring a value for an electric signal from a heater element at each of a plurality of heat producing temperatures; preparing a specific heat capacity calculating equation that uses an electric signal from a temperature measuring element and electric signals from a heater element at a plurality of heat producing temperatures as independent variables and uses the specific heat capacity divided by the thermal conductivity as the dependent variable; and calculating the value for the specific heat capacity divided by the thermal conductivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation.

Another form of the present invention provides a flow rate measuring system, having (a) a container for the injection of a mixed gas being measured for which the specific heat capacity divided by the thermal conductivity is unknown; (b) a temperature measuring element disposed in the container; (c) a heater element, disposed in the container, for producing heat at a plurality of heat producing temperatures; (d) a measuring portion for measuring a value for an electric signal from a temperature measuring element that is dependent on the temperature of a mixed gas being measured, and a value for an electric signal from a heater element at each of a plurality of heat producing temperatures; (e) a specific heat capacity calculating equation storing device for storing a specific heat capacity calculating equation that uses an electric signal from a temperature measuring element and electric signals from a heater element at a plurality of heat producing temperatures as independent variables and uses the specific heat capacity divided by the thermal conductivity as the dependent variable; (f) a specific heat capacity calculating portion for calculating the value for the specific heat capacity divided by the thermal conductivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation; (g) a flow rate sensor, for detecting a volumetric flow rate of the mixed gas being measured; and (h) a mass flow rate calculating portion for calculating a mass flow rate of the mixed gas being measured, based on the calculated value for the specific heat capacity divided by the thermal conductivity and the detected value for the volumetric flow rate of the mixed gas being measured.

Another form of the present invention provides a method for measuring a flow rate, including (a) the preparation of a plurality of a mixed gas being measured for which the specific heat has to divided by the thermal conductivity is unknown; (b) the acquisition of a value for an electric signal from a temperature measuring element that is dependent on the temperature of a mixed gas being measured; (c) the heater element that is in contact with a mixed gas being measured being caused to produce heat at a plurality of heat producing temperatures; (d) the acquisition of a value for an electric signal from a heater element at each of a plurality of heat producing temperatures; (e) the preparation of a specific heat capacity calculating equation that uses an electric signal from a temperature measuring element and electric signals from a heater element at a plurality of heat producing temperatures as independent variables and uses the specific heat capacity divided by the thermal conductivity as the dependent variable; (f) the calculation of the value for the specific heat capacity divided by the thermal conductivity of the mixed gas being measured by substituting the value of an electric signal from the temperature measuring element and the value of an electric signal from the heater element into the independent variable that is the electric signal from the temperature measuring element and the independent variable that is the electric signal from the heater element, in the thermal diffusivity calculating equation; (g) the detection of the volumetric flow rate of the mixed gas being measured; and (h) the calculation of a mass flow rate of the gas being measured, based on the calculated value for the specific heat capacity divided by the thermal conductivity and the detected value for the volumetric flow rate of the mixed gas being measured.

The present invention provides a thermal diffusivity measuring system, a concentration of caloric component measuring system, and a flow rate measuring system wherein the characteristics of a mixed gas can be measured easily.

### BRIEF DESCRIPTION OF THE DRAWINGS

FIG. 1 is a perspective view of a microchip as set forth in an example according to the present invention.

FIG. 2 is a cross-sectional diagram, viewed from the direction of the section II-II, of the microchip according to the present invention.

FIG. 3 is a circuit diagram relating to a heater element according to and example.

FIG. 4 is a circuit diagram relating to a temperature measuring element according to the present invention.

FIG. 5 is a graph illustrating the relationship between the heat producing temperature of the heater element and the radiation coefficient of the gas in the example.

FIG. 6 is a first schematic diagram of a thermal diffusivity calculating equation generating system as set forth in the present invention.

FIG. 7 is a second schematic diagram of a thermal diffusivity calculating equation generating system as set forth in the example.

FIG. 8 is a flowchart illustrating a method for generating a thermal diffusivity calculating equation as set forth in the present invention.

FIG. 9 is a schematic diagram illustrating a thermal diffusivity measuring system as set forth in another example according to the present invention.

FIG. 10 is a flowchart illustrating a method for measuring a thermal diffusivity according to the present invention.

FIG. 11 is a table showing the compositions of sample mixed gases used in examples of embodiment relating to the present invention.

FIG. 12 is a table showing the true values and calculated values for the inverses of the thermal diffusivities for the sample mixed gases used in the examples according to the present invention.

FIG. 13 is a graph illustrating the true values and calculated values for the inverses of the thermal diffusivities for the sample mixed gases used in the examples according to the present invention.

FIG. 14 is a schematic diagram of a thermal diffusivity calculating equation generating system as set forth in a further example according to the present invention.

FIG. 15 is a schematic diagram illustrating a thermal diffusivity measuring system as set forth in another example according to the present invention.

FIG. 16 is a schematic diagram of a concentration of caloric component calculating equation generating system as set forth in a yet further example according to the present invention.

FIG. 17 is a flowchart illustrating a method for generating a concentration of caloric component calculating equation as set forth in a yet further example according to the present invention.

FIG. 18 is a schematic diagram of a concentration of caloric component measuring system as set forth in a an example according to the present invention.

FIG. 19 is a flowchart illustrating a method for measuring a concentration of caloric component as set forth in the example according to the present invention.

FIG. 20 is a table showing the compositions of sample mixed gases used in examples according to the present invention.

FIG. 21 is a table showing the true values and calculated values for the alkane densities in the sample mixed gases used in the examples according to the present invention.

FIG. 22 is a graph illustrating the true values and calculated values for the alkane densities in the sample mixed gases used in the examples according to the present invention.

FIG. 23 is a schematic diagram of a concentration of caloric component calculating equation generating system as set forth according to the present invention.

FIG. 24 is a schematic diagram of a concentration of caloric component measuring system as set forth in an example according to the present invention.

FIG. 25 is a schematic diagram of a specific heat capacity calculating equation generating system as set forth in another example according to the present invention.

FIG. 26 is a flowchart illustrating a method for generating a specific heat capacity calculating equation as set forth in a further example according to the present invention.

FIG. 27 is a schematic diagram of a specific heat capacity measuring system as set forth in yet another example according to the present invention.

FIG. 28 is a flowchart illustrating a method for measuring a specific heat capacity as set forth according to the present invention.

FIG. 29 is a table showing the true values and calculated values for specific heat capacities divided by the thermal conductivities in the sample mixed gases used in the examples according to the present invention.

FIG. 30 is a graph illustrating the true values and calculated values for specific heat capacities divided by the thermal conductivities in the sample mixed gases used in the examples according to the present invention.

FIG. 31 is a schematic diagram of a specific heat capacity calculating equation generating system as set forth in an example according to the present invention.

FIG. 32 is a schematic diagram of a specific heat capacity measuring system as set forth in another example.

FIG. 33 is a schematic diagram of a flow rate measuring system as set forth in a further example.

FIG. 34 is a schematic diagram of a flow meter as set forth in the further example.

FIG. 35 is a perspective view of a microchip as set forth in the further example.

FIG. 36 is a cross-sectional diagram, viewed from the direction of the section XXXVI-XXXVI, of the microchip as set forth in the further example according to the present invention.

FIG. 37 is a table showing the compositions of mixed gases used in the present invention.

FIG. 38 is a table showing the flow rate detection errors for the mixed gases used in the present invention.

FIG. 39 is a graph illustrating the flow rate detection errors for the mixed gases used in the present invention.

FIG. 40 is a schematic diagram of a flow rate measuring system as set forth in yet another example according to the present invention.

FIG. 41 is a schematic diagram of a flow rate measuring system as set forth in an example according to the present invention.

FIG. 42 is a schematic diagram of a flow meter as set forth in the example according to the present invention.

FIG. 43 is a schematic diagram of a flow rate measuring system as set forth in a further example according to the present invention.

FIG. 44 is a schematic diagram of a flow rate measuring system as set forth in an example.

FIG. 45 is a schematic diagram of a flow meter as set forth in the example according to the present invention.

FIG. 46 is a schematic diagram of a flow rate measuring system as set forth in another example according to the present invention.

FIG. 47 is a graph illustrating the relationship between the radiation coefficients and thermal conductivities according to the present invention.

### DETAILED DESCRIPTION OF THE INVENTION

Examples of the present invention are described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

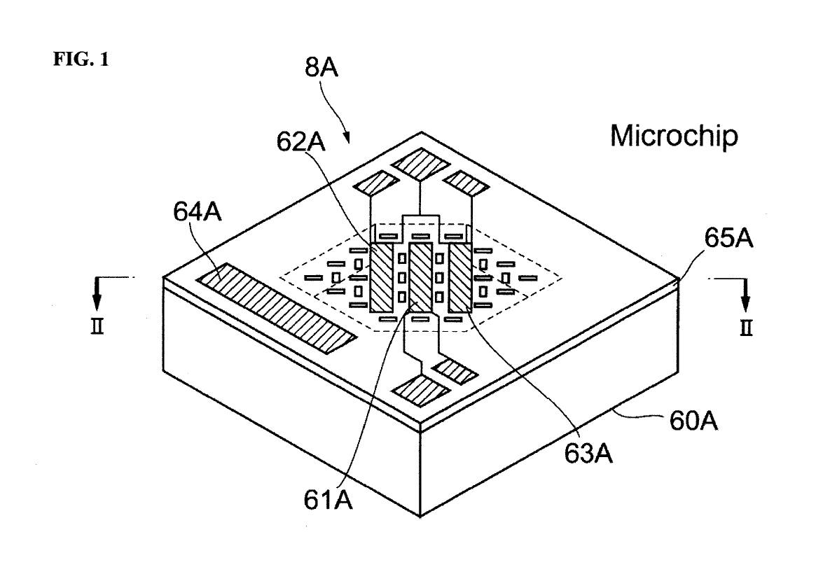

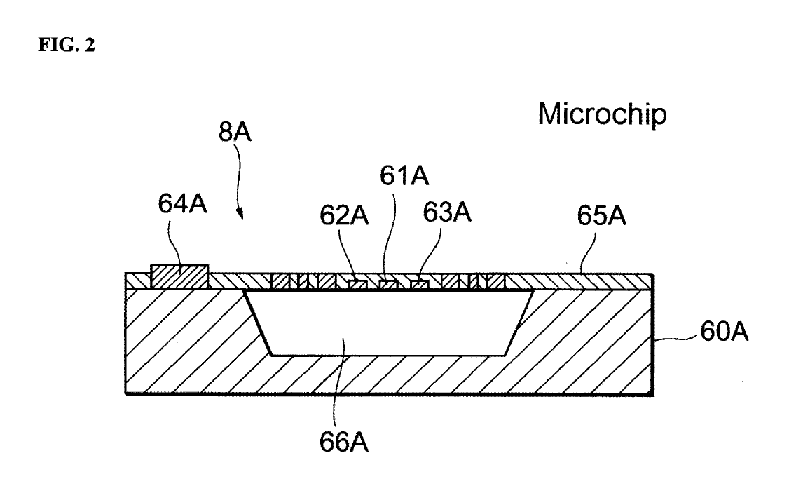

A microchip 8A that is used in a thermal diffusivity calculating equation generating system as set forth in an example is described in reference to FIG. 1, which is a perspective diagram, and FIG. 2, which is a cross-sectional diagram that is viewed from the direction of the section II-II, The microchip 8A comprises a substrate 60A, which is provided with a cavity 66A, and a dielectric layer 65A, which is disposed so as to cover the cavity 66A on the substrate 60A. The thickness of the substrate 60A is, for example, 0.5 mm. The length and width dimensions of the substrate 60A are, for example, 1.5 mm each. The portion of the dielectric layer 65A that covers the cavity 66A forms a thermally insulating diaphragm. The microchip 8A further comprises a heater element 61A that is provided on a portion of the diaphragm of the dielectric layer 65A, a first temperature measuring element 62A and a second temperature measuring element 63A provided in a portion of the diaphragm of the dielectric layer 65A so that the heater element 61A is interposed therebetween, and a third temperature measuring element 64A that is provided on the substrate 60A.

The heater element 61A is disposed in the center of the portion of the diaphragm of the dielectric layer 65A that covers the cavity 66A. The heater element 61A is, for example, a resistor, and produces heat through the supply of electric power thereto, to heat the ambient gas that contacts the heater element 61A. The first temperature measuring element 62A, the second temperature measuring element 63A, and the third temperature measuring element 64A are, for example, each resistors and each detect the gas temperature of the ambient gas prior to the production of heat by the heater element 61A. Note that the gas temperature may be measured using any single one of the first temperature measuring element 62A, the second temperature measuring element 63A, or the third temperature measuring element 64A. Conversely, an average value of the gas temperature detected by the first temperature measuring element 62A and the gas temperature detected by the second temperature measuring element 63A may be used as the gas temperature. While the description below is for an example wherein the average value of the gas temperatures detected by the first temperature measuring element 62A and the second temperature measuring element 63A is used as the gas temperature, there is no limitation thereto.

Silicon (Si), or the like, may be used as the material for the substrate 60A. Silicon dioxide (SiO₂), or the like, may be used as the material for the dielectric layer 65A. The cavity 66A may be formed through anisotropic etching, or the like. Furthermore, platinum (Pt) or the like may be used as the material for the first temperature measuring element 62A, the second temperature measuring element 63A, and the third temperature measuring element 64A, and they may be formed through a lithographic method, or the like.

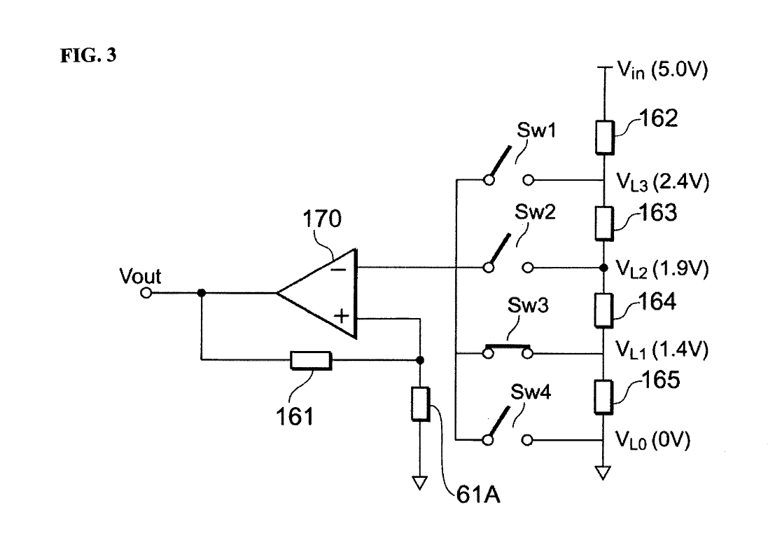

As illustrated in FIG. 3, one end of the heater element 61A is connected electrically to a + input terminal of an operational amplifier 170, for example, with the other end grounded. A resistive element 161 is connected, in parallel, to the + input terminal and the output terminal of the operational amplifier 170. The − input terminal of the operational amplifier 170 is connected electrically between a resistive element 162 and a resistive element 163, which are connected in series, between the resistive element 163 and a resistive element 164, which are connected in series, between the resistive element 164 and a resistive element 165, which are connected in series, or between the resistive element 165 and a ground terminal. The appropriate selection of the resistance values for each of the resistive elements 162 through 165 will produce a voltage V_{L3} of for example, 2.4 V between the resistive element 163 and 162 when a voltage Vin of, for example, 5.0V is applied to one end of the resistive element 162. Additionally, a voltage V_{L2} of, for example, 1.9 V is produced between the resistive element 164 and the resistive element 163, and a voltage V_{L1} of, for example, 1.4 V is produced between the resistive element 165 and the resistive element 164.

A switch SW1 is connected between the resistive element 162 and the resistive element 163 and the − input terminal of the operational amplifier 170, and a switch SW2 is connected between the resistive element 163 and the resistive element 164 and the − input terminal of the operational amplifier 170. Furthermore, a switch SW3 is connected between the resistive element 164 and the resistive element 165 and the − input terminal of the operational amplifier 170, and a switch SW4 is connected between the resistive element 165 and ground terminal and the − input terminal of the operational amplifier 170.

When applying the voltage V_{L3} of 2.4 V to the − input terminal of the operational amplifier 170, only switch SW1 is turned ON, and switches SW2, SW3, and SW4 are turned OFF. When applying the voltage V_{L2} of 1.9 V to the − input terminal of the operational amplifier 170, only switch SW2 is turned ON, and switches SW1, SW3, and SW4 are turned OFF. When applying the voltage V_{L1} of 1.4 V to the − input terminal of the operational amplifier 170, only switch SW3 is turned ON, and switches SW1, SW2, and SW4 are turned OFF. When applying the voltage V_{L0} of 0V to the − input terminal of the operational amplifier 170, only switch SW4 is turned ON, and switches SW1, SW2, and SW3 are turned OFF. Consequently, 0V and any of three levels of voltages can be applied to the − input terminal of the operational amplifier 170 through turning the switches SW1, SW2, SW3, and SW4 ON and OFF, Because of this, the applied voltage that determines the heat producing temperature of the heater element 61A can be set to any of three levels through turning the switches SW1, SW2, SW3, and SW4 ON and OFF.

In the heater element 61A illustrated in FIG. 1 and FIG. 2, the resistance value varies depending on the temperature. The relationship between the heat producing temperature T_{H} of the heater element 61A and the resistance value R_{H} of the heater element 61A is given by Equation (1), below:

R_{H}=R_{STD}×[1+α(T_{H}−T_{STD})+β(T_{H}−T_{STD})²] (1)

Here T_{STD} indicates a standard temperature of, for example, 20° C. R_{STD} indicates a resistance value that is measured in advance at the standard temperature of T_{STD}. α is the first-order temperature coefficient of resistance, and β is the second-order temperature coefficient of resistance. Moreover, the resistance value R_{H} of the heater element 61A is given by Equation (2), below, from the driving power P_{H} of the heater element 61A and the current I_{H} flowing in the heater element 61A:

R_{H}=P_{H}/I_{H}² (2)

Conversely, the resistance value R_{H} of the heater element 61A is given by Equation (3), below, from the voltage V_{H} applied to the heater element 61A and the current I_{H} flowing in the heater element 61A:

R_{H}=V_{H}/I_{H} (3)

Here the heat producing temperature T_{H} of the heater element 61A reaches a thermal equilibrium and stabilizes between the heater element 61A and the ambient gas. Note that this “thermal equilibrium” refers to a state wherein there is a balance between the heat production by the heater element 61A and the heat dissipation from the heater element 61A into the ambient gas. As indicated in Equation (4), below, radiation coefficient M_{I} of the ambient gas is obtained by dividing the driving power P_{H} of the heater element 61A by the difference between the heat producing temperature T_{H} of the heater element 61A and the temperature T_{I} of the ambient gas in this equilibrium state. Note that the units for the radiation coefficient MI are, for example, W/° C.

M_{I}=P_{H}/(T_{H}−T_{I}) (4)

Because the current I_{H} flowing in the heater element 61A and the driving power P_{H} or the voltage V_{H} can be measured, the heat producing temperature T_{H} of the heater element 61A can be calculated from Equation (1) through Equation (3), above. Moreover, the temperature T_{I} of the ambient gas can be measured by the first temperature measuring element 62A and the second temperature measuring element 63A in FIG. 1. Consequently, the radiation coefficient M_{I} can be calculated using the microchip 8A illustrated in FIG. 1 and FIG. 2.

Microchip 8A is secured, in a chamber, or the like, that is filled with the ambient gas, through, for example, a thermally insulating member that is disposed on the bottom face of the microchip 8A. Securing the microchip 8A through a thermally insulating member within a chamber, or the like, makes the temperature of the microchip 8A less susceptible to temperature variations of the inner wall of the chamber, or the like. The thermally insulating member is made from glass, or the like, with a thermal conductivity of, for example, no more than 1.0 W/(m·K).

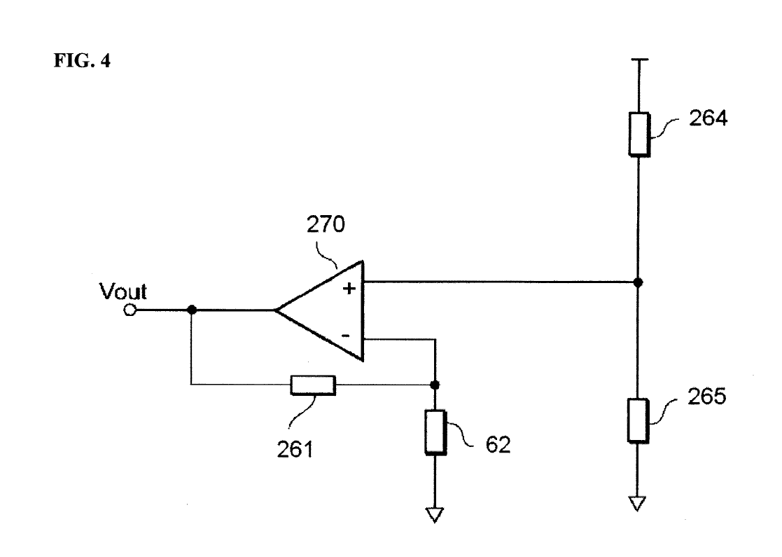

As illustrated in FIG. 4, one end of the first temperature measuring element 62A is connected electrically to a − input terminal of an operational amplifier 270, for example, with the other end grounded. A resistive element 261 is connected, in parallel, to the − input terminal and the output terminal of the operational amplifier 270. The + input terminal of the operational amplifier 270 is connected electrically to between a resistive element 264 and a resistive element 265 that are connected in series. This causes a weak voltage of about 0.3 V to be applied to the first temperature measuring element 62A. The temperature of the first temperature measuring element 62A, to which the weak voltage of about 0.3 V is applied, will approximate the ambient temperature T_{I}.

Here the ambient gas is a mixed gas, where the mixed gas is assumed to comprise four gas components: gas A, gas B, gas C, and gas D. The sum of the volume fraction V_{A} of the gas A, the volume fraction V_{B} of the gas B, the volume fraction V_{C} of the gas C, and the volume fraction V_{D} of the gas D, as given by Equation (5), below, is 1:

V_{A}+V_{B}+V_{C}+V_{D}=1 (5)

Furthermore, defining the inverse of the thermal diffusivity of the gas A as 1/K_{A}, the inverse of the thermal diffusivity of the gas B as 1/K_{B}, the inverse of the thermal diffusivity of the gas C as 1/K_{C}, and the inverse of the thermal diffusivity of the gas D as 1/K_{D}, the inverse of the thermal diffusivity of the mixed gas, 1/α, is given by the sum of the product of the inverses of the thermal diffusivities of the individual gas components. Consequently, the inverse 1/α of the thermal diffusivity of the mixed gas is given by Equation (6), below.

Note that the thermal diffusivity α (m²/s) is given by Equation (7), below, wherein k is the thermal conductivity (Js⁻¹m⁻¹K⁻¹), ρ is the density (kgm⁻³), and Cp is the specific heat capacity (Jkg⁻¹K⁻¹).

1/α=1/K_{A}×V_{A}±1/K_{B}×V_{B}+1/K_{C}×V_{C}+1/K_{D}×V_{D} (6)

α=k/(ρCp) (7)

Next, when the radiation coefficient of gas A is defined as M_{A}, the radiation coefficient of gas B is defined as M_{B}, the radiation coefficient of gas C is defined as M_{C} and the radiation coefficient of gas D is defined as M_{D}, the radiation coefficient M_{I} of the mixed gas is given by the sum of the products of the radiation coefficients of the individual gas components with the volume fractions of those gas components. Consequently, the radiation coefficient M_{I} of the mixed gas is given by Equation (8), below.

M_{I}=M_{A}×V_{A}+M_{B}V_{B}+M_{C}×V_{C}+M_{D}×V_{D} (8)

Moreover, because the radiation coefficient of the gas is dependent on the heat producing temperature T_{H} of the heater element 61A, the radiation coefficient Mₜ of the mixed gas is given by Equation (9) as a function of the heat producing temperature T_{H} of the heater element 61A:

M_{I}(T_{H})=M_{A}(T_{H})×V_{A}+M_{B}(T_{B})×V_{B}+M_{C}(T_{H})×V_{C}+M_{D}(T_{H})×V_{D} (9)

Consequently, the radiation coefficient M_{I}(T_{H1}) of the mixed gas, when the heat producing temperature of the heater element 61A is T_{H1}, is given by Equation (10), below. Moreover, the radiation coefficient M_{I}(T_{H2}) of the mixed gas, when the heat producing temperature of the heater element 61A is T_{H2}, is given by Equation (11), below, and the radiation coefficient M_{I}(T_{H3}) of the mixed gas, when the heat producing temperature of the heater element 61A is T_{H3}, is given by Equation (12), below. Note that the heat producing temperature T_{H1}, the heat producing temperature T_{H2}, and the heat producing temperature T_{H3}, are each different temperatures.

M_{I}(T_{H1})=M_{A}(T_{H1})×V_{A}+M_{B}(T_{H1})×V_{B}+M_{C}(T_{H1})×V_{C}+M_{D}(T_{H1})×V_{D} (10)

M_{I}(T_{H2})=M_{A}(T_{H2})×V_{A}+M_{B}(T_{H2})×V_{B}+M_{C}(T_{H2})×V_{C}+M_{D}(T_{H2})×V_{D} (11)

M_{I}(T_{H3})=M_{A}(T_{H3})×V_{A}+M_{B}(T_{H3})×V_{B}+M_{C}(T_{H3})×V_{C}+M_{D}(T_{H3})×V_{D} (12)

If the radiation coefficients M_{A}(T_{H}), M_{B}(T_{H}), M_{C}(T_{H}), and M_{D}(T_{H}) have non-linearity with respect to the heat producing temperature T_{H} of the heater element 61A, the aforementioned Equations (10) through (12) will have a linearly independent relationship. Moreover, even if the radiation coefficients M_{A}(T_{H}), M_{B}(T_{H}), M_{C}(T_{H}), and M_{D}(T_{H}) have linearity with respect to the heat producing temperature T_{H} of the heater element 61A, the aforementioned Equations (10) through (12) will have a linearly independent relationship if the rates of change of the radiation coefficients M_{A}(T_{H}), M_{B}(T_{H}), M_{C}(T_{H}), and M_{D}(T_{H}) of the individual gases with respect to the heat producing temperature T_{H} of the heater element 61A are different. Moreover, if Equations (10) through (12) have a linearly independent relationship, then Equation (5) and Equations (10) through (12) will have a linearly independent relationship.

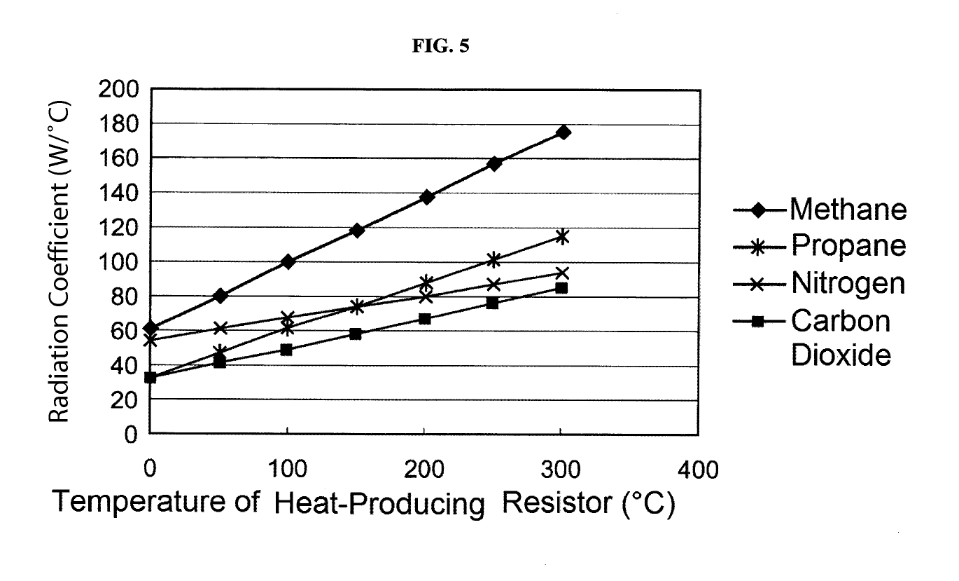

FIG. 5 is a graph illustrating the relationship between the heat producing temperature of the heater element 61A and the radiation coefficients of the methane (CH₄), propane (C₃H₈), nitrogen (N₂), and carbon dioxide (CO₂), which are included in natural gas. The radiation coefficients of the respective gas components of the methane (CH₄), propane (C₃H₈), nitrogen (N₂), and carbon dioxide (CO₂), are linear with respect to the heat producing temperature of the heater element 61A. However, the rates of change of the radiation coefficients of the methane (CH₄), propane (C₃H₈), nitrogen (N₂), and carbon dioxide (CO₂), with respect to the heat producing temperature of the heater element 61A, are each different. Consequently, Equations (10) through (12), above, will be linearly independent if the gas components that comprise the mixed gas are methane (CH₄), propane (C₃H₈), nitrogen (N₂), and carbon dioxide (CO₂).

The values for the radiation coefficients M_{A}(T_{H1}), M_{B}(T_{H1}), M_{C}(T_{H1}), M_{D}(T_{H1}), M_{A}(T_{H2}), M_{B}(T_{H2}), M_{C}(T_{H2}), M_{D}(T_{H2}), M_{A}(T_{H3}), M_{B}(T_{H3}), M_{C}(T_{H3}), and M_{D}(T_{H3}) for the individual gas components in Equations (10) through (12) can be obtained in advance through measurements, or the like. Consequently, as illustrated in Equations (13) through (16), below, the volume fraction V_{A} of the gas A, the volume fraction V_{B} of the gas B, the volume fraction V_{C} of the gas C, and the volume fraction V_{D} of the gas D, of the mixed gas can be obtained as functions of the radiation coefficients M_{I}(T_{H1}), M_{I}(T_{H2}), and M_{I}(T_{H3}), by solving the system of equations of Equation (5) and Equations (10) through (12). Note that in Equations (13) through (16), below, fn, where n is a non-negative integer, is a code indicating a function:

V_{A}=f₁[M_{I}(T_{H1}),M_{I}(T_{H2}),M_{I}(T_{H3})] (13)

V_{B}=f₂[M_{I}(T_{H1}),M_{I}(T_{H2}),M_{I}(T_{H3})] (14)

V_{C}=f₃[M_{I}(T_{H1}),M_{I}(T_{H2}),M_{I}(T_{H3})] (15)

V_{D}=f₄[M_{I}(T_{H1}),M_{I}(T_{H2}),M_{I}(T_{H3})] (16)

Moreover, the gas volume is proportional to the temperature of the gas itself by Boyle-Charles law. If, for example, the temperature of the mixed gas prior to the causing the heater element 61A to produce heat is defined as T_{I}, the volume fraction V_{A} of the gas A, the volume fraction V_{B} of the gas B, the volume fraction V_{C} of the gas C, and the volume fraction V_{D} of the gas D can be obtained as functions of the radiation coefficients M_{I}(T_{H1}), M_{I}(T_{H2}), and M_{I}(T_{H3}) of the mixed gas, and of the temperature of the mixed gas, as indicated in Equations (17) through (20), below.

V_{A}=f₁[M_{I}(T_{H1}),M_{I}(T_{H2}),M_{I}(T_{H3}),T_{I}] (17)

V_{B}=f₂[M_{I}(T_{H1}),M_{I}(T_{H2}),M_{I}(T_{H3}),T_{I}] (18)

V_{C}=f₃[M_{I}(T_{H1}),M_{I}(T_{H2}),M_{I}(T_{H3}),T_{I}] (19)

V_{D}=f₄[M_{I}(T_{H1}),M_{I}(T_{H2}),M_{I}(T_{H3}),T_{I}] (20)

Here Equation (21), below, is obtained through substituting Equation (17) through (20) into Equation (6), above.

$$\begin{matrix}1 / α = 1 / {K}_{A} \times {V}_{A} + 1 / {K}_{B} \times {V}_{B} + 1 / {K}_{C} \times {V}_{C} + 1 / {K}_{D} \times {V}_{D} \\ = 1 / {K}_{A} \times {f}_{1} [ {M}_{I} ( {T}_{H 1} ) , {M}_{I} ( {T}_{H 2} ) , {M}_{I} ( {T}_{H 3} ) , {T}_{I} ] + \\ 1 / {K}_{B} \times {f}_{2} [ {M}_{I} ( {T}_{H 1} ) , {M}_{I} ( {T}_{H 2} ) , {M}_{I} ( {T}_{H 3} ) , {T}_{I} ] + \\ 1 / {K}_{C} \times {f}_{3} [ {M}_{I} ( {T}_{H 1} ) , {M}_{I} ( {T}_{H 2} ) , {M}_{I} ( {T}_{H 3} ) , {T}_{I} ] + \\ 1 / {K}_{D} \times {f}_{4} [ {M}_{I} ( {T}_{H 1} ) , {M}_{I} ( {T}_{H 2} ) , {M}_{I} ( {T}_{H 3} ) , {T}_{I} ]\end{matrix} \qquad ( 21 )$$

As is clear from Equation (21), above, the inverse 1/α of the thermal diffusivity of the mixed gas is obtained from an equation having, as variables, the radiation coefficients M_{I}(T_{H1}), M_{I}(T_{H2}), and M_{I}(T_{H3}) of the mixed gas, and the temperature T_{I} of the mixed gas, when the heat producing temperatures of the heater element 61A are T_{H1}, T_{H2}, and T_{H3}, Consequently, the inverse 1/α of the thermal diffusivity of the mixed gas is given by Equation (22), below, where g₁ is a code indicating a function.

1/α=g₁[M_{I}(T_{H1}),M_{I}(T_{H2}),M_{I}(T_{H3}),T_{I}] (22)

Consequently, the inventors discovered that, for a mixed gas comprising a gas A, a gas D, a gas C, and a gas D, wherein the volume fraction V_{A} of the gas A, the volume fraction V_{B} of the gas B, the volume fraction V_{C} of the gas C, and the volume fraction V_{D} of the gas D, are unknown, it is possible to calculate easily the inverse 1/α of the thermal diffusivity of the mixed gas to be measured if Equation (22) is obtained in advance, Specifically, the inverse 1/α of the thermal diffusivity of the mixed gas being measured can be obtained uniquely by measuring the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}, and then substituting into Equation (22). Note that if the temperature T_{I} of the mixed gas previous to the heater element 61A being caused to produce heat is stable, then Equation (22) need not include the variable for the temperature T_{I} of the mixed gas.

Note that the gas components of the mixed gas are not limited to four different components. For example, if the mixed gas comprises n types of gas components, then first an equation having, as variables, the radiation coefficients M_{I}(T_{H1}), M_{I}(T_{H2}), M_{I}(T_{H3}), . . . M_{I}(T_{Hn-1}) of the mixed gas when the heat producing temperatures of the heater element 61A are at least n−1 different temperatures T_{H1}, T_{H2}, T_{H3}, . . . T_{Hn-1}, as given in Equation (23), below, is obtained. Then, the inverse 1/α of the thermal diffusivity of the mixed gas being measured is obtained uniquely by measuring the radiation coefficients M_{I}(T_{H1}), M_{I}(T_{H2}), M_{I}(T_{H3}), . . . , M_{I}(T_{Hn-1}) of the mixed gas wherein the volume fractions of each of the n types of gas components is unknown when the heat producing temperatures of the heater element 61A are n−1 different temperatures of T_{H1}, T_{H2}, T_{H3}, . . . , T_{Hn-1}, and then substituting into Equation (23).

1/α=g₁[M_{I}(T_{H1}),M_{I}(T_{H2}),M_{I}(T_{H3}), . . . ,M_{I}(T_{Hn-1}),T_{I}] (23)

Note that if the mixed gas includes an alkane (CⱼH₂ⱼ₊₂) other than methane (CH₄) and propane (C₃H₈), where j is a natural number, in addition to methane (CH₄) and propane (C₃H₈), then the alkane (CⱼH₂ⱼ₊₂) other than methane (CH₄) and propane (C₃H₈) will be seen as a mixture of methane (CH₄) and propane (C₃H₈), and there will be no effect on the calculation in Equation (23). For example, as indicated in Equations (24) through (27), below, the calculation may be performed using Equation (23) by viewing ethane (C₂H₆), butane (C₄H₁₀), pentane (C₅H₁₂), and hexane (C₆H₁₄) as a mixture of methane (CH₄) and propane (C₃H₈), with each multiplied by the respective specific factors.

C₂H₆=0.5CH₄+0.5C₃H₈ (24)

C₄H₁₀=−0.5CH₄+1.5C₃H₈ (25)

C₅H₁₂=−1.0CH₄+2.0C₃H₈ (26)

C₆H₁₄=−1.5CH₄±2.5C₃H₈ (27)

Consequently, with z as a natural number, if a mixed gas comprising n types of gas components includes, as gas components, z types of alkanes (CⱼH₂ⱼ₊₂) other than methane (CH₄) and propane (C₃H₈), in addition to methane (CH₄) and propane (C₃H₈), an equation may be calculated having, as variables, the radiation coefficients M_{I} of the mixed gas at, at least, n−z−1 different heat producing temperatures.

Note that if the types of gas components in the mixed gas used in the calculation in Equation (23) are the same as the types of gas components of the mixed gas to be measured, wherein the inverse 1/α of the thermal diffusivity is unknown, then, of course, Equation (23) can be used in calculating the inverse 1/α of the thermal diffusivity of gas to be measured. Furthermore, Equation (23) can also be used when the mixed gas to be measured comprises a number of gas components that is less than n, where the gas components of the less than n different types are included in the mixed gas that was used for calculating Equation (3). If, for example, the mixed gas used in calculating Equation (23) included four types of gas components, namely methane (CH₄), propane (C₃H₈), nitrogen (N₂) and carbon dioxide (CO₂), then even if the mixed gas to be measured includes only three different components, namely methane (CH₄), propane (C₃H₈), and carbon dioxide (CO₂), without containing the nitrogen (N₂), still Equation (23) can be used in calculating the inverse 1/α of the thermal diffusivity of the mixed gas to be measured.

Furthermore, if the mixed gas used in calculating Equation (23) included methane (CH₄) and propane (C₃H₈) as gas components, Equation (23) could still be used even when the mixed gas being measured includes an alkane (CⱼH₂ⱼ₊₂) that was not included in the mixed gas that was used in calculating Equation (23). This is because, as described above, even if the alkane (CⱼH₂ⱼ₊₂) other than methane (CH₄) and propane (C₃H₈) is viewed as a mixture of methane (CH₄) and propane (C₃H₈) there is no effect on calculating the inverse 1/α of the thermal diffusivity using Equation (23).

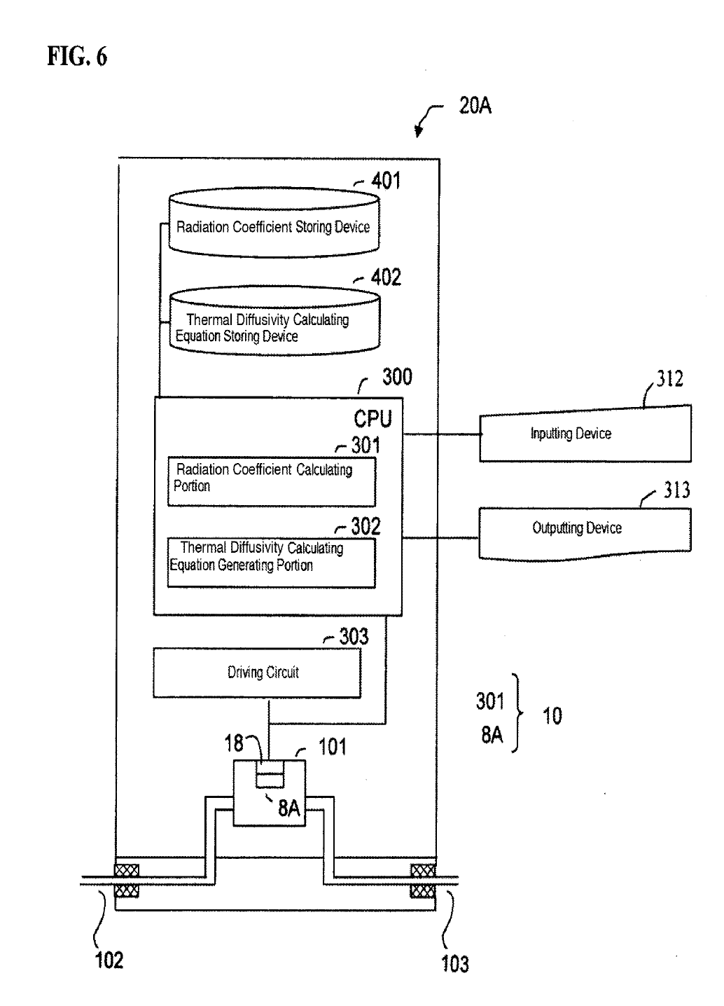

Here the thermal diffusivity calculating equation generating system 20A according to the example illustrated in FIG. 6 having a chamber 101 that is filled with a sample mixed gas for which the inverse 1/α of the thermal diffusivity is known; and a measuring mechanism 10, illustrated in FIG. 6, for measuring the values of a plurality of radiation coefficients M_{I} of the sample mixed gas and the temperature T_{I} of the sample mixed gas, using the heater element 61A, the first temperature measuring element 62A, and the temperature measuring element 63A that are illustrated in FIG. 1 and FIG. 2. Moreover, a gas physical property value measuring system includes a thermal diffusivity calculating equation generating portion 302 for generating a thermal diffusivity calculating equation using the radiation coefficients M_{I} and the gas temperatures T_{I} for a plurality of heat producing temperatures of the heater element 61A as independent variables and the inverse 1/α of the thermal diffusivity of the gas as the dependent variable, based on the values of the inverses 1/α of known thermal diffusivities of a plurality of sample mixed gases, a plurality of measured values for the plurality of radiation coefficients M_{I} of the sample mixed gases, and a plurality of measured values for the temperatures T_{I} of the sample mixed gases. Note that the sample mixed gasses include a plurality of types of gases.

The measuring mechanism 10 comprises the microchip 8A that has been explained using FIG. 1 and FIG. 2, disposed within the chamber 101, into which the sample mixed gasses are introduced. The microchip 8A is disposed within the chamber 101, by means of a thermally insulating member 18. A flow path 102, for feeding the sample mixed gasses into the chamber 101, and a flow path 103, for discharging the sample mixed gasses from the chamber 101, are connected to the chamber 101.

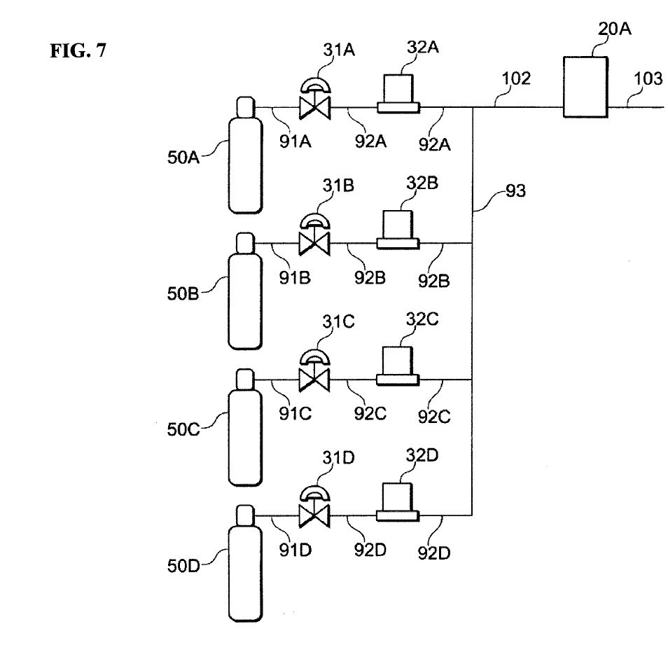

When a four types of sample mixed gases, each having a thermal diffusivity with a different inverse 1/α are used, then, as illustrated in FIG. 7, a first gas canister 50A for storing a first sample mixed gas, a second gas canister 50B for storing a second sample mixed gas, a third gas canister 50C for storing a third sample mixed gas, and a fourth gas canister 50D for storing a fourth sample mixed gas are prepared. The first gas canister 50A is connected, through a flow path 91A to a first gas pressure regulating device 31A for providing the first sample mixed gas from the first gas canister 50A, regulated to a low-pressure such as, for example, 0.2 MPa. Additionally, a first flow rate controlling device 32A is connected through a flow path 92A to the first gas pressure regulating device 31A. The first flow rate controlling device 32A controls the rate of flow of the first sample mixed gas that is fed into the thermal diffusivity calculating equation generating system 20A through the flow path 92A and the flow path 102.

A second flow gas pressure regulating device 31B is connected through a flow path 91B to the second gas canister 50B. Additionally, a second flow rate controlling device 32B is connected through a flow path 92B to the second gas pressure regulating device 31B. The second flow rate controlling device 32B controls the rate of flow of the second sample mixed gas that is fed into the thermal diffusivity calculating equation generating system 20A through the flow paths 92B, 93, and 102.

A third flow gas pressure regulating device 31C is connected through a flow path 91C to the third gas canister 50C. Additionally, a third flow rate controlling device 32C is connected through a flow path 92C to the third gas pressure regulating device 31C. The third flow rate controlling device 32C controls the rate of flow of the third sample mixed gas that is fed into the thermal diffusivity calculating equation generating system 20A through the flow paths 92C, 93, and 102.

A fourth flow gas pressure regulating device 31D is connected through a flow path 91D to the fourth gas canister 50D. Additionally, a fourth flow rate controlling device 32D is connected through a flow path 92D to the fourth gas pressure regulating device 31D. The fourth flow rate controlling device 32D controls the rate of flow of the fourth sample mixed gas that is fed into the thermal diffusivity calculating equation generating system 20A through the flow paths 92D, 93, and 102.

The first through fourth at sample mixed gases are each, for example, natural gas. The first through fourth sample mixed gases each include four different gas components of for example, methane (CH₄), propane (C₃H₈), nitrogen (N₂), and carbon dioxide (CO₂).

After the first sample mixed gas is filled into the chamber 101, the first temperature measuring element 62A and the second temperature measuring element 63A, illustrated in FIG. 1 and FIG. 2, of the microchip 8A detect the temperature T_{I} of the first sample mixed gas prior to the production of heat by the heater element 61A. Thereafter, the heater element 61A applies a driving power P_{H} from the driving circuit 303 illustrated in FIG. 6. The application of the driving power P_{H} causes the heater element 61A, illustrated in FIG. 1 and FIG. 2, to produce heat at, for example, 100° C., 150° C., and 200° C.

After the removal of the first sample mixed gas from the chamber 101 illustrated in FIG. 6, the second through fourth sample mixed gases are filled sequentially into the chamber 101. After the second through fourth sample mixed gases, respectively, are filled into the chamber 101, the microchip 8A detects the respective temperatures of the second through fourth sample mixed gases. Additionally, the heater element 61A, illustrated in FIG. 1 and FIG. 2, to which the driving power P_{H} is applied, produces heat at 100° C., 150° C., and 200° C.

Note that if there are n types of gas components in each of the sample mixed gases, the heater element 61A, illustrated in FIG. 1 and FIG. 2, is caused to reduce heat at least n−1 different heat producing temperatures. However, as described above, alkane (CⱼH₂ⱼ₊₂) other than methane (CH₄) and propane (C₃H₈) can be viewed as a mixture of methane (CH₄) and propane (C₃H₈). Consequently, with z as a natural number, if a sample mixed gas comprising n types of gas components includes, as gas components, z types of alkanes (CⱼH₂ⱼ₊₂) in addition to methane (CH₄) and propane (C₃H₈), the heater element 61A is caused to produce heat at n−z−1 different heat producing temperatures.

Moreover, the measuring mechanism 10 illustrated in FIG. 6 is provided with a central calculation processing device (CPU) 300 that includes a radiation coefficient calculating portion 301 that is connected to the microchip 8A. The radiation coefficient calculating portion 301, as indicated in Equation (4), above, divides a first driving power P_{H1} of the heater element 61A of the microchip 8A that is illustrated in FIG. 1 and FIG. 2 by the difference between a first heat producing temperature T_{H} of the heater element 61A (for example, 100° C.) and the temperature T_{I} for each of the first through fourth sample mixed gases. Doing so calculates the value for the radiation coefficient M_{I} for each of the first through fourth sample mixed gases in thermal equilibrium with the heater element 61A with the heat producing temperature of 100° C.

Additionally, the radiation coefficient calculating portion 301 illustrated in FIG. 6 divides a second driving power P_{H2} of the heater element 61A of the microchip 8A that is illustrated in FIG. 1 and FIG. 2 by the difference between a second heat producing temperature T_{H} of the heater element 61A (for example, 150° C.) and the temperature T_{I} for each of the first through fourth sample mixed gases. Doing so calculates the value for the radiation coefficient M_{I} for each of the first through fourth sample mixed gases in thermal equilibrium with the heater element 61A with the heat producing temperature of 150° C.

Furthermore, the radiation coefficient calculating portion 301 illustrated in FIG. 6 divides a third driving power P_{H3}, of the heater element 61A of the microchip 8A that is illustrated in FIG. 1 and FIG. 2 by the difference between a third heat producing temperature T_{H} of the heater element 61A for example, 200° C.) and the temperature T_{I} for each of the first through fourth sample mixed gases. Doing so calculates the value for the radiation coefficient M_{I} for each of the first through fourth sample mixed gases in thermal equilibrium with the heater element 61A with the heat producing temperature of 200° C.

The thermal diffusivity calculating equation generating system 20 illustrated in FIG. 6 is further provided with a radiation coefficient storing device 401, connected to the CPU 300. The radiation coefficient calculating portion 301 stores, in the radiation coefficient storing device 401, the measured gas temperature values T_{I} and the calculated values for the radiation coefficients M_{I}.

The thermal diffusivity calculating equation generating portion 302 collects the respective known inverse 1/α values for the thermal diffusivities for the first through fourth sample mixed gases, for example, the plurality of measured values for the radiation coefficients M_{I} for when the heat producing temperature of the heater element 61A was 100° C., the plurality of measured values for the radiation coefficients M_{I} for when the heat producing temperature of the heater element 61A was 150° C., and the plurality of measured values for the radiation coefficients M_{I} for when the heat producing temperature of the heater element 61A was 200° C. Based on the inverse 1/α values for the thermal diffusivities and the plurality of radiation coefficients M_{I} that have been collected, the thermal diffusivity calculating equation generating portion 302 then, through multivariate analysis, calculates a thermal diffusivity calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having, as the dependent variable, the inverse 1/α of the thermal diffusivity.

Note that “multivariate analysis” includes support vector analysis disclosed in A. J. Smola and B. Schoikopf (eds.), “A Tutorial on Support Vector Regression” (NeuroCOLT Technical Report NC-TR-98-030), multiple linear regression analysis, the Fuzzy Quantification Theory Type II, disclosed in Japanese Unexamined Patent Application Publication H5-141999, and the like. Additionally, the radiation coefficient calculating portion 301 and the thermal diffusivity calculating equation generating portion 302 are included in the CPU 300.

The thermal diffusivity calculating equation generating system 20A is further provided with a thermal diffusivity calculating equation storing device 402, connected to the CPU 300. The thermal diffusivity calculating equation storing device 402 stores the thermal diffusivity calculating equation generated by the thermal diffusivity calculating equation generating portion 302. An inputting device 312 and an outputting device 313 are also connected to the CPU 300. A keyboard, a pointing device such as a mouse, or the like, may be used as the inputting device 312. An image displaying device such as a liquid crystal display or a monitor, or a printer, or the like, may be used as the outputting device 313.

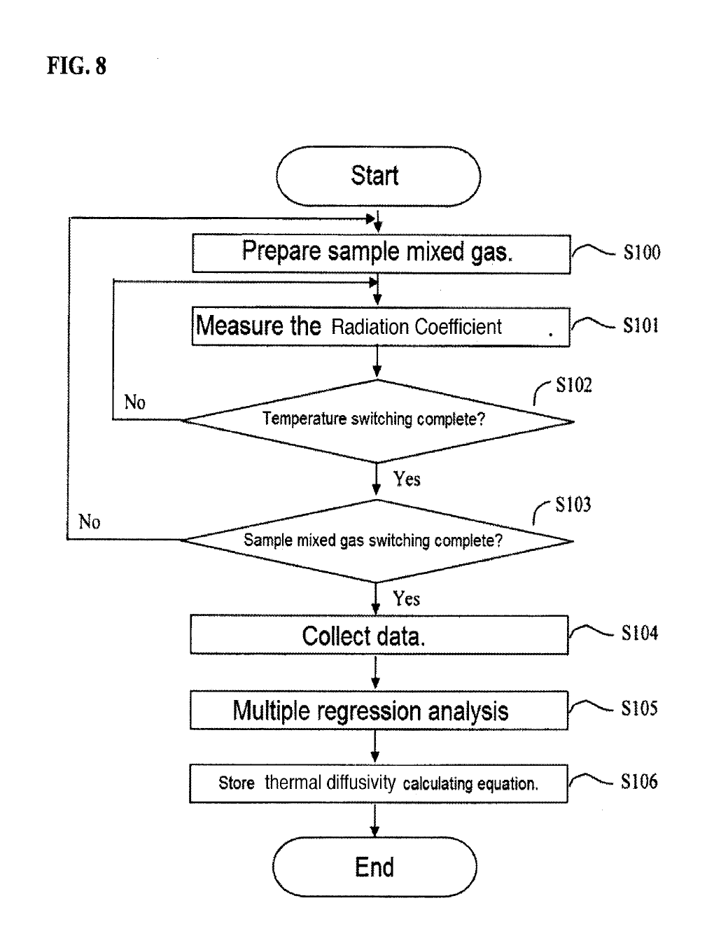

The flowchart in FIG. 8 will be used next to explain a method for generating a thermal diffusivity calculating equation as set forth in the example according to the present invention, Note that in the example below a case will be explained wherein the first through fourth sample mixed gases are prepared and the heater element 61A of the microchip 8A illustrated in FIG. 6 is caused to produce heat at 100° C., 150° C., and 200° C.

(a) In Step S100, the valve for the first flow rate controlling device 32A is opened while leaving the second through fourth flow rate controlling devices 32B through 32D, illustrated in FIG. 7, closed, to introduce the first sample mixed gas into the chamber 101 illustrated in FIG. 6.

in Step S101, the first temperature measuring element 62A and the second temperature measuring element 63A detect the temperature T_{I} of the first sample mixed gas. Thereafter, the driving circuit 303 illustrated in FIG. 6 applies a first driving power P_{H1} to the heater element 61A, illustrated in FIG. 1 and FIG. 2, of the microchip 8A, to cause the heater element 61A to produce heat at 100° C. Moreover, the radiation coefficient calculating portion 301, illustrated in FIG. 6, calculates the value of the radiation coefficient M_{I} of the first sample mixed gas when the heat producing temperature of the heater element 61A is 100° C. Thereafter, the radiation coefficient calculating portion 301 stores, in the radiation coefficient storing device 401, the value for the temperature T_{I} of the first sample mixed gas and the value for the radiation coefficient M_{I} for when the heat producing temperature of the heater element 61A is 100° C. Thereafter, the driving circuit 303 stops the provision of the first driving power P_{H1} to the heater element 61A.

(b) In Step S102, the driving circuit 303 evaluates whether or not the switching of the heat producing temperatures of the heater element 61A, illustrated in FIG. 1 and FIG. 2, has been completed. If the switching to the heat producing temperature of 150° C. and to the heat producing temperature of 200° C. has not been completed, then processing returns to Step S101, and the driving circuit 303, illustrated in FIG. 6, causes the heater element 61A, illustrated in FIG. 1 and FIG. 2, to produce heat at 150° C. The radiation coefficient calculating portion 301, illustrated in FIG. 6, calculates, and stores in the radiation coefficient storing device 401, the value of the radiation coefficient M_{I} of the first sample mixed gas when the heat producing temperature of the heater element 61A is 150° C. Thereafter, the driving circuit 303 stops the provision of the driving power to the heater element 61A.

(c) In Step S102, whether or not the switching of the heat producing temperatures of the heater element 61A, illustrated in FIG. 1 and FIG. 2, has been completed is evaluated again. If the switching to the heat producing temperature of 200° C. has not been completed, then processing returns to Step S101, and the driving circuit 303, illustrated in FIG. 6, causes the heater element 61A, illustrated in FIG. 1 and FIG. 2, to produce heat at 200° C. The radiation coefficient calculating portion 301, illustrated in FIG. 6, calculates, and stores in the radiation coefficient storing device 401, the value of the radiation coefficient M_{I} of the first sample mixed gas when the heat producing temperature of the heater element 61A is 200° C. Thereafter, the driving circuit 303 stops the provision of the driving power to the heater element 61A.

(d) If the switching of the heat producing temperature of the heater element 61A has been completed, then processing advances from Step S102 to Step S103. In Step S103, an evaluation is performed as to whether or not the switching of the sample mixed gases has been completed. If the switching to the second through fourth sample mixed gases has not been completed, processing returns to Step S100. In Step S100, the valve for the first flow rate controlling device 32A is closed and the valve for the second flow rate controlling device 32B is opened while leaving the third and fourth flow rate controlling devices 32C through 32D, illustrated in FIG. 7, closed, to introduce the second sample mixed gas into the chamber 101 illustrated in FIG. 6.

(e) The loop of Step S101 through Step S102 is repeated in the same manner as for the first sample mixed gas. The value for the temperature T_{I} of the second sample mixed gas is measured first, Additionally, the radiation coefficient calculating portion 301 calculates the value for the radiation coefficient M_{I} for the second sample mixed gas when the heat producing temperature of the heater element 61A is 100° C. the value for the radiation coefficient M_{I} for the second sample mixed gas when the heat producing temperature of the heater element 61A is 150° C., and the value for the radiation coefficient M_{I} for the second sample mixed gas when the heat producing temperature of the heater element 61A is 200° C. Moreover, the radiation coefficient calculating portion 301 stores, in the radiation coefficient storing device 401, the value for the temperature T_{I} measured for the second sample mixed gas and the calculated values for the radiation coefficients M_{I}.

(f) Thereafter, the loop of Step S100 through Step S103 is repeated. Doing so stores, in the radiation coefficient storing device 401, the value T_{I} for the temperature of the third sample mixed gas, the values of the respective radiation coefficients M_{I} for the third sample mixed gas when the heat producing temperatures of the heater element 61A are 100° C., 150° C., and 200° C., the value T_{I} for the temperature of the fourth sample mixed gas, and the values of the respective radiation coefficients M_{I} for the fourth sample mixed gas when the heat producing temperatures of the heater element 61A are 100° C., 150° C., and 200° C.

(g) In Step S104, the known value for the inverse 1/α of the thermal diffusivity of the first sample mixed gas, the known value for the inverse in of the thermal diffusivity of the second sample mixed gas, the known value for the inverse 1/α of the thermal diffusivity of the third sample mixed gas, and the known value for the inverse 1/α of the thermal diffusivity of the fourth sample mixed gas are inputted from the inputting device 312 into the thermal diffusivity calculating equation generating portion 302. Additionally, the thermal diffusivity calculating equation generating portion 302 reads in, from the radiation coefficient storing device 401, the values for the temperatures T_{I} of the first through fourth sample mixed gases and the values for the radiation coefficients M_{I} for the first through fourth sample mixed gases when the heat producing temperatures of the heater element 61A were 100° C., 150° C., and 200° C.

(h) In Step S105, the thermal diffusivity calculating equation generating portion 302 performs multiple linear regression analysis based on the values for the inverses 1/α of the thermal diffusivities of the first through fourth sample mixed gases, the values for the temperatures T_{I} of the first through fourth sample mixed gases, and the values for the radiation coefficients M_{I} for the first through fourth sample mixed gases when the heat producing temperatures of the heater element 61A were 100° C., 150° C., and 200° C. Based on the multiple linear analysis, the thermal diffusivity calculating equation generating portion 302 calculates a thermal diffusivity calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having, as the dependent variable, the inverse 1/α of the thermal diffusivity. Thereafter, in Step S106, the thermal diffusivity calculating equation generating portion 302 stores, into the thermal diffusivity calculating equation storing device 402, the thermal diffusivity calculating equation that has been generated, to complete the method for generating the thermal diffusivity calculating equation as set forth in the first form of embodiment.

As described above, the method for generating a thermal diffusivity calculating equation as set forth enables the generation of a thermal diffusivity calculating equation that calculates a unique value for the thermal diffusivity α of a mixed gas being measured.

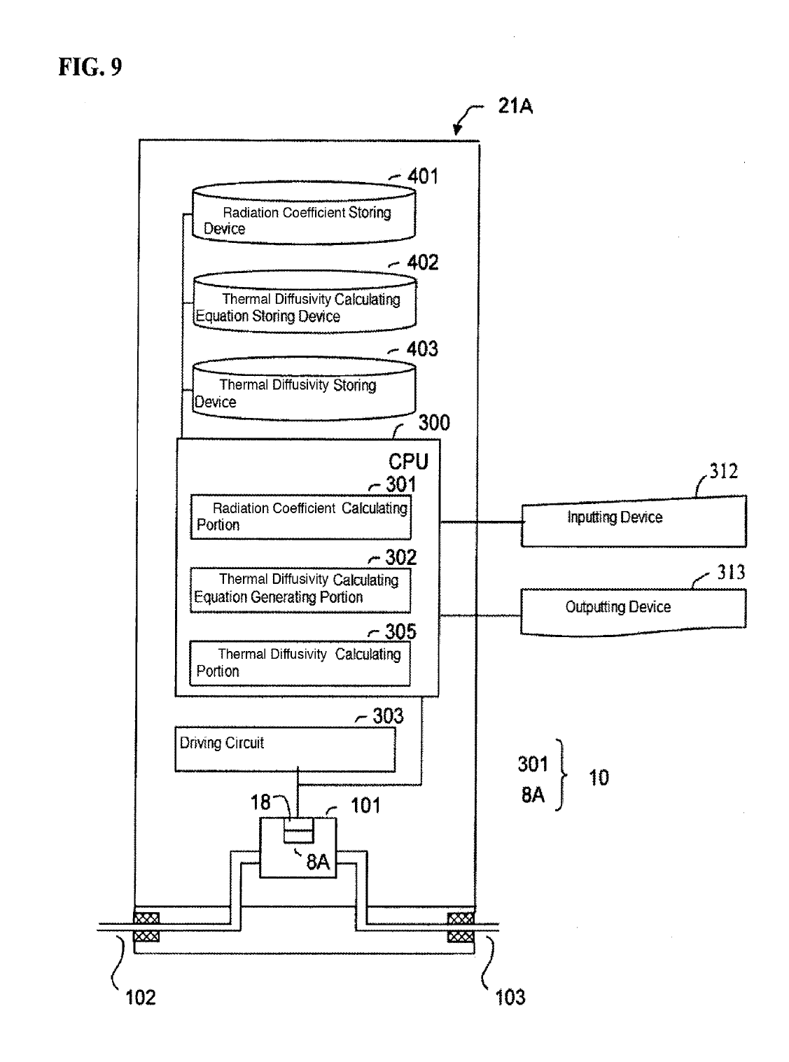

As illustrated in FIG. 9, a thermal diffusivity measuring system 21A according to another example includes a chamber 101 that is filled with a mixed gas to be measured for which the inverse 1/α of the thermal diffusivity is unknown; and a measuring mechanism 10, illustrated in FIG. 9, for measuring the values of a plurality of radiation coefficients M_{I} of the mixed gas being measured and the temperature TI of the mixed gas being measured, using the heater element 61A, the first temperature measuring element 62A, and the second temperature measuring element 63A that are illustrated in FIG. 1 and FIG. 2. The thermal diffusivity measuring system 21A further has a thermal diffusivity calculating equation storing device 402 for storing a thermal diffusivity calculating equation having, as independent variables, the temperature T_{I} of the gas and the radiation coefficients M_{I} for the gas at a plurality of heat producing temperatures of the heater element 61A, and having, as the independent variable, the inverse 1/α of the thermal diffusivity; and a thermal diffusivity calculating portion 305 for calculating the value of the inverse 1/α of the thermal diffusivity of the mixed gas being measured, by substituting the value for the temperature T_{I} of the mixed gas being measured and the radiation coefficients M_{I}, for the mixed gas being measured, at a plurality of heat producing temperatures of the heater element 61A into the independent variables of the temperature T_{I} of the gas and the radiation coefficients M_{I} for the gas at a plurality of heat producing temperatures of the heater element 61A in the thermal diffusivity calculating equation.

The thermal diffusivity calculating equation storing device 402 stores the thermal diffusivity calculating equation described in the first form of embodiment. As an example, a case will be explained here wherein natural gases, including methane (CH₄), propane (C₃H₈), nitrogen (N₂), and carbon dioxide (CO₂), were used as the sample mixed gases for generating the thermal diffusivity calculating equation. Additionally, the thermal diffusivity calculating equation uses, as independent variables, the radiation coefficient M_{I} of the gas when the heat producing temperature of the heater element 61A is 100° C., the radiation coefficient M_{I} of the gas when the heat producing temperature of the heater element 61A is 150° C., the radiation coefficient M_{I} of the gas when the heat producing temperature of the heater element 61A is 200° C., and the temperature T_{I} of the gas.

In this example, a natural gas that includes, in unknown volume fractions, methane (CH₄), propane (C₃H₈), nitrogen (N₂), and carbon dioxide (CO₂), and for which the inverse 1/α of the thermal diffusivity is unknown, is introduced into the chamber 101 as the mixed gas to be measured. The first temperature measuring element 62A and the second temperature measuring element 63A, illustrated in FIG. 1 and FIG. 2, of the microchip 8A detect the temperature T_{I} of the mixed gas to be measured, prior to the production of heat by the heater element 61A. Thereafter, the heater element 61A applies a driving power P_{H} from the driving circuit 303 illustrated in FIG. 9. The application of the driving power P_{H} causes the heater element 61A, illustrated in FIG. 1 and FIG. 2, to produce heat at 100° C., 150° C., and 200° C.

The radiation coefficient calculating portion 301, illustrated in FIG. 9, follows the method explained by Equations (1) to (4), above, to calculate the value of the radiation coefficient M_{I} of the mixed gas being measured when at thermal equilibrium with the heater element 61A producing heat at the heat producing temperature of 100° C. Moreover, the radiation coefficient calculating portion 301 calculates the value of the radiation coefficient M_{I} of the mixed gas being measured when at thermal equilibrium with the heater element 61A producing heat at the heat producing temperature of 150° C. and the value of the radiation coefficient M_{I} of the mixed gas being measured when at thermal equilibrium with the heater element 61A producing heat at the heat producing temperature of 200° C. The radiation coefficient calculating portion 301 stores, in the radiation coefficient storing device 401, the gas temperature value T_{I} of the mixed gas being measured and the calculated values for the radiation coefficients M_{I}.

The thermal diffusivity calculating portion 305 substitutes the values of the radiation coefficients M_{I} and the temperature T_{I} of the mixed gas being measured into the independent variables of the radiation coefficients M_{I} for the gas and the temperature T_{I} of the gas in the thermal diffusivity calculating equation, to calculate the value of the inverse 1/α of the thermal diffusivity of the mixed gas being measured. The thermal diffusivity calculating portion 305 may further calculate the value of the thermal diffusivity a from the value of the inverse 1/α of the thermal diffusivity. A thermal diffusivity storing device 403 is also connected to the CPU 300. The thermal diffusivity storing device 403 stores the value of the inverse 1/α of the thermal diffusivity of the mixed gas being measured, calculated by the thermal diffusivity calculating portion 305. The requirements for the other structural elements in the thermal diffusivity measuring system 21A as set forth here are identical to those in the thermal diffusivity calculating equation generating system 20A set forth above, so explanations thereof are omitted.

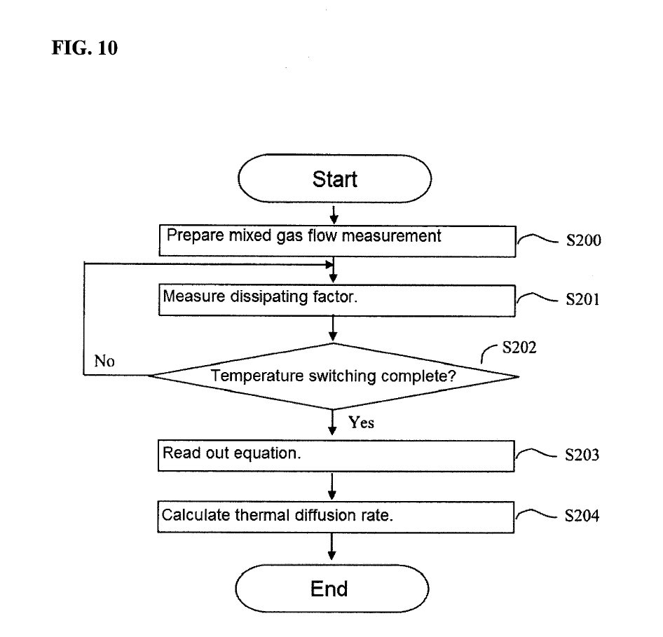

The flowchart in FIG. 10 will be used next to explain a method for measuring a thermal diffusivity as set forth according to the present invention. Note that in the example below a case will be explained the heater element 61A of the microchip 8A illustrated in FIG. 9 is caused to produce heat at 100° C., 150° C., and 200° C.

(a) In Step S200, the mixed gas to be measured is introduced into the chamber 101 illustrated in FIG. 9, Next, in Step S201, The first temperature measuring element 62a and the second temperature measuring element 63A, illustrated in FIG. 1 and FIG. 2, of the microchip 8A detect the temperature T_{I} of the mixed gas to be measured, prior to the production of heat by the heater element 61A. Thereafter, the driving circuit 303 illustrated in FIG. 9 applies a first driving power P_{H1} to the heater element 61A, illustrated in FIG. 1 and FIG. 2, of the microchip 8A, to cause the heater element 61A to produce heat at 100° C. The radiation coefficient calculating portion 301 illustrated in FIG. 9 calculates the radiation coefficient M_{I} of the mixed gas being measured, at the heat producing temperature of 100° C. Moreover, the radiation coefficient calculating portion 301 stores, in the radiation coefficient storing device 401, the value for the temperature T_{I} of the mixed gas being measured and the value for the radiation coefficient M_{I} of the mixed gas being measured for when the heat producing temperature of the heater element 61A is 100° C. Thereafter, the driving circuit 303 stops the provision of the first driving power P_{H1} to the heater element 61A.

(b) In Step S202, the driving circuit 303, illustrated in FIG. 9, evaluates whether or not the switching of the heat producing temperatures of the heater element 61A, illustrated in FIG. 1 and FIG. 2, has been completed. If the switching to the heat producing temperature of 150° C. and to the heat producing temperature of 200° C. has not been completed, then processing returns to Step S201, and the driving circuit 303, illustrated in FIG. 9, causes the heater element 61A, illustrated in FIG. 1 and FIG. 2, to produce heat at 150° C. The radiation coefficient calculating portion 301, illustrated in FIG. 9, calculates, and stores in the radiation coefficient storing device 401, the value of the radiation coefficient M_{I} of the first sample mixed gas being measured when the heat producing temperature of the heater element 61A is 150° C. Thereafter, the driving circuit 303 stops the provision of the driving power to the heater element 61A.

(c) In Step S202, whether or not the switching of the heat producing temperatures of the heater element 61A, illustrated in FIG. 1 and FIG. 2, has been completed is evaluated again. If the switching to the heat producing temperature of 200° C. has not been completed, then processing returns to Step S201, and the driving circuit 303, illustrated in FIG. 9, causes the heater element 61A, illustrated in FIG. 1 and FIG. 2, to produce heat at 200° C. The radiation coefficient calculating portion 301, illustrated in FIG. 9, calculates, and stores in the radiation coefficient storing device 401, the value of the radiation coefficient M_{I} of the first sample mixed gas being measured when the heat producing temperature of the heater element 61A is 200° C.

Thereafter, the driving circuit 303 stops the provision of the driving power to the heater element 61A.

(d) if the switching of the heat producing temperature of the heater element 61A has been completed, then processing advances from Step S202 to Step S203. In Step S203, the thermal diffusivity calculating portion 305 reads in, from the thermal diffusivity calculating equation storing device 402, the thermal diffusivity calculating equation that uses, as independent variables, the value for the temperature T_{I} of the gas and the values for the radiation coefficients M_{I} when the heat producing temperatures of the heater element 61A are 100° C., 150° C., and 200° C. In addition, the thermal diffusivity calculating portion 305 region, from the radiation coefficient storing device 401, the value for the temperature T_{I} of the mixed gas being measured and the values for the radiation coefficients M_{I} of the mixed gas being measured for when the heat producing temperatures of the heater element 61A are 100° C., 150° C., and 200° C.

(e) In Step S204, the thermal diffusivity calculating portion 305 substitutes the value of the temperature T_{I} of the mixed gas being measured into the independent variable of the temperature T in the thermal diffusivity calculating equation, and substitutes the value of the radiation coefficients M_{I} of the mixed gas being measured into the independent variable of the radiation coefficients M_{I} in the thermal diffusivity calculating equation, to calculate the value of the inverse 1/α of the thermal diffusivity of the mixed gas being measured. Thereafter, the thermal diffusivity calculating portion 305 stores, into the thermal diffusivity storing device 403, the value calculated for the thermal diffusivity α, to complete the method for measuring the thermal diffusivity as set forth herein.

The method for measuring the thermal diffusivity as set forth in the example described above enables the measurement of the thermal diffusivity α of a mixed gas that is a mixed gas to be measured, from measured values for the radiation coefficients M_{I} of the mixed gas to be measured, without using costly gas chromatography equipment or speed-of-sound sensors.

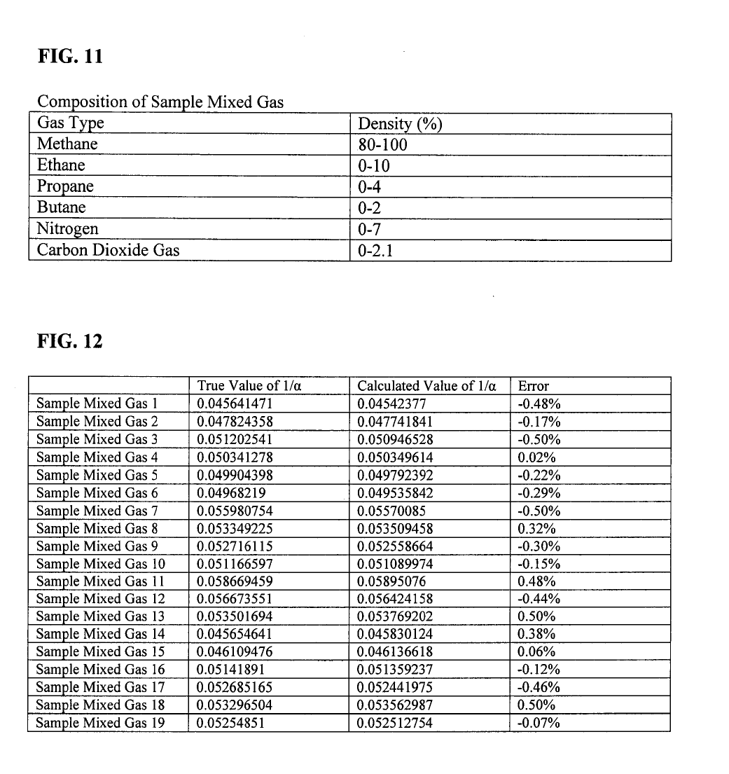

First, as illustrated in FIG. 11, 19 different sample mixed gases, having mutually differing volume densities of ethane, propane, butane, nitrogen, and carbon dioxide, were prepared. Following this, the values of the radiation coefficient M_{I} for each of the 19 mixed gas samples are measured when the heater element has been caused to produce heat at a plurality of temperatures. Thereafter, support vector regression, based on the known values for the inverses 1/α of the thermal diffusivities of the 19 sample mixed gases and the plurality of measured values for the radiation coefficients M_{I}, was used to generate an equation for calculating the inverse 1/α of the thermal diffusivity using the radiation coefficients M_{I} as independent variables and the inverse 1/α of the thermal diffusivity as the dependent variable.

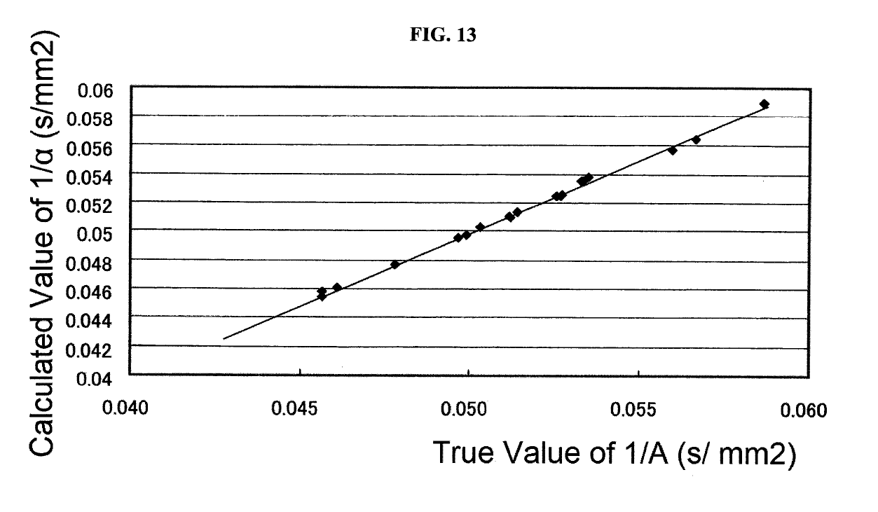

Following this, the equation for calculating the inverse 1/α of the thermal diffusivity was used to calculate calculated values for the inverses 1/α of the thermal diffusivities for the 19 sample mixed gases, and the true values for the inverses 1/α of the thermal diffusivities for the 19 sample mixed gases were compared. When this was done, the error in the calculated values, relative to the true values for the inverses 1/α of the thermal diffusivities, as illustrated in FIG. 12 and FIG. 13, where within −0.5% and +0.5%. The ability to calculate accurately the inverse 1/α of a thermal diffusivity from measured values for radiation coefficients M_{I}, through the use of a thermal diffusivity calculating equation that has the radiation coefficients M_{I} as the independent variables and the inverse 1/α of a thermal diffusivity as the dependent variable was thus demonstrated.

Through Equation (1), above, the temperature T_{H} of the heater element 61A, illustrated in FIG. 1 and FIG. 2, is given by Equation (28), below:

T_{H}=(½β)×[−α+[α²−4β(1−R_{H}/R_{H}_{_{—}}_{STD})]^{1/2}]+T_{H}_{_{—}}_{STD} (28)

Consequently, the difference ΔT_{H} between the heat producing temperature T_{H} of the heater element 61A and the temperature T_{I} of the ambient gas is given by Equation (29), below:

ΔT_{H}=(½β)×[−α+[α²−4β(R_{H}/R_{H}_{_{—}}_{STD})]^{1/2}]+T_{H}_{_{—}}_{STD}−T_{I} (29)

The temperature of the first temperature measuring element 62A, when power is applied to the extent that it does not produce heat itself, will approximate the ambient temperature T_{I}. The relationship between the temperature T_{I} of the first temperature measuring element 62A and the resistance value R_{I} of the first temperature measuring element 62A is given by Equation (30), below:

R_{I}=R_{I}_{_{—}}_{STD}×[1+α(T_{I}−T_{I}_{_{—}}_{STD})+β(T_{I}−T_{I}_{_{—}}_{STD})²] (30)

Here T_{I}_{_{—}}_{STD} indicates a standard temperature for the first temperature measuring element 62A of, for example, 20° C. R_{I}_{_{—}}_{STD} indicates a resistance value that is measured in advance for the first temperature measuring element 62A at the standard temperature of T_{I}_{_{—}}_{STD}. Through Equation (30), above, the temperature T_{I} of the first temperature measuring element 62A is given by Equation (31), below:

T_{I}=(½β)×[−α+[α²−4β_{I}(1−R_{I}/R_{I}_{_{—}}_{STD})]^{1/2}]+T_{I}_{_{—}}_{STD} (31)

Consequently, the radiation coefficient M_{I} of the ambient gas is also given by Equation (32), below.

$$\begin{matrix}{M}_{I} = {P}_{H} / Δ {T}_{H} \\ = {P}_{H} / [ ( \frac{1}{2} β ) [ - α + {[ {α}^{2} - 4 β ( 1 - {R}_{H} / {R}_{H\_STD} ) ]}^{\frac{1}{2}} ] + \\ {T}_{H\_STD} - ( \frac{1}{2} β ) [ - α + {[ {α}^{2} - 4 β ( 1 - {R}_{I} / {R}_{I \_STD} ) ]}^{\frac{1}{2}} ] - \\ {T}_{I\_STD} ]\end{matrix} \qquad ( 32 )$$

Because the current I_{H} flowing in the heater element 61A and the driving power P_{H} or the voltage V_{H} can be measured, the resistance R_{H} of the heater element 61A can be calculated from Equation (2) through Equation (3), above. Similarly, it is also possible to calculate the resistance value R_{I} of the first temperature measuring element 62A.

As is illustrated in Equation (22), above, the inverse 1/α of the thermal diffusivity of the mixed gas that comprises the four types of gas components is obtained from an equation having, as variables, the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}. Additionally, the radiation coefficient M_{I} of the mixed gas, as indicated in Equation (32), above, depends on the resistance value R_{H} of the heater element 61A and on the resistance value R_{I} of the first temperature measuring element 62A. Given this, the inventors discovered that the inverse 1/α of the thermal diffusivity of a mixed gas can also be obtained from an equation having, as variables, the resistances R_{H1}(T_{H1}), R_{H2}(T_{H2}), and R_{H3}(T_{H3}) of the heater element 61A when the temperatures of the heater element 61A are T_{H1}, T_{H2}, and T_{H3}, and the resistance value R_{I} of the first temperature measuring element 62A that is in contact with the mixed gas, as shown in Equation (33), below.

1/α=g₂[R_{H1}(T_{H1}),R_{H2}(T_{H2}),R_{H3}(T_{H3}),R_{I}] (33)

Given this, the inverse 1/α of the thermal diffusivity of a mixed gas can be calculated uniquely by measuring the resistances R_{H1}(T_{H1}), R_{H2}(T_{H2}), and R_{H3}(T_{H3}) of the heater element 61A when the heat producing temperatures of the heater element 61A, which is in contact with the mixed gas, are T_{H1}, T_{H2}, and T_{H3}, and the resistance value R_{I} of the first temperature measuring element 62A that is in contact with the mixed gas prior to the heat production by the heater element 61A, for example, and then substituting into Equation (33).

Furthermore, the inverse 1/α of the thermal diffusivity of a mixed gas can also be obtained from an equation having, as variables, the currents I_{H1}(T_{H1}), I_{H2}(T_{H2}), and I_{H3}(T_{H3}) flowing in the heater element 61A when the temperatures of the heater element 61A are T_{H1}, T_{H2}, and T_{H3}, and the current I_{I} flowing in the first temperature measuring element 62A that is in contact with the mixed gas, as shown in Equation (34), below.

1/α=g₃[I_{H1}(T_{H1}),I_{H2}(T_{H2}),I_{H3}(T_{H3}),I_{I}] (34)

Conversely, the inverse 1/α of the thermal diffusivity of a mixed gas can also be obtained from an equation having, as variables, the voltages V_{H1}(T_{H1}), V_{H2}(T_{H2}), and V_{H3}(T_{H3}) of the heater element 61A when the temperatures of the heater element 61A are T_{H1}, T_{H2}, and T_{H3}, and the voltage V_{I} of the first temperature measuring element 62A that is in contact with the mixed gas, as shown in Equation (35), below,

1/α=g₄[V_{H1}(T_{H1}),V_{H2}(T_{H2}),V_{H3}(T_{H3}),V_{I}] (35)

Conversely, the inverse 1/α of the thermal diffusivity of a mixed gas can also be obtained from an equation having, as variables, the output voltages AD_{H1}(T_{H1}), AD_{H2}(T_{H2}), and AD_{H3}(T_{H3}) of analog-digital converting circuits (hereinafter termed “A/D converting circuits”) that are connected to the heater element 61A when the temperatures of the heater element 61A are T_{H1}, T_{H2}, and T_{H3}, and the output voltage AD_{I} of an A/D converting circuit that is connected to the first temperature measuring element 62A that is in contact with the mixed gas, as shown in Equation (36), below.

1/α=g₅[AD_{H1}(T_{H1}),AD_{H2}(T_{H2}),AD_{H3}(T_{H3}),AD_{I}] (36)

Consequently, the inverse 1/α of the thermal diffusivity of a mixed gas can also be obtained from an equation having, as variables, electric signals S_{H1}(T_{H1}), S_{H2}(T_{H2}), and S_{H3}(T_{H3}) from the heater element 61A when the heat producing temperatures of the heater element 61A are T_{H1}, T_{H2}, and T_{H3}, and an electric signal S_{I} from the first temperature measuring element 62A that is in contact with the mixed gas, as shown in Equation (37), below.

1/α=g₆[S_{H1}(T_{H1}),S_{H2}(T_{H2}),S_{H3}(T_{H3}),S_{I}] (37)

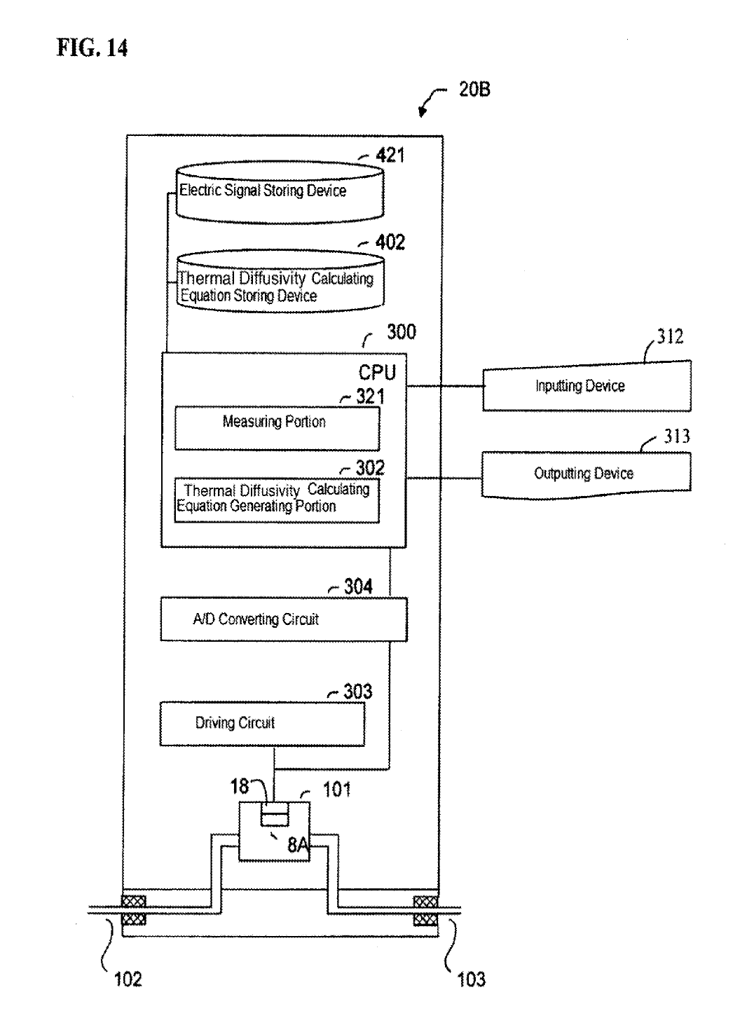

Here a thermal diffusivity calculating equation generating system 20B as illustrated in FIG. 14 includes a measuring portion 321, illustrated in FIG. 14, for measuring values of electric signals S_{I} from the first temperature measuring element 62A, illustrated in FIG. 1 and FIG. 2, that are dependent on the respective temperatures T of the plurality of sample mixed gases, and the values of electric signals S_{H} from the heater element 61A at each of the plurality of heat producing temperatures T_{H}; and a thermal diffusivity calculating equation generating portion 302 for generating a thermal diffusivity calculating equation based on known values for inverses 1/α of thermal diffusivities of a plurality of sample mixed gases, the plurality of measured values for the electric signals S_{I} from the first temperature measuring element 62A, and the plurality of measured values for the electric signals from the heater element 61A at the plurality of heat producing temperatures, having an electric signal S_{I} from the first temperature measuring element 62A and the electric signals S_{H} from the heater element 61A at the plurality of heat producing temperatures T_{H} as independent variables, and having the inverse 1/α of the thermal diffusivity as the dependent variable.

After a first sample mixed gas is filled into the chamber 101, the first temperature measuring element 62A of the microchip 8A, illustrated in FIG. 1 and FIG. 2, outputs an electric signal S_{I} that is dependent on the temperature of the first sample mixed gas. Following this, the heater element 61A applies driving powers P_{H1}, P_{H2}, and P_{H3} from the driving circuit 303 illustrated in FIG. 14. When the driving powers P_{H1}, P_{H2}, and P_{H3} are applied, the heater element 61A that is in contact with the first sample mixed gas produces heat at a temperature T_{H1} of 100° C., a temperature T_{H2} of 150° C., and a temperature T_{H3} of 200° C., for example, to output an electric signal S_{H1} (T_{H1}) at the heat producing temperature T_{H1}, an electric signal S_{H2}(T_{H2}) at the heat producing temperature T_{H2}, and an electric signal S_{H3} (T_{H3}) at the heat producing temperature T_{H3}.

After the removal of the first sample mixed gas from the chamber 101, the second through fourth sample mixed gases are filled sequentially into the chamber 101, After the second sample mixed gas is filled into the chamber 101, the first temperature measuring element 62A of the microchip 8A, illustrated in FIG. 1 and FIG. 2, outputs an electric signal S_{I} that is dependent on the temperature of the second sample mixed gas. Following this, the heater element 61A, which is in contact with the second sample mixed gas, outputs an electric signal S_{H1} (T_{H1}) at a heat producing temperature T_{H1}, an electric signal S_{H2} (T_{H2}) at a heat producing temperature T_{H2}, and an electric signal S_{H3} (T_{H3}) at a heat producing temperature T_{H3}.

After the third sample mixed gas is filled into the chamber 101, illustrated in FIG. 14, the first temperature measuring element 62A of the microchip 8A, illustrated in FIG. 1 and FIG. 2, outputs an electric signal S_{I} that is dependent on the temperature of the third sample mixed gas. Following this, the heater element 61A, which is in contact with the third sample mixed gas, outputs an electric signal S_{H1} (T_{H1}) at a heat producing temperature T_{H1}, an electric signal S_{H2} (T_{H2}) at a heat producing temperature T_{H2}, and an electric signal S_{H3} (T_{H3}) at a heat producing temperature T_{H3}.

After the fourth sample mixed gas is filled into the chamber 101, illustrated in FIG. 14, the first temperature measuring element 62A of the microchip 8A, illustrated in FIG. 1 and FIG. 2, outputs an electric signal S_{I} that is dependent on the temperature of the fourth sample mixed gas. Following this, the heater element 61A, which is in contact with the fourth sample mixed gas, outputs an electric signal S_{H1} (T_{H1}) at a heat producing temperature T_{H1}, an electric signal S_{H2} (T_{H2}) at a heat producing temperature T_{H2}, and an electric signal S_{H3} (T_{H3}) at a heat producing temperature T_{H3}.

Note that if there are n types of gas components in each of the sample mixed gases, the heater element 61A, illustrated in FIG. 1 and FIG. 2, is caused to reduce heat at least n−1 different temperatures. However, as described above, alkane (CⱼH₂ⱼ₊₂) other than methane (CH₄) and propane (C₃H₈) can be viewed as a mixture of methane (CH₄) and propane (C₃H₈). Consequently, with z as a natural number, if a sample mixed gas comprising n types of gas components includes, as gas components, z types of alkanes (CⱼH₂ⱼ₊₂) in addition to methane (CH₄) and propane (C₃H₈), the heater element 61A is caused to produce heat at n−z−1 different temperatures.

As illustrated in FIG. 14, the microchip 8A is connected to a CPU that includes the measuring portion 321. An electric signal storing device 421 is also connected to the CPU 300, The measuring portion 321 measures the value of the electric signal S_{I} from the first temperature measuring element 62A, and, from the heater element 61A, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

Note that the electric signal S_{I} from the first temperature measuring element 62A may be the resistance value R_{I} of the first temperature measuring element 62A, the current I_{I} flowing in the first temperature measuring element 62A, the voltage V_{I} applied to the first temperature measuring element 62A, or the output signal AD_{I} from the A/D converting circuit 304 that is connected to the first temperature measuring element 62A. Similarly, the electric signal SH from the heater element 61A may be the resistance value R_{H} of the heater element 61A, the current I_{H} flowing in the heater element 61A, the voltage V_{H} applied to the heater element 61A, or the output signal AD_{H} from the A/D converting circuit 304 that is connected to the heater element 61A.

The thermal diffusivity calculating equation generating portion 302 that is included in the CPU 300 collection the respective known values for the inverses 1/α of the thermal diffusivities for, for example, each of the first through fourth sample mixed gases, the plurality of measured values for the electric signals S_{I} from the first temperature measuring element 62A, and the plurality of measured values for the electric signals S_{H1} (T_{H1}), S_{H2} (T_{H2}), and S_{H3} (T_{H3}) from the heater element 61A. Furthermore, the thermal diffusivity calculating equation generating portion 302 uses multivariate analysis based on the collected values for the inverses 1/α of the thermal diffusivities, the electric signals S_{I}, and the electric signals S_{H}, to generate a thermal diffusivity calculating equation having the electric signal S_{I} from the first temperature measuring element 62A and the electric signals S_{H1} (T_{H1}), S_{H2} (T_{H2}), and S_{H3} (T_{H3}) from the heater element 61A as the independent variables, and the inverse 1/α of the thermal diffusivity as the dependent variable. The other structural elements of the thermal diffusivity calculating equation generating system 20B illustrated in FIG. 14 are identical to those of the thermal diffusivity calculating equation generating system 20A that is illustrated in FIG. 6, so explanations thereof are omitted.

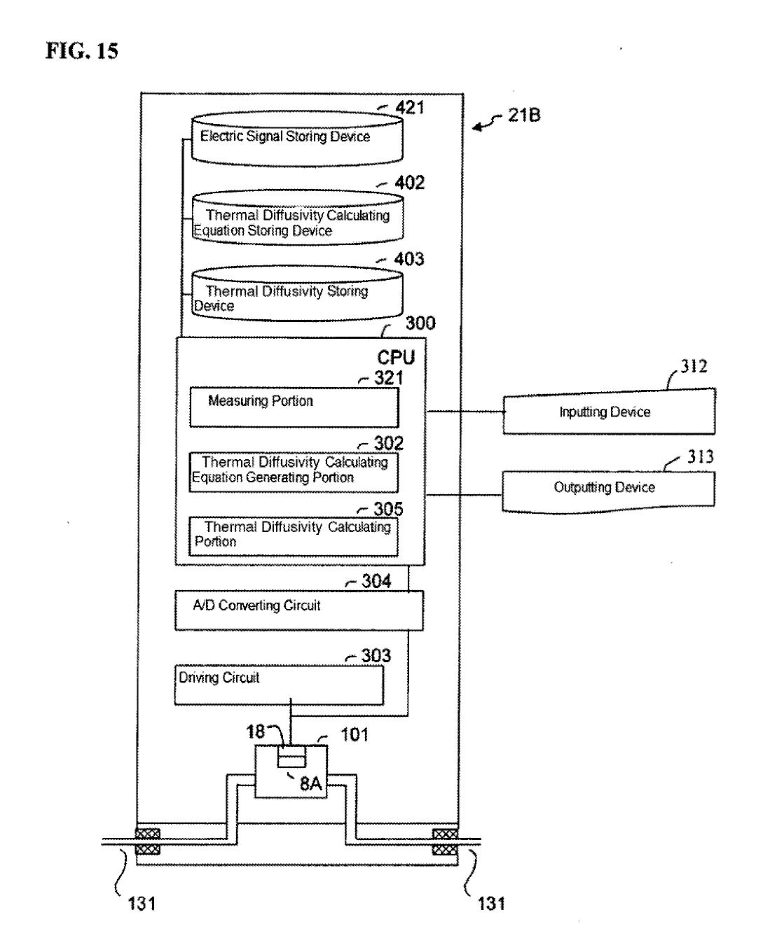

As illustrated in FIG. 15, a thermal diffusivity measuring system 21B as set forth has a measuring portion 321 for measuring the value of an electric signal S_{I} from the first temperature measuring element 62A, which is dependent on the temperature T_{I} of the gas being measured, and values of the electric signals S_{H} from the heater element 61A at each of the plurality of heat producing temperatures T_{H}; a thermal diffusivity calculating equation storing device 402 for storing a thermal diffusivity calculating equation that has the electric signal S_{I} from the first temperature measuring element 62A and the electric signals S_{H} from the heater element 61A at the plurality of heat producing temperatures T_{H} as independent variables and the inverse 1/α of the thermal diffusivity as the dependent variable; and a thermal diffusivity calculating portion. 305 for calculating the value of the inverse 1/α of the thermal diffusivity of the mixed gas being measured, by substituting the measured value of the electric signal S_{I} from the first temperature measuring element 62A and the measured values of the electric signals S_{H} from the heater element 61A into the independent variable that is the electric signal S_{I} from the first temperature measuring element 62A and the independent variables that are the electric signals S_{H} from the heater element 61A in the thermal diffusivity calculating equation.

The thermal diffusivity calculating equation includes, for example, as independent variables, the electric signal S_{I} from the first temperature measuring element 62A, the electric signal S_{H1} (T_{H1}) from the heater element 61A at a heat producing temperature T_{H1} of 100° C., the electric signal S_{H2} (T_{H2}) from the heater element 61A at a heat producing temperature T_{H2} of 150° C., and the electric signal S_{H3} (T_{H3}) from the heater element 61A at a heat producing temperature T_{H3} of 200° C.

The first temperature measuring element 62A of the microchip 8A illustrated in FIG. 1 and FIG. 2 outputs an electric signal S_{I} that is dependent on the temperature of the gas that is measured. Following this, the heater element 61A applies driving powers P_{H1}, P_{H2}, and P_{H3} from the driving circuit 303 illustrated in FIG. 15. When the driving powers P_{H1}, P_{H2}, and P_{H3} are applied, the heater element 61A that is in contact with the mixed gas being measured produces heat at a temperature T_{H1} of 100° C., a temperature T_{H2} of 150° C., and a temperature T_{H3} of 200° C., for example, to output an electric signal S_{H1} (T_{H1}) at the heat producing temperature T_{H1}, an electric signal S_{H2} (T_{H2}) at the heat producing temperature T_{H2}, and an electric signal S_{H3} (T_{H3}) at the heat producing temperature T_{H3}.

The measuring portion 321, illustrated in FIG. 15, measures the value of the electric signal S_{I} from the first temperature measuring element 62A, which is in contact with the mixed gas being measured, and, from the heater element 61A, which is in contact with the mixed gas being measured, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

The thermal diffusivity calculating portion 305 substitutes the respected respective measured values into the independent variables of the electric signal S_{I} from the first temperature measuring element 62A and the electric Signals S_{H1} (T_{H1}), S_{H2} (T_{H2}), and S_{H3} (T_{H3}) from the heater element 61A in the thermal diffusivity calculating equation that is stored in the thermal diffusivity calculating equation storing device 402, to calculate the value of the inverse 1/α of the thermal diffusivity of the mixed gas. The other structural elements of the thermal diffusivity measuring system 21B illustrated in FIG. 15 are identical to those of the thermal diffusivity measuring system 21A that is illustrated in FIG. 9, so explanations thereof are omitted. The natural gas includes caloric components such as methane (CH₄) and propane (C₃H₈), and non-caloric components such as nitrogen (N₂) and carbon dioxide (CO₂). The relationship between the concentration of caloric component C₀ of the caloric components such as alkanes (CₙH₂ₙ₊₂) in the mixed gas and the radiation coefficient of the mixed gas will be explained next. The mixed gas comprises four gas components, gas A, gas B, gas C, and gas D, and when the unit-volume calorific value of gas A is defined as K_{A}, the unit-volume calorific value of gas B is defined as K_{B}, the unit-volume calorific value of gas C is defined as K_{C}, and the unit-volume calorific value of gas is defined as K_{D}, the unit-volume calorific value Q of the mixed gas is given by the sum of the products of the volume fractions of the individual gas components multiplied by the unit-volume calorific values of the individual gas components. Consequently, the unit-volume calorific value Q of the mixed gas is given by Equation (38), below. Note that the units for the unit-volume calorific values are, for example, MJ/m³.

Q=K_{A}×V_{A}+K_{B}×V_{B}+K_{C}×V_{C}+K_{D}×V_{D} (38)

Here Equation (39), below, is obtained through substituting Equations (17) through (20), above, into Equation (38), above.

$$\begin{matrix}Q = {K}_{A} \times {V}_{A} + {K}_{B} \times {V}_{B} + {K}_{C} \times {V}_{C} + {K}_{D} \times {V}_{D} \\ = {K}_{A} \times {f}_{1} [ {M}_{I} ( {T}_{H 1} ) , {M}_{I} ( {T}_{H 2} ) , {M}_{I} ( {T}_{H 3} ) , {T}_{I} ] + \\ {K}_{B} \times {f}_{2} [ {M}_{I} ( {T}_{H 1} ) , {M}_{I} ( {T}_{H 2} ) , {M}_{I} ( {T}_{H 3} ) , {T}_{I} ] + \\ {K}_{C} \times {f}_{3} [ {M}_{I} ( {T}_{H 1} ) , {M}_{I} ( {T}_{H 2} ) , {M}_{I} ( {T}_{H 3} ) , {T}_{I} ] + \\ {K}_{D} \times {f}_{4} [ {M}_{I} ( {T}_{H 1} ) , {M}_{I} ( {T}_{H 2} ) , {M}_{I} ( {T}_{H 3} ) , {T}_{I} ]\end{matrix} \qquad ( 39 )$$

As is clear from Equation (39), above, the unit-volume calorific value Q of the mixed gas is obtained from an equation having, as variables, the radiation coefficients M_{I}(T_{H1}), M_{I}(T_{H2}), and M_{I}(T_{H3}) of the mixed gas, and the temperature T_{I} of the mixed gas, when the heat producing temperatures of the heater element 61A are T_{H1}, T_{H2}, and T_{H3}. Consequently, the calorific value Q of the mixed gas is given by Equation (40), below, where h_{I} is a code indicating a function.

Q=h_{I}[M_{I}(T_{H2}),M_{I}(T_{H2}),M_{I}(T_{H3}),T_{I}] (40)

Consequently, the inventors discovered that, for a mixed gas comprising a gas A, a gas B, a gas C, and a gas D, wherein the volume fraction V_{A} of the gas A, the volume fraction V_{B} of the gas B, the volume fraction V_{C} of the gas C, and the volume fraction V_{D} of the gas D, are unknown, it is possible to calculate easily the unit-volume calorific value of the mixed gas Lobe measured if Equation (40) is Obtained in advance. Specifically, the calorific value Q of the mixed gas being measured can be obtained uniquely by measuring the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}, and then substituting into Equation (40).

Additionally, the calorific value Q of the mixed gas is proportional to the concentration of caloric component C₀ of the alkanes, and the like, in the mixed gas. Consequently, the concentration of caloric component C₀ in the mixed gas is given by Equation (41), below, where h₂ is a code indicating a function.

C₀=h₂[M_{I}(T_{H1}),M_{I}(T_{H2}),M_{I}(T_{H3}),T_{I}] (41)

Furthermore, if the mixed gas comprises n types of gas components, then the concentration of caloric component C₀ in the mixed gas is given by Equation (42), below.

C₀=h₂[M_{I}(T_{H1}),M_{I}(T_{H2}),M_{I}(T_{H3}), . . . ,M_{I}(T_{Hn-1}),T_{I}] (42)

Note that, as with Equation (23), if the mixed gas includes an alkane (CⱼH₂ⱼ₊₂) other than methane (CH₄) and propane (C₃H₈), where j is a natural number, in addition to methane (CH₄) and propane (C₃₁H₈), then the alkane (CⱼH₂ⱼ₊₂) other than methane (CH₄) and propane (C₃H₈) will be seen as a mixture of methane (CH₄) and propane (C₃H₈), so there will be no effect on the calculation in Equation (42). Also, if the temperature T_{I} of the mixed gas previous to the heater element 61A, illustrated in FIG. 1 and FIG. 2, being caused to produce heat is stable, then Equation (42) need not include the variable for the temperature T_{I} of the mixed gas.

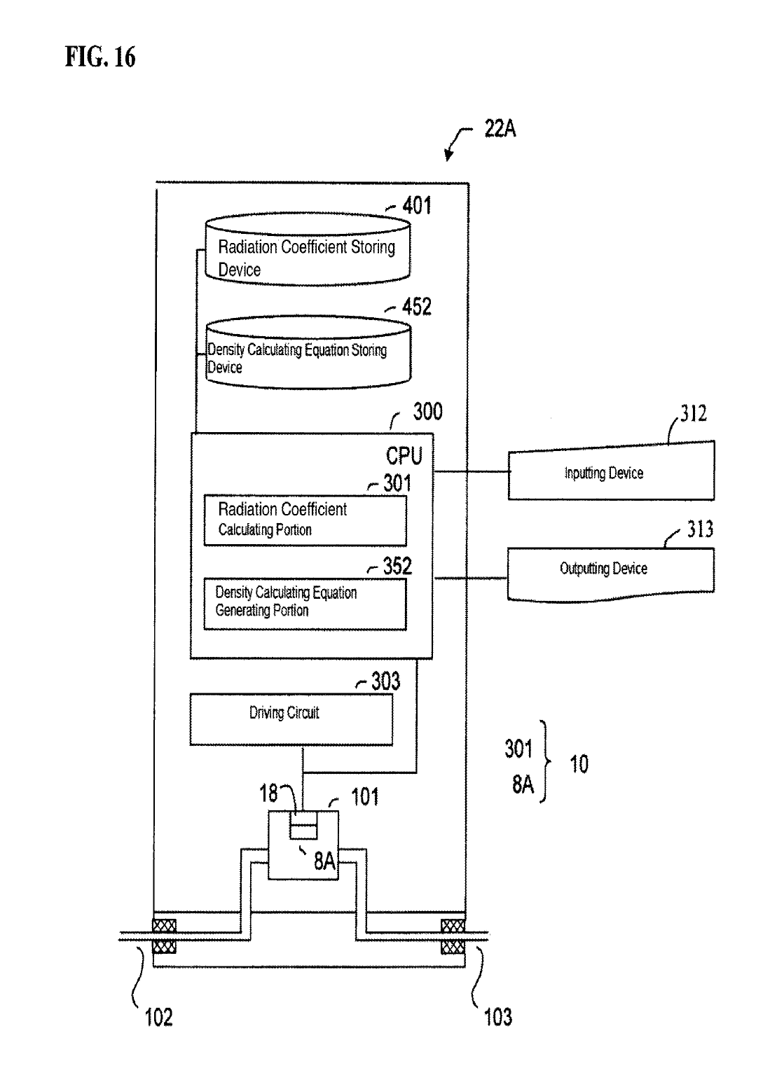

The concentration of caloric component calculating equation generating system 22A according to the example illustrated in FIG. 16 includes a chamber 101 that is filled with sample mixed gases for which the caloric component densities C₀ are known in advance, and a measuring mechanism 10 for measuring the values of a plurality of radiation coefficients M_{I} of the sample mixed gases and the values of the temperatures T_{I} of the sample mixed gases. Moreover, the concentration of caloric component calculating equation generating system 22A has a density calculating equation generating portion 352 for generating a concentration of caloric component calculating equation using the radiation coefficients M_{I} and the gas temperatures T_{I} for a plurality of heat producing temperatures of the heater element 61A as independent variables and the concentration of caloric component C₀ of the gas as the dependent variable, based on the values of the caloric component densities C₀ of a plurality of sample mixed gases, a plurality of measured values for the plurality of radiation coefficients M_{I} of the sample mixed gases, and a plurality of measured values for the temperatures T_{I} of the sample mixed gases.

The measuring mechanism 10 and heat dissipation factor storing device 401 are the same as in the above examples, so the explanations thereof are omitted. The density calculating equation generating portion 352 collects the respective known caloric component densities C₀ of the first through fourth sample mixed gases, for example, the plurality of measured values for the radiation coefficients M_{I} for the gas when the heat producing temperature of the heater element 61A was 100° C., the plurality of measured values for the radiation coefficients M_{I} for the gas when the heat producing temperature of the heater element 61A was 150° C., and the plurality of measured values for the gas the radiation coefficients M_{I} for when the heat producing temperature of the heater element 61A was 200° C. Based on the caloric component densities C₀ and the plurality of radiation coefficients M_{I} that have been collected, the density calculating equation generating portion 352 then, through multivariate analysis, calculates a concentration of caloric component calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having, as the dependent variable, the concentration of caloric component C₀.

The concentration of caloric component calculating equation generating system 22A is further provided with a density calculating equation storing device 452, connected to the CPU 300. The density calculating equation storing device 452 stores the concentration of caloric component calculating equation generated by the density calculating equation generating portion 352.

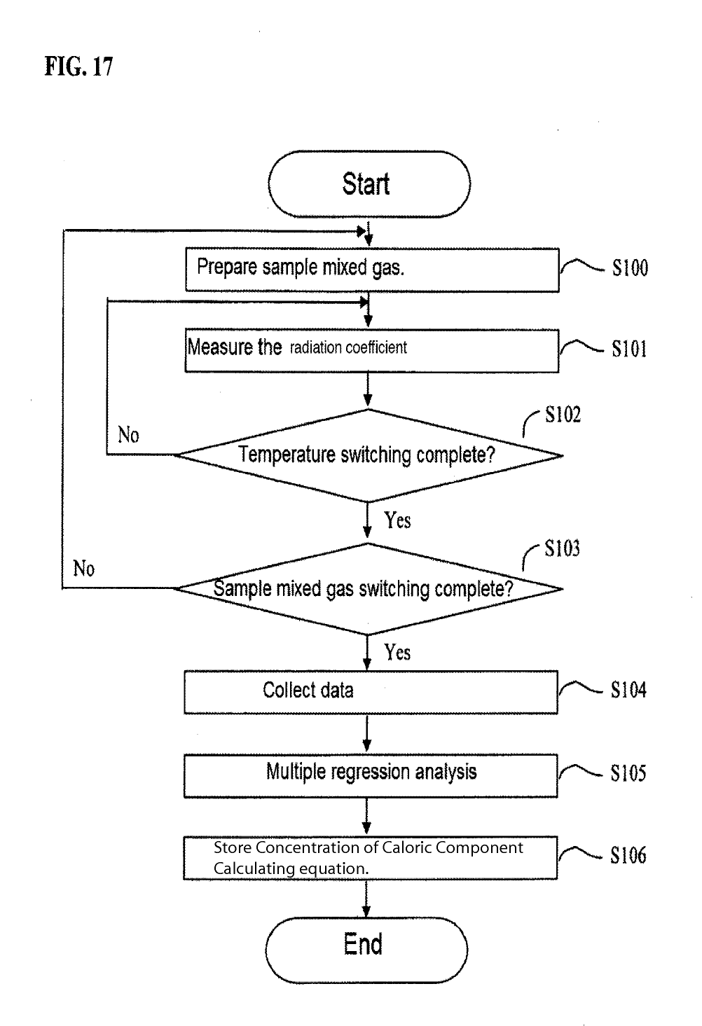

The flowchart in FIG. 17 is used next to explain a method for generating a concentration of caloric component calculating equation as set forth in another example of the present invention. Note that in the example below a case is explained wherein the first through fourth sample mixed gases are prepared and the heater element 61A of the microchip 8A illustrated in FIG. 16 is caused to produce heat at 100° C., 150° C., and 200° C.

(a) First, Step S100 through Step S103 are performed in the same way as above. Next, in Step S104, the known value for the concentration of caloric component C₀ of the first sample mixed gas, the known value for the concentration of caloric component C₀ of the second sample mixed gas, the known value for the concentration of caloric component C₀ of the third sample mixed gas, and the known value for the concentration of caloric component C₀ of the fourth sample mixed gas are inputted from the inputting device 312 into the density calculating equation generating portion 352. Additionally, the density calculating equation generating portion 352 reads in, from the radiation coefficient storing device 401, the values for the temperatures T_{I} of the first through fourth sample mixed gases and the values for the radiation coefficients M_{I} for the first through fourth sample mixed gases when the heat producing temperatures of the heater element 61A were 100° C., 150° C., and 200° C.

(b) In Step S105, the density calculating equation generating portion 352 performs multiple linear regression analysis based on the values for the caloric component densities C₀ of the first through fourth sample mixed gases, the values for the temperatures T_{I} of the first through fourth sample mixed gases, and the values for the radiation coefficients M_{I} for the first through fourth sample mixed gases when the heat producing temperatures of the heater element 61A were 100° C., 150° C., and 200° C. Based on the multiple linear analysis, the density calculating equation generating portion 352 calculates a concentration of caloric component calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having; as the dependent variable, the concentration of caloric component C₀. Thereafter, in Step S106, the density calculating equation generating portion 352 stores, into the density calculating equation storing device 452, the concentration of caloric component calculating equation that has been generated, to complete the method for generating the concentration of caloric component calculating equation as above.

As described above, the method for generating a concentration of caloric component calculating equation as set forth enables the generation of a concentration of caloric component calculating equation that calculates a unique value for the concentration of caloric component C₀ of a mixed gas being measured.

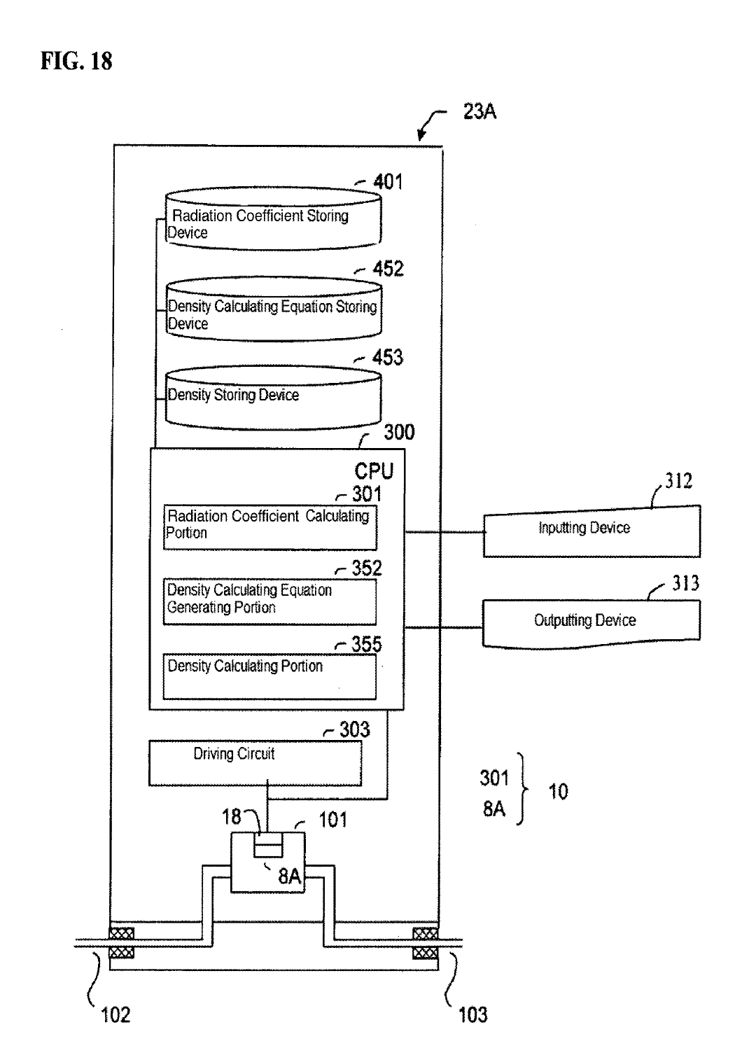

A concentration of caloric component measuring system 23A according to a further example illustrated in FIG. 18 has a chamber 101 that is filled with a mixed gas to be measured for which the concentration of caloric component C₀ is unknown, and a measuring mechanism 10 for measuring the value of the temperature T_{I} of the mixed gas to be measured and the values of a plurality of radiation coefficients M_{I} of the mixed gas to be measured. The concentration of caloric component measuring system 23A further has a density calculating equation storing device 452 for storing a concentration of caloric component calculating equation having, as independent variables, the temperature T_{I} of the gas and the radiation coefficients M_{I} for the gas at a plurality of heat producing temperatures of the heater element 61A, and having, as the independent variable, the concentration of caloric component C₀; and a density calculating portion 355 for calculating the value of the concentration of caloric component C₀ of the mixed gas being measured, by substituting the value for the temperature T_{I} of the mixed gas being measured and the radiation coefficients M_{I}, for the mixed gas being measured, at a plurality of heat producing temperatures of the heater element 61A into the independent variables of the temperature T_{I} of the gas and the radiation coefficients M_{I} for the gas at a plurality of heat producing temperatures of the heater element 61A in the thermal diffusivity calculating equation.

The density calculating equation storing device 452 stores the concentration of caloric component calculating equation as described above. As an example, a case is explained here wherein natural gases, including methane (CH₄), propane (C₃H₈), nitrogen (N₂), and carbon dioxide (CO₂), were used as the sample mixed gases for generating the concentration of caloric component calculating equation. Additionally, the concentration of caloric component calculating equation uses, as independent variables, the radiation coefficient M_{I} of the gas when the heat producing temperature of the heater element 61A is 100° C., the radiation coefficient of the gas when the heat producing temperature of the heater element 61A is 150° C., the radiation coefficient M_{I} of the gas when the heat producing temperature of the heater element 61A is 200° C., and the temperature T_{I} of the gas.

In yet another example, a natural gas that includes, in unknown volume fractions, methane (CH₄), propane (C₃H₈), nitrogen (N₂), and carbon dioxide (CO₂), and for which the concentration of caloric component C₀ is unknown, is introduced into the chamber 101 as the mixed gas to be measured. The measuring mechanism 10 and heat dissipation factor storing device 401 are the same as above, so the explanations thereof are omitted.

The density calculating portion 355 substitutes the values of the radiation coefficients M_{I} and the temperature T_{I} of the mixed gas being measured into the independent variables of the radiation coefficients M_{I} for the gas and the temperature T_{I} of the gas in the concentration of caloric component calculating equation, to calculate the value of the concentration of caloric component C₀ of the mixed gas being measured. A density storing device 453 is also connected to the CPU 300. The density storing device 453 stores the value of concentration of caloric component C₀ of the mixed gas being measured, calculated by the density calculating portion 355. The requirements for the other structural elements in the concentration of caloric component measuring system 23A as set forth therein are identical to those in the concentration of caloric component calculating equation generating system 22A set forth above, so explanations thereof are omitted.

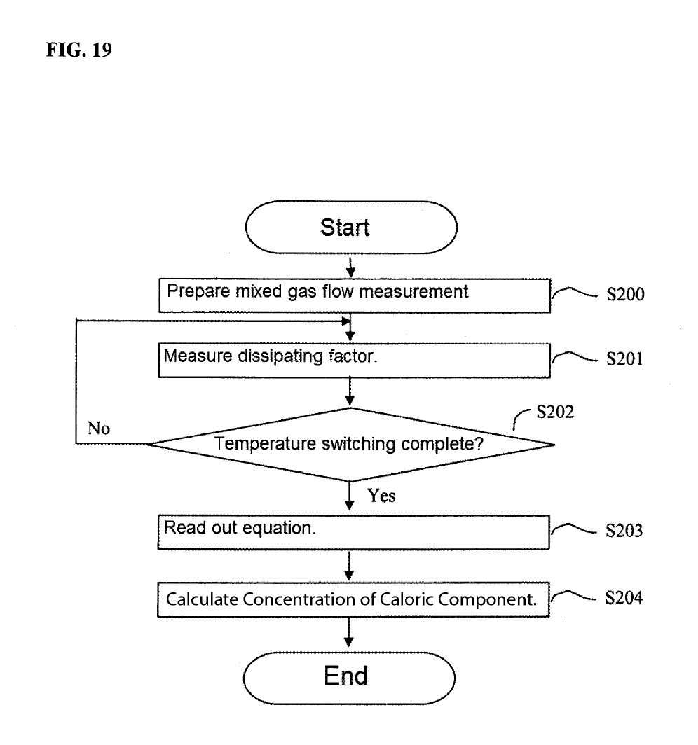

The flowchart in FIG. 19 is used next to explain a method for measuring a concentration of caloric component according to the present invention. Note that in the example below a case is explained the heater element 61A of the microchip 8A illustrated in FIG. 18 is caused to produce heat at 100° C., 150° C., and 200° C.

(a) First, Step S200 through Step S202 are performed in the same way as above. Next, in Step S203, the density calculating portion 355 reads in, from the density calculating equation storing device 452, the concentration of caloric component calculating equation that uses, as independent variables, the value for the temperature T_{I} of the gas and the values for the radiation coefficients M_{I} when the heat producing temperatures of the heater element 61A are 100° C., 150° C., and 200° C. In addition, the density calculating portion 355 region, from the radiation coefficient storing device 401, the value for the temperature T_{I} of the mixed gas being measured and the values for the radiation coefficients M_{I} of the mixed gas being measured for when the heat producing temperatures of the heater element 61A are 100° C., 150° C., and 200° C.

(c) In Step S204, the density calculating portion 355 substitutes the value of the temperature T_{I} of the mixed gas being measured into the independent variable of the temperature T_{I} in the concentration of caloric component calculating equation, and substitutes the value of the radiation coefficients M_{I} of the mixed gas being measured into the independent variable of the radiation coefficients M_{I} in the concentration of caloric component calculating equation, to calculate the value of the concentration of caloric component C₀ of the mixed gas being measured. Thereafter, the density calculating portion 355 stores, into the density storing device 453, the value calculated for the concentration of caloric component C₀, to complete the method for measuring the concentration of caloric component.

The method for measuring the concentration of caloric component as described above, enables the measurement of the concentration of caloric component C₀ in a mixed gas that is a mixed gas to be measured, from measured values for the radiation coefficients M_{I} of the mixed gas to be measured, without using costly gas chromatography equipment or speed-of-sound sensors.

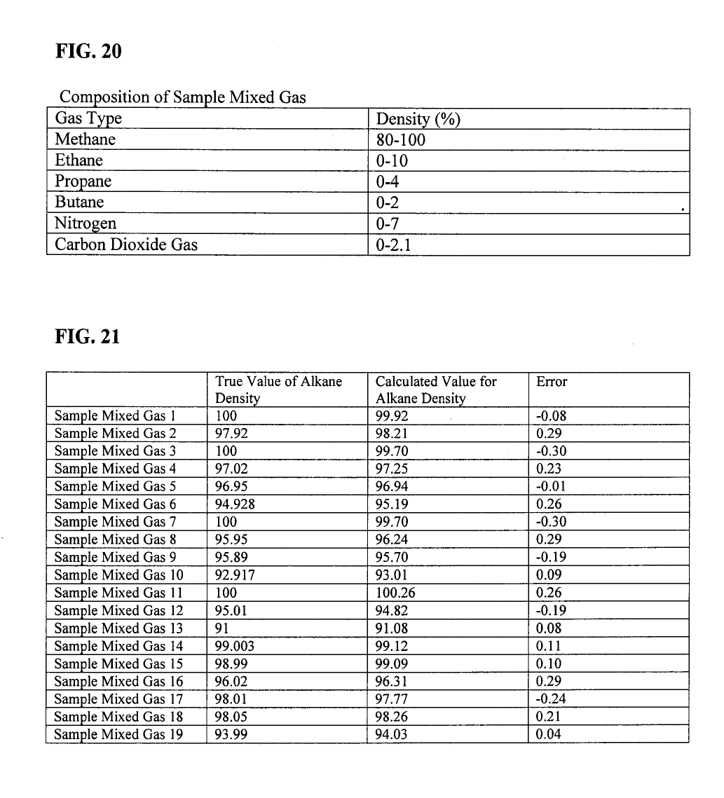

First, as illustrated in FIG. 20, 19 different sample mixed gases, having mutually differing volume densities of ethane, propane, butane, nitrogen, and carbon dioxide, were prepared. Following this, the values of the radiation coefficient M_{I} for each of the 19 mixed gas samples are measured when the heater element has been caused to produce heat at a plurality of temperatures. Thereafter, support vector regression, based on the known values for the alkane densities C₀ of the 19 sample mixed gases and the plurality of measured values for the radiation coefficients M_{I}, was used to generate an equation for calculating the alkane density C₀ using the radiation coefficients M_{I} as independent variables and the alkane density C₀ as the dependent variable.

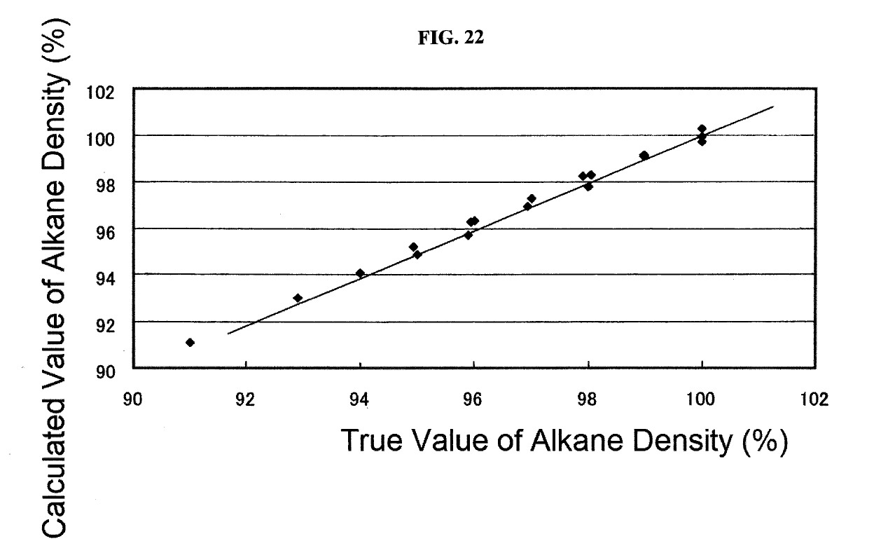

Following this, the equation for calculating the alkane density C₀ was used to calculate calculated values for the alkane densities C₀ for the 19 sample mixed gases, and the true values for the alkane densities C₀ for the 19 sample mixed gases were compared. When this was done, the error in the calculated values, relative to the true values for the alkane densities C₀, as illustrated in FIG. 21 and FIG. 22, where within −0.3% and +0.3%. The ability to calculate accurately alkane density C₀ from measured values for radiation coefficients M_{I}, through the use of an alkane density C₀ calculating equation that has the radiation coefficients M_{I} as the independent variables and the alkane density C₀ as the dependent variable was thus demonstrated.

As is illustrated in Equation (41), above, the concentration of caloric component C₀ of the mixed gas that comprises the four types of gas components is obtained as an equation having, as variables, the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}. Additionally, the radiation coefficient M_{I} of the mixed gas, as indicated in Equation (32), above, depends on the resistance value R_{H} of the heater element 61A and on the resistance value R_{I} of the first temperature measuring element 62A. Given this, the inventors discovered that the concentration of caloric component C₀ of a mixed gas can also be obtained as an equation having, as variables, the resistances R_{H1}(T_{H1}), R_{H2}(T_{H2}), and R_{H3}(T_{H3}) of the heater element 61A when the temperatures of the heater element 61A are T_{H1}, T_{H2}, and T_{H3}, and the resistance value R_{I} of the first temperature measuring element 62A that is in contact with the mixed gas, as shown in Equation (43), below.

C₀=h₃[R_{H1}(T_{H1}),R_{H2}(T_{H2}),R_{H3}(T_{H3}),R_{I}] (43)

Given this, the concentration of caloric component C₀ of a mixed gas can be calculated uniquely by measuring the resistances R_{H1}(T_{H1}), R_{H2}(T_{H2}), and R_{H3}(T_{H3}) of the heater element 61A when the heat producing temperatures of the heater element 61A, which is in contact with the mixed gas, are T_{H1}, T_{H2}, and T_{H3}, and the resistance value R_{I} of the first temperature measuring element 62A that is in contact with the mixed gas prior to the heat production by the heater element 61A, for example, and then substituting into Equation (43).

Furthermore, the concentration of caloric component C₀ of a mixed gas can also be obtained as an equation having, as variables, the currents I_{H1}(T_{H1}), I_{H2}(T_{H2}), and I_{H3}(T_{H3}) flowing in the heater element 61A when the temperatures of the heater element 61A are T_{H1}, T_{H2}, and T_{H3}, and the current I_{I} flowing in the first temperature measuring element 62A that is in contact with the mixed gas, as shown in Equation (44), below.

C₀=h₄[I_{H1}(T_{H1}),I_{H2}(T_{H2}),I_{H3}(T_{H3}),I_{I}] (44)

Conversely, the concentration of caloric component C₀ of a mixed gas can also be obtained from an equation having, as variables, the voltages V_{H1}(T_{H1}), V_{H2}(T_{H2}), and V_{H3}(T_{H3}) of the heater element 61A when the temperatures of the heater element 61A are T_{H1}, T_{H2}, and T_{H3}, and the voltage V_{I} of the first temperature measuring element 62A that is in contact with the mixed gas, as shown in Equation (45), below.

C₀=h₅[V_{H1}(T_{H1}),V_{H2}(T_{H2}),V_{H3}(T_{H3}),V_{I}] (45)

Conversely, the concentration of caloric component C₀ of a mixed gas can also be obtained as an equation having, as variables, the output voltages AD_{H1}(T_{H1}), AD_{H2}(T_{H2}), and AD_{H3}(T_{H3}) of analog-digital converting circuits that are connected to the heater element 61A when the temperatures of the heater element 61A are T_{H1}, T_{H2}, and T_{H3}, and the output voltage AD_{I} of an A/D converting circuit that is connected to the first temperature measuring element 62A that is in contact with the mixed gas, as shown in Equation (46), below.

C₀=h₆[AD_{H1}(T_{H1}),AD_{H2}(T_{H2}),AD_{H3}(T_{H3}),AD_{I}] (46)

Consequently, the concentration of caloric component C₀ of a mixed gas can also be obtained from an equation having, as variables, electric signals S_{H1}(T_{H1}), S_{H2}(T_{H2}), and S_{H3}(T_{H3}) from the heater element 61A when the heat producing temperatures of the heater element 61A are T_{H1}, T_{H2}, and T_{H3}, and an electric signal S_{I} from the first temperature measuring element 62A that is in contact with the mixed gas, as shown in Equation (47), below.

C₀=h₇[S_{H1}(T_{H1}),S_{H2}(T_{H2}),S_{H3}(T_{H3}),S_{I}] (47)

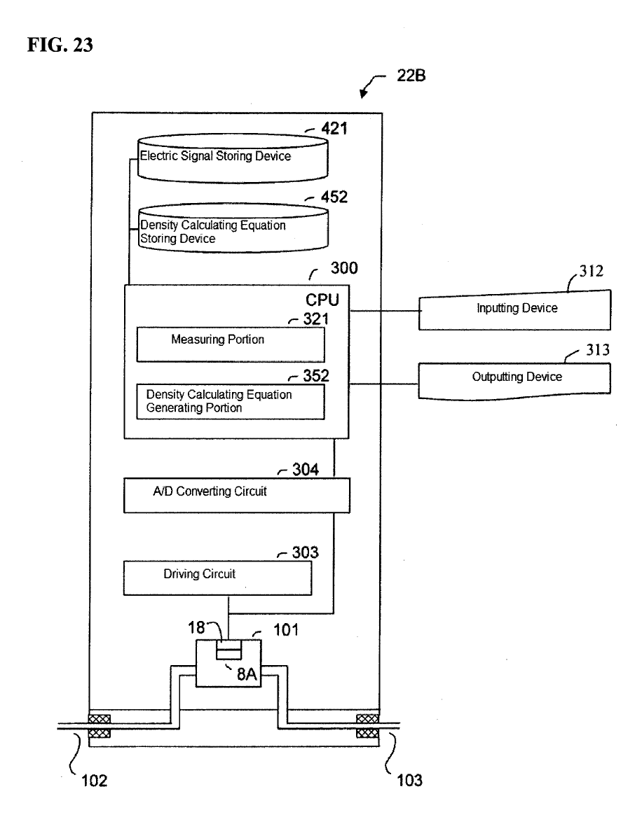

Here a concentration of caloric component calculating equation generating system 22B as illustrated in FIG. 23 has a measuring portion 321, illustrated in FIG. 23, for measuring values of electric signals S_{I} from the first temperature measuring element 62A, illustrated in FIG. 1 and FIG. 2, that are dependent on the respective temperatures T_{I} of the plurality of sample mixed gases, and the values of electric signals S_{H} from the heater element 61A at each of the plurality of heat producing temperatures T_{H}; and a concentration of caloric component calculating equation generating portion 352 for generating a concentration of caloric component calculating equation based on known values for caloric component densities of a plurality of sample mixed gases, the measured value for the electric signal S_{I} from the first temperature measuring element 62A, and the plurality of measured values for the electric signals from the heater element 61A at the plurality of heat producing temperatures, having an electric signal S_{I} from the first temperature measuring element 62A and the electric signals S_{H} from the heater element 61A at the plurality of heat producing temperatures T_{H} as independent variables, and having the concentration of caloric component as the dependent variable.

As with the above examples, the measuring portion 321 measures the value of the electric signal S_{I} from the first temperature measuring element 62A, and, from the heater element 61A, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

The concentration of caloric component calculating equation generating portion 352 that is included in the CPU 300 collection the respective known values for the caloric component densities C₀ of for example, each of the first through fourth sample mixed gases, the plurality of measured values for the electric signals S_{I} from the first temperature measuring element 62A, and the plurality of measured values for the electric signals S_{H1} (T_{H1}), S_{H2} (T_{H2}), and S_{H3} (T_{H3}) from the heater element 61A. Furthermore, the concentration of caloric component calculating equation generating portion 352 uses multivariate analysis based on the collected values for the caloric component densities C₀, the electric signals S_{I}, and the electric signals S_{H}, to generate a concentration of caloric component calculating equation having the electric signal S_{I} from the first temperature measuring element 62A and the electric signals S_{H1} (T_{H1}), S_{H2} (T_{H2}), and S_{H3} (T_{H3}) from the heater element 61A as the independent variables, and the concentration of caloric component C₀ as the dependent variable. The other structural elements of the concentration of caloric component calculating equation generating system 22B illustrated in FIG. 23 are identical to those of the concentration of caloric component calculating equation generating system 22A that is illustrated in FIG. 16, so explanations thereof are omitted.

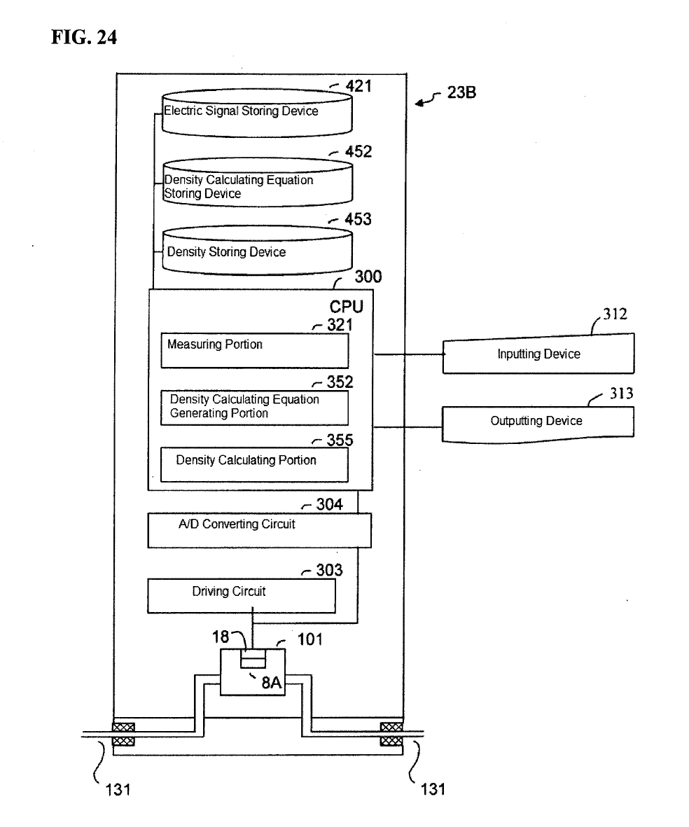

As illustrated in FIG. 24, a concentration of caloric component measuring system 23B as set forth below includes a measuring portion 321 for measuring the value of an electric signal S_{I} from the first temperature measuring element 62A, which is dependent on the temperature T_{I} of the gas being measured, and values of the electric signals S_{H} from the heater element 61A at each of the plurality of heat producing temperatures T_{H}; a density calculating equation storing device 452 for storing a concentration of caloric component calculating equation that has the electric signal S_{I} from the first temperature measuring element 62A and the electric signals S_{H} from the heater element 61A at the plurality of heat producing temperatures T_{H} as independent variables and the concentration of caloric component C₀ as the dependent variable; and a density calculating portion 355 for calculating the value of the concentration of caloric component C₀ of the mixed gas being measured, by substituting the measured value of the electric signal S_{I} from the first temperature measuring element 62A and the measured values of the electric signals S_{H} front the heater element 61A into the independent variable that is the electric signal S_{I} from the first temperature measuring element 62A and the independent variables that are the electric signals S_{H} from the heater element 61A in the concentration of caloric component calculating equation.

The concentration of caloric component calculating equation includes, for example, as independent variables, the electric signal S_{I} from the first temperature measuring element 62A, the electric signal S_{H1} (T_{H1}) from the heater element 61A at a heat producing temperature T_{H1} of 100° C., the electric signal S_{H2} (T_{H2}) from the heater element 61A at a heat producing temperature T_{H2} of 150° C., and the electric signal S_{H3} (T_{H3}) from the heater element 61A at a heat producing temperature T_{H3} of 200° C.

The first temperature measuring element 62A of the microchip 8A illustrated in FIG. 1 and FIG. 2 outputs an electric signal S_{I} that is dependent on the temperature of the gas that is measured. Following this, the heater element 61A applies driving powers P_{H1}, P_{H2}, and P_{H3} from the driving circuit 303 illustrated in FIG. 24. When the driving powers P_{H1}, P_{H2}, and P_{H3} are applied, the heater element 61A that is in contact with the mixed gas being measured produces heat at a temperature T_{H1} of 100° C., a temperature T_{H2} of 150° C., and a temperature T_{H3} of 200° C., for example, to output an electric signal S_{H1} (T_{H1}) at the heat producing temperature T_{H1}, an electric signal S_{H2} (T_{H2}) at the heat producing temperature T_{H2}, and an electric signal S_{H3} (T_{H3}) at the heat producing temperature T_{H3}.

The measuring portion 321 measures the value of the electric signal S_{I} from the first temperature measuring element 62A, which is in contact with the mixed gas being measured, and, from the heater element 61A, which is in contact with the mixed gas being measured, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

The density calculating portion 355 substitutes the respected respective measured values into the independent variables of the electric signal S_{I} from the first temperature measuring element 62A and the electric signals S_{H1} (T_{H1}), S_{H2} (T_{H2}), and S_{H3} (T_{H3}) from the heater element 61A in the concentration of caloric component calculating equation that is stored in the density calculating equation storing device 452, to calculate the value of the concentration of caloric component C₀ of the mixed gas being measured. The other structural elements of the concentration of caloric component measuring system 23B illustrated in FIG. 24 are identical to those of the concentration of caloric component measuring system 23A that is illustrated in FIG. 18, so explanations thereof are omitted.

As is clear from Equation (7), above, the inverse 1/α of the thermal diffusivity is proportional to the system the heat capacity Cp divided by the thermal conductivity k. Consequently, Equation (22), above, can be modified with so that the specific heat capacity Cp divided by the thermal conductivity k can be obtained, as shown in Equation (48), below, from an equation having, as variables, the radiation coefficients M_{I}(T_{H1}), M_{I}(T_{H2}), and M_{I}(T_{H3}) of the mixed gas, and the temperature T_{I} of the mixed gas, when the heat producing temperatures of the heater element 61A are T_{H1}, T_{H2}, and T_{H3}.

Cp/k=g₇[M_{I}(T_{H1}),M_{I}(T_{H2}),M_{I}(T_{H3}),T_{I}] (48)

Consequently, the inventors discovered that, for a mixed gas comprising a gas A, a gas B, a gas C, and a gas D, wherein the volume fraction V_{A} of the gas A, the volume fraction V_{B} of the gas B, the volume fraction V_{C} of the gas C, and the volume fraction V_{D} of the gas D, are unknown, it is possible to calculate easily the specific heat capacity Cp divided by the thermal conductivity k in the mixed gas to be measured if Equation (48) is obtained in advance. Specifically, the specific heat capacity Cp divided by the thermal conductivity k in the mixed gas being measured can be obtained uniquely by measuring the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}, and then substituting into Equation (48).

Note that if the mixed gas comprises n types of gas components, then the specific heat capacity Cp divided by the thermal conductivity k in the mixed gas is given by Equation (49), below

Cp/k=g₇[M_{I}(T_{H1}),M_{I}(T_{H2}),M_{I}(T_{H3}),T_{I}] (49)

Note that, as with Equation (23), if the mixed gas includes an alkane (CⱼH₂ⱼ₊₂) other than methane (CH₄) and propane (C₃H₈), where j is a natural number, in addition to methane (CH₄) and propane (C₃H₈), then the alkane (CⱼH₂ⱼ₊₂) other than methane (CH₄) and propane (C₃H₈) will be seen as a mixture of methane (CH₄) and propane (C₃H₈), so there will be no effect on the calculation in Equation (49). Also, if the temperature T_{I} of the mixed gas previous to the heater element 61A, illustrated in FIG. 1 and FIG. 2, being caused to produce heat is stable, then Equation (49) need not include the variable for the temperature T_{I} of the mixed gas.

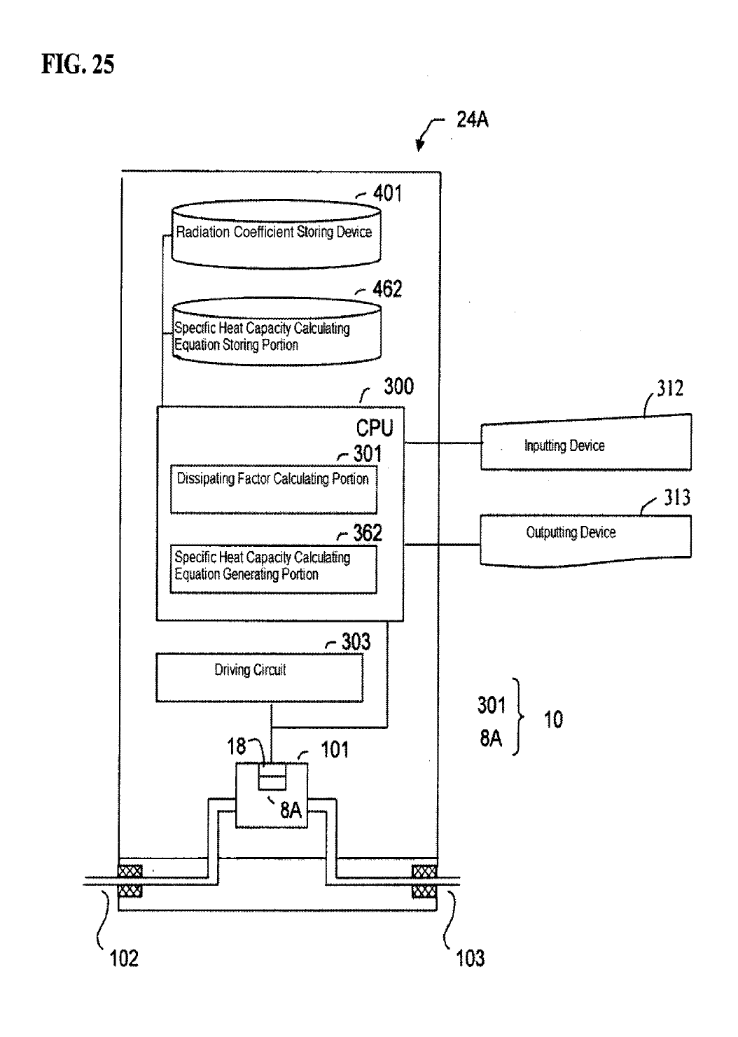

The specific heat capacity calculating equation generating system 24A according to FIG. 25 comprises a chamber 101 that is filled with sample mixed gases for which the specific heat capacities Cp divided by the thermal conductivities k are known in advance, and a measuring mechanism 10 for measuring the values of a plurality of radiation coefficients M_{I} of the sample mixed gases and the values of the temperatures T_{I} of the sample mixed gases. Moreover, the specific heat capacity calculating equation generating system 24A comprises a specific heat capacity calculating equation generating portion 362 for generating a specific heat capacity calculating equation using the radiation coefficients M_{I} and the gas temperatures T_{I} for a plurality of heat producing temperatures of the heater element 61A as independent variables and the specific heat capacity Cp divided by the thermal conductivity k in the gas as the dependent variable, based on the values of the specific heat capacities Cp divided by the thermal conductivities k in a plurality of sample mixed gases, a plurality of measured values for the plurality of radiation coefficients M_{I} of the sample mixed gases, and a plurality of measured values for the temperatures T_{I} of the sample mixed gases.

The measuring mechanism 10 and heat dissipation factor storing device 401 are the same as above, so the explanations thereof are omitted. The specific heat capacity calculating equation generating portion 362 collects the respective known specific heat capacities Cp divided by the thermal conductivities k in the first through fourth sample mixed gases, for example, the plurality of measured values for the radiation coefficients M_{I} for the gas when the heat producing temperature of the heater element 61A was 100° C., the plurality of measured values for the radiation coefficients M_{I} for the gas when the heat producing temperature of the heater element 61A was 150° C., and the plurality of measured values for the gas the radiation coefficients M_{I} for when the heat producing temperature of the heater element 61A was 200° C. Based on the specific heat capacities Cp divided by the thermal conductivities k and the plurality of radiation coefficients M_{I} that have been collected, the specific heat capacity calculating equation generating portion 362 then, through multivariate analysis, calculates a specific heat capacity calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having, as the dependent variable, the specific heat capacity Cp divided by the thermal conductivity k.

The specific heat capacity calculating equation generating system 24A is further provided with a specific heat capacity calculating equation storing device 462, connected to the CPU 300. The specific heat capacity calculating equation storing device 462 stores the specific heat capacity calculating equation generated by the specific heat capacity calculating equation generating portion 362.

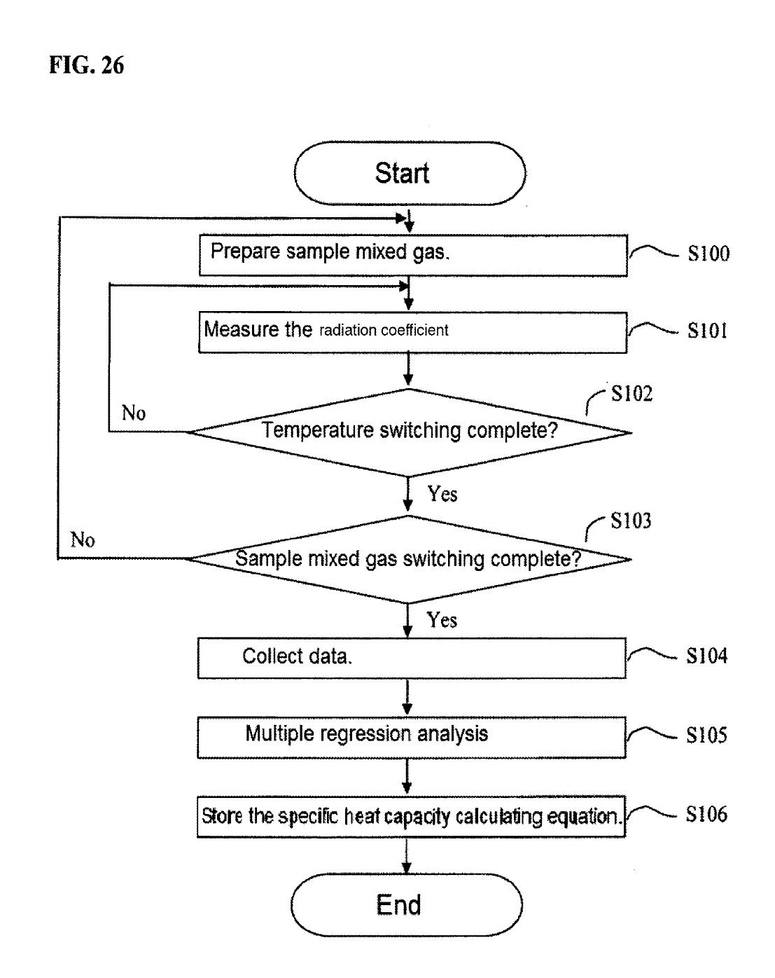

The flowchart in FIG. 26 is used next to explain a method for generating a specific heat capacity calculating equation as set forth according to the present invention. Note that in the example below a case is explained wherein the first through fourth sample mixed gases are prepared and the heater element 61A of the microchip 8A illustrated in FIG. 25 is caused to produce heat at 100° C., 150° C., and 200° C.

(a) First, Step S100 through Step S103 are performed in the same way as above. Next, in Step S104, the known value for the specific heat capacity Cp divided by the thermal conductivity k in the first sample mixed gas, the known value for the specific heat capacity Cp divided by the thermal conductivity k in the second sample mixed gas, the known value for the specific heat capacity Cp divided by the thermal conductivity k in the third sample mixed gas, and the known value for the specific heat capacity Cp divided by the thermal conductivity k in the fourth sample mixed gas are inputted from the inputting device 312 into the specific heat capacity calculating equation generating portion 362. Additionally, the specific heat capacity calculating equation generating portion 362 reads in, from the radiation coefficient storing device 401, the values for the temperatures T_{I} of the first through fourth sample mixed gases and the values for the radiation coefficients M_{I} for the first through fourth sample mixed gases when the heat producing temperatures of the heater element 61A were 100° C., 150° C., and 200° C.

(b) In Step S105, the specific heat capacity calculating equation generating portion 362 performs multiple linear regression analysis based on the values for the specific heat capacities Cp divided by the thermal conductivities k in the first through fourth sample mixed gases, the values for the temperatures T_{I} of the first through fourth sample mixed gases, and the values for the radiation coefficients M_{I} for the first through fourth sample mixed gases when the heat producing temperatures of the heater element 61A were 100° C., 150° C., and 200° C. Based on the multiple linear analysis, the specific heat capacity calculating equation generating portion 362 calculates a specific heat capacity calculating equation having, as independent variables, the radiation coefficient M_{I} when the heat producing temperature of the heater element 61A is 100° C., the radiation coefficient M_{I} when the heat producing temperature of the heater element 61A is 150° C., the radiation coefficient M_{I} when the heat producing temperature of the heater element 61A is 200° C., and the gas temperature T_{I}, and having, as the dependent variable, the specific heat capacity Cp divided by the thermal conductivity k. Thereafter, in Step S106, the specific heat capacity calculating equation generating portion 362 stores, into the specific heat capacity calculating equation storing device 462, the specific heat capacity calculating equation that has been generated, to complete the method for generating the specific heat capacity calculating equation.

As described above, the method for generating a specific heat capacity calculating equation enables the generation of a specific heat capacity calculating equation that calculates a unique value for the specific heat capacity Cp divided by the thermal conductivity k in a mixed gas being measured.

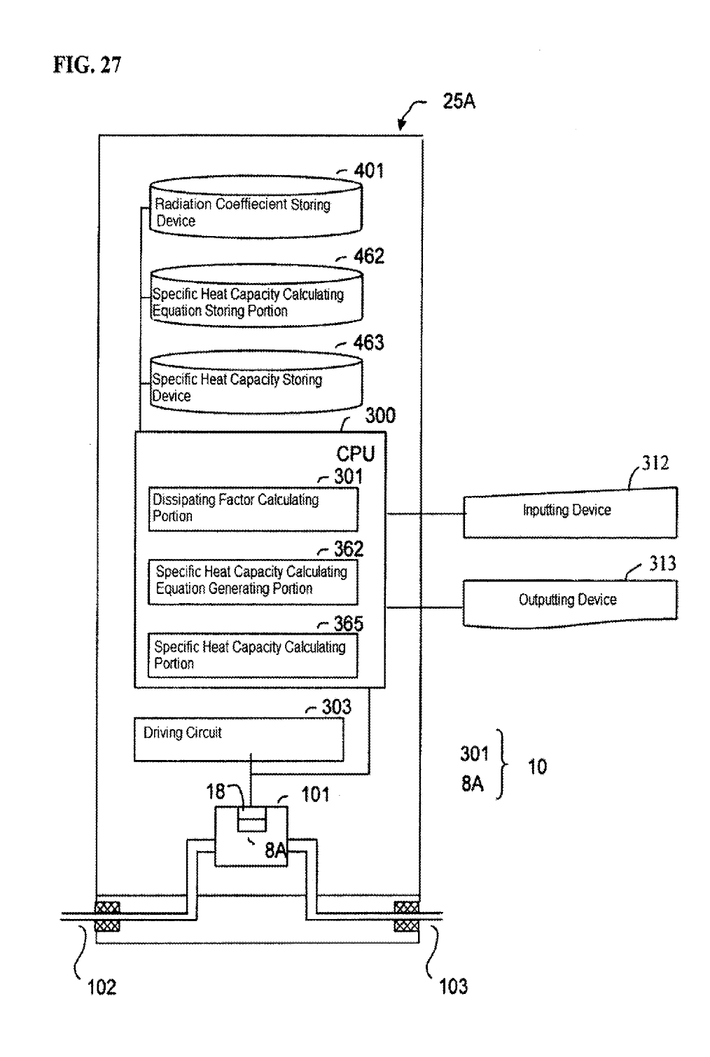

A specific heat capacity measuring system 25A according to an example illustrated in FIG. 27 includes a chamber 101 that is filled with a mixed gas to be measured for which the specific heat capacity Cp divided by the thermal conductivity k is unknown, and a measuring mechanism 10 for measuring the value of the temperature T_{I} of the mixed gas to be measured and the values of a plurality of radiation coefficients M_{I} of the mixed gas to be measured. The specific heat capacity measuring system 25A further has a specific heat capacity calculating equation storing device 462 for storing a specific heat capacity calculating equation having, as independent variables, the temperature T_{I} of the gas and the radiation coefficients M_{I} for the gas at a plurality of heat producing temperatures of the heater element 61A, and having, as the independent variable, the specific heat capacity Cp divided by the thermal conductivity k; and a specific heat capacity calculating portion 365 for calculating the value of the specific heat capacity Cp divided by the thermal conductivity k of the mixed gas being measured, by substituting the value for the temperature T_{I} of the mixed gas being measured and the radiation coefficients M_{I}, for the mixed gas being measured, at a plurality of heat producing temperatures of the heater element 61A into the independent variables of the temperature T_{I} of the gas and the radiation coefficients M_{I} for the gas at a plurality of heat producing temperatures of the heater element 61A in the specific heat capacity calculating equation.

The specific heat capacity calculating equation storing device 462 stores the specific heat capacity calculating equation. As an example, a case is explained here wherein natural gases, including methane (CH₄), propane (C₃H₈), nitrogen (N₂), and carbon dioxide (CO₂), were used as the sample mixed gases for generating the specific heat capacity calculating equation. Additionally, the specific heat capacity calculating equation uses, as independent variables, the radiation coefficient M_{I} of the gas when the heat producing temperature of the heater element 61A is 100° C., the radiation coefficient M_{I} of the gas when the heat producing temperature of the heater element 61A is 150° C., the radiation coefficient M_{I} of the gas when the heat producing temperature of the heater element 61A is 200° C., and the temperature T_{I} of the gas.

In a yet further example, a natural gas that includes, in unknown volume fractions, methane (CH₄), propane (C₃H₈), nitrogen (N₂), and carbon dioxide (CO₂), and for which the value of the specific heat capacity Cp divided by the thermal conductivity k is unknown, is introduced into the chamber 101 as the mixed gas to be measured. The measuring mechanism 10 and heat dissipation factor storing device 401 are the same as in the first form of embodiment, so the explanations thereof are omitted.

The specific heat capacity calculating portion 365 substitutes the values of the radiation coefficients M_{I} and the temperature T_{I} of the mixed gas being measured into the independent variables of the radiation coefficients M_{I} for the gas and the temperature T_{I} of the gas in the specific heat capacity calculating equation, to calculate the value of the specific heat capacity Cp divided by the thermal conductivity k of the mixed gas being measured. A specific heat capacity storing device 463 is also connected to the CPU 300. The specific heat capacity storing device 463 stores the value of the specific heat capacity Cp divided by the thermal conductivity k of the mixed gas being measured, calculated by the specific heat pass the calculating portion 365. The requirements for the other structural elements in the specific heat capacity measuring system 25A are identical to those in the specific heat capacity calculating equation generating system 24A set forth above, so explanations thereof are omitted.

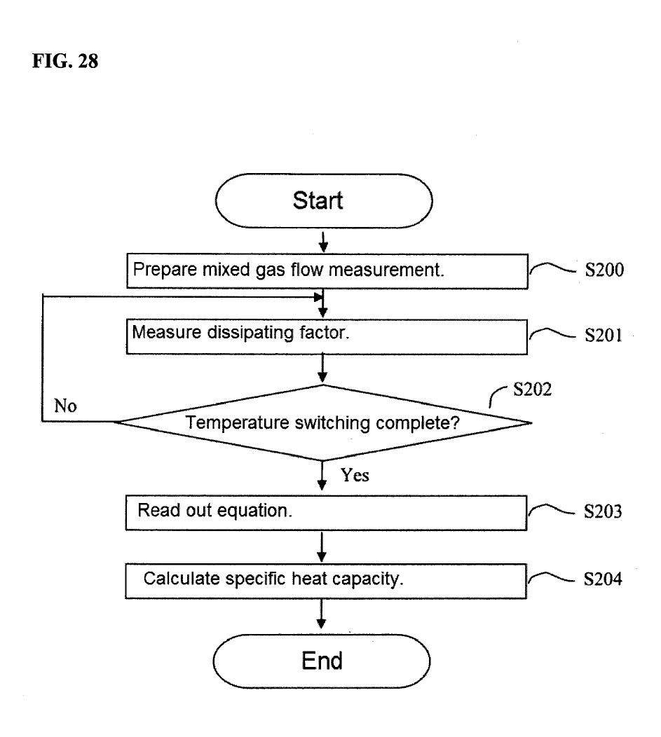

The flowchart in FIG. 28 is used next to explain a method for measuring a specific heat capacity according to the present invention. Note that in the example below a case is explained the heater element 61A of the microchip 8A illustrated in FIG. 27 is caused to produce heat at 100° C., 150° C., and 200° C.

(a) First, Step S200 through Step S202 are performed in the same way as above. Next, in Step S203, the specific heat capacity calculating portion 365 reads in, from the specific heat capacity calculating equation storing device 462, the specific heat capacity calculating equation that uses, as independent variables, the value for the temperature T_{I} of the gas and the values for the radiation coefficients M_{I} when the heat producing temperatures of the heater element 61A are 100° C., 150° C., and 200° C. In addition, the specific heat capacity calculating portion 365 region, from the radiation coefficient storing device 401, the value for the temperature T_{I} of the mixed gas being measured and the values for the radiation coefficients M_{I} of the mixed gas being measured for when the heat producing temperatures of the heater element 61A are 100° C., 150° C., and 200° C.

In Step S204, the specific heat capacity calculating portion 365 substitutes the value of the temperature T_{I} of the mixed gas being measured into the independent variable of the temperature T_{I} in the specific heat capacity calculating equation, and substitutes the value of the radiation coefficients M_{I} of the mixed gas being measured into the independent variable of the radiation coefficients M_{I} in the specific heat capacity calculating equation, to calculate the value of the specific heat capacity Cp divided by the thermal conductivity k of the mixed gas being measured. Thereafter, the specific heat capacity calculating portion 365 stores, into the specific heat capacity storing device 463, the value calculated for the specific heat capacity Cp divided by the thermal conductivity k, to complete the method for measuring the specific heat capacity. The method for measuring the specific heat capacity described above, enables the measurement of the specific heat capacity Cp divided by the thermal conductivity k in a mixed gas that is a mixed gas to be measured, from measured values for the radiation coefficients M_{I} of the mixed gas to be measured, without using costly gas chromatography equipment or speed-of-sound sensors.

First, as illustrated in FIG. 20, 19 different sample mixed gases, having mutually differing volume densities of ethane, propane, butane, nitrogen, and carbon dioxide, were prepared. Following this, the values of the radiation coefficient M_{I} for each of the 19 mixed gas samples are measured when the heater element has been caused to produce heat at a plurality of temperatures. Thereafter, support vector regression, based on the known values for the specific heat capacities Cp divided by the thermal conductivities k in the 19 sample mixed gases and the plurality of measured values for the radiation coefficients M_{I}, was used to generate an equation for calculating the specific heat capacity Cp divided by the thermal conductivity k using the radiation coefficients M_{I} as independent variables and the specific heat capacity Cp divided by the thermal conductivity k as the dependent variable.

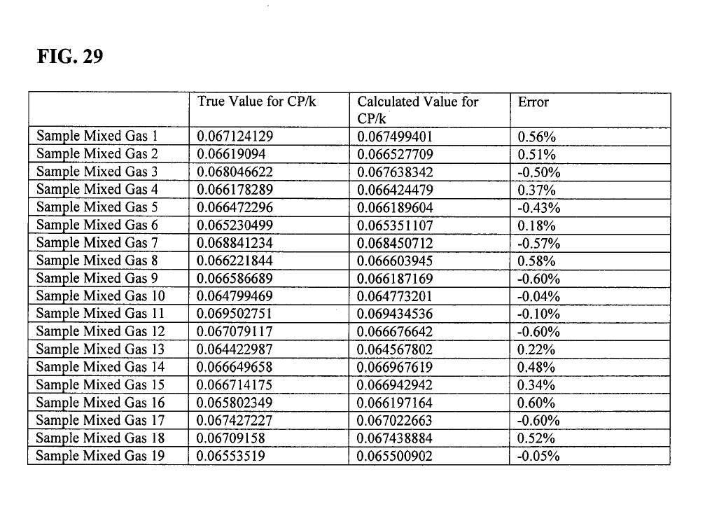

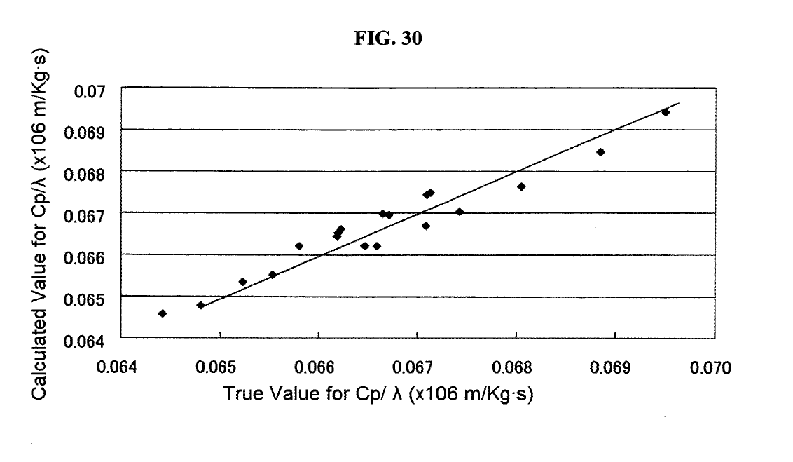

Following this, the equation for calculating the specific heat capacity Cp divided by the thermal conductivity k was used to calculate calculated values for the specific heat capacities Cp divided by the thermal conductivities k in the 19 sample mixed gases, and the true values for the specific heat capacities Cp divided by the thermal conductivities k in the 19 sample mixed gases were compared. When this was done, the error in the calculated values, relative to the true values for the specific heat capacities Cp divided by the thermal conductivities k, as illustrated in FIG. 29 and FIG. 30, where within −0.6% and +0.6%. The ability to calculate accurately the specific heat capacity Cp divided by the thermal conductivity k from measured values for radiation coefficients M_{I}, through the use of a calculating equation for the specific heat capacity Cp divided by the thermal conductivity k that has the radiation coefficients M_{I} as the independent variables and the specific heat capacity Cp divided by the thermal conductivity k as the dependent variable was thus demonstrated.

As is illustrated in Equation (48), above, the specific heat capacity Cp divided by the thermal conductivity k in the mixed gas that has the four types of gas components is obtained as an equation having, as variables, the radiation coefficients M_{I}(T_{H1}), M_{I}(T_{H2}), and M_{I}(T_{H3}) of the mixed gas when the heat producing temperatures of the heater element 61A are T_{H1}, T_{H2}, and T_{H3}. Additionally, the radiation coefficient M_{I} of the mixed gas, as indicated in Equation (32), above, depends on the resistance value R_{H} of the heater element 61A and on the resistance value R_{I} of the first temperature measuring element 62A. Given this, the inventors discovered that the specific heat capacity Cp divided by the thermal conductivity k in a mixed gas can also be obtained as an equation having, as variables, the resistances R_{H1}(T_{H1}), R_{H2}(T₂), and R_{H3}(T_{H3}) of the heater element 61A when the temperatures of the heater element 61A are T_{H1}, T_{H2}, and T_{H3}, and the resistance value R_{I} of the first temperature measuring element 62A that is in contact with the mixed gas, as shown in Equation (50), below.

Cp/k=g₈[R_{H1}(T_{H1}),R_{H2}(T_{H2}),R_{H3}(T_{H3}),R_{I}] (50)

Given this, the specific heat capacity Cp divided by the thermal conductivity k in a mixed gas can be calculated uniquely by measuring the resistances R_{H1}(T_{H1}), R_{H2}(T_{H2}), and R_{H3}(T_{H3}) of the heater element 61A when the heat producing temperatures of the heater element 61A, which is in contact with the mixed gas, are T_{H1}, T_{H2}, and T_{H3}, and the resistance value R_{I} of the first temperature measuring element 62A that is in contact with the mixed gas prior to the heat production by the heater element 61A, for example, and then substituting into Equation (50).

Furthermore, the specific heat capacity Cp divided by the thermal conductivity k in a mixed gas can also be obtained as an equation having, as variables, the currents I_{H1}(T_{H1}), I_{H2}(T_{H2}), and I_{H3}(T_{H3}) flowing in the heater element 61A when the temperatures of the heater element 61A are T_{H1}, T_{H2}, and T_{H3}, and the current I_{I} flowing in the first temperature measuring element 62A that is in contact with the mixed gas, as shown in Equation (51), below.

Cp/k=g₉[I_{H1}(T_{H1}),I_{H2}(T_{H2}),I_{H3}(T_{H3}),I_{I}] (51)

Conversely, the specific heat capacity Cp divided by the thermal conductivity k in a mixed gas can also be obtained from an equation having, as variables, the voltages V_{H1}(T_{H1}), V_{H2}(T_{H2}), and V_{H3}(T_{H3}) of the heater element 61A when the temperatures of the heater element 61A are T_{H1}, T_{H2}, and T_{H3}, and the voltage V_{I} of the first temperature measuring element 62A that is in contact with the mixed gas, as shown in Equation (52), below.

Cp/k=g₁₀[V_{H1}(T_{H1}),V_{H2}(T_{H2}),V_{H3}(T_{H3}),V_{I}] (52)

Conversely, the specific heat capacity Cp divided by the thermal conductivity k in a mixed gas can also be obtained as an equation having, as variables, the output voltages AD_{H1}(T_{H1}), AD_{H2}(T_{H2}), and AD_{H3}(T_{H3}) of analog-digital converting circuits that are connected to the heater element 61A when the temperatures of the heater element 61A are T_{H1}, T_{H2}, and T_{H3}, and the output voltage AD_{I} of an A/D converting circuit that is connected to the first temperature measuring element 62A that is in contact with the mixed gas, as shown in Equation (53), below.

Cp/k=g₁₁[AD_{H1}(T_{H1}),AD_{H2}(T_{H2}),AD_{H3}(T_{H3}),AD_{I}] (53)

Consequently, specific heat capacity Cp divided by the thermal conductivity k in a mixed gas can also be obtained from an equation having, as variables, electric signals S_{H1}(T_{H1}), S_{H2}(T_{H2}), and S_{H3}(T_{H3}) from the heater element 61A when the heat producing temperatures of the heater element 61A are T_{H1}, T_{H2}, and T_{H3}, and an electric signal S_{I} from the first temperature measuring element 62A that is in contact with the mixed gas, as shown in Equation (54), below.

Cp/k=g₁₂[S_{H1}(T_{H1}),S_{H2}(T_{H2}),S_{H3}(T_{H3}),S_{I}] (54)

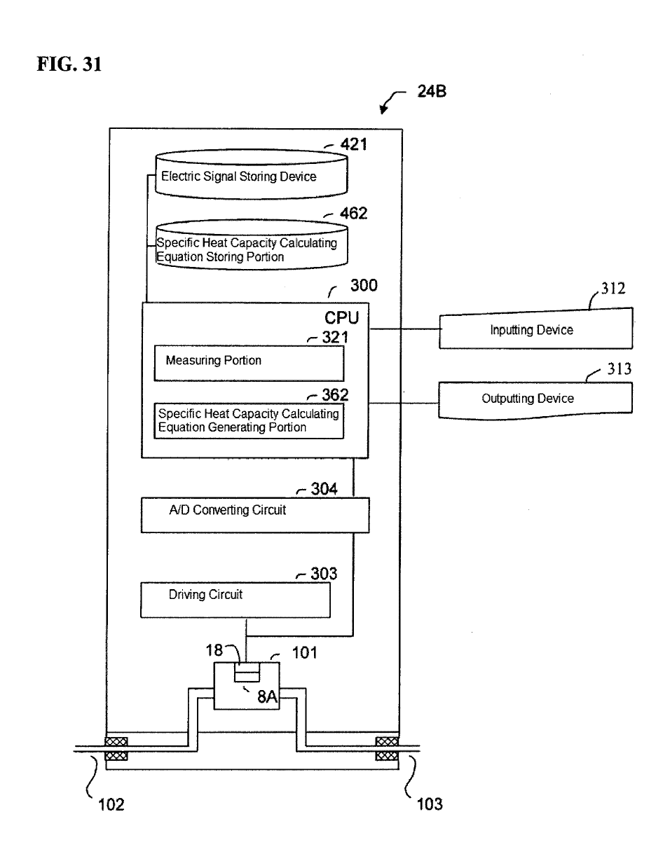

Here a specific heat capacity calculating equation generating system 24B as illustrated in FIG. 31 includes a measuring portion 321, illustrated in FIG. 31, for measuring values of electric signals S_{I} from the first temperature measuring element 62A, illustrated in FIG. 1 and FIG. 2, that are dependent on the respective temperatures T_{I} of the plurality of sample mixed gases, and the values of electric signals S_{H} from the heater element 61A at each of the plurality of heat producing temperatures T_{H}; and a specific heat capacity calculating equation generating portion 362 for generating a specific heat capacity calculating equation based on known values for specific heat capacities Cp divided by thermal conductivities k in a plurality of sample mixed gases, the measured value for the electric signal S_{I} from the first temperature measuring element 62A, and the plurality of measured values for the electric signals from the heater element 61A at the plurality of heat producing temperatures, having an electric signal S_{I} from the first temperature measuring element 62A and the electric signals S_{H} from the heater element 61A at the plurality of heat producing temperatures T_{H} as independent variables, and having the specific heat capacity Cp divided by thermal conductivity k as the dependent variable.

As above, the measuring portion 321 measures the value of the electric signal S_{I} from the first temperature measuring element 62A, and, from the heater element 61A, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

The specific heat capacity calculating equation generating portion 362 that is included in the CPU 300 collection the respective known values for the specific heat capacities Cp divided by the thermal conductivities k in, for example, each of the first through fourth sample mixed gases, the plurality of measured values for the electric signals S_{I} from the first temperature measuring element 62A, and the plurality of measured values for the electric signals S_{H1} (T_{H1}), S_{H2} (T_{H2}), and S_{H3} (T_{H3}) from the heater element 61A. Furthermore, the specific heat capacity calculating equation generating portion 362 uses multivariate analysis based on the collected values for the specific heat capacities Cp divided by the thermal conductivities k, the electric signals S_{I}, and the electric signals S_{H}, to generate a specific heat capacity calculating equation having the electric signal S_{I} from the first temperature measuring element 62A and the electric signals S_{H1} (T_{H1}), S_{H2} (T_{H2}), and S_{H3} (T_{H3}) from the heater element 61A as the independent variables, and the specific heat capacity Cp divided by the thermal conductivity k in as the dependent variable. The other structural elements of the specific heat capacity calculating equation generating system 24B illustrated in FIG. 31 are identical to those of the specific heat capacity calculating equation generating system 24A that is illustrated in FIG. 25, so explanations thereof are omitted.

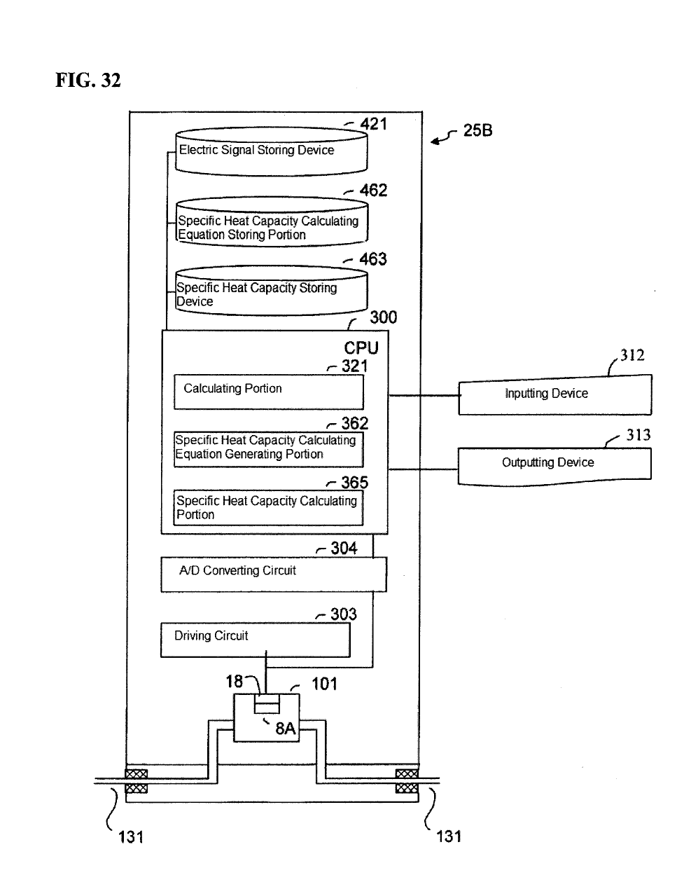

As illustrated in FIG. 32, a specific heat capacity measuring system 25B as set forth has a measuring portion 321 for measuring the value of an electric signal S_{I} from the first temperature measuring element 62A, which is dependent on the temperature T_{I} of the gas being measured, and values of the electric signals S_{H} from the heater element 61A at each of the plurality of heat producing temperatures T_{H}; a specific heat capacity calculating equation storing device 462 for storing a specific heat capacity calculating equation that has the electric signal S_{I} from the first temperature measuring element 62A and the electric signals S_{H} from the heater element 61A at the plurality of heat producing temperatures T_{H} as independent variables and the specific heat capacity Cp divided by the thermal conductivity k as the dependent variable; and a specific heat capacity calculating portion 365 for calculating the value of the specific heat capacity Cp divided by the thermal conductivity k of the mixed gas being measured, by substituting the measured value of the electric signal S_{I} from the first temperature measuring element 62A and the measured values of the electric signals S_{I} from the heater element 61A into the independent variable that is the electric signal S_{I} from the first temperature measuring element 62A and the independent variables that are the electric signals S_{H} from the heater element 61A in the specific heat capacity calculating equation.

The specific heat capacity calculating equation includes, for example, as independent variables, the electric signal S_{I} from the first temperature measuring element 62A, the electric signal S_{H1} (T_{H1}) from the heater element 61A at a heat producing temperature T_{H1} of 100° C., the electric signal S_{H2} (T_{H2}) from the heater element 61A at a heat producing temperature T_{H2} of 150° C., and the electric signal S_{H3} (T_{H3}) from the heater element 61A at a heat producing temperature T_{H3} of 200° C.

The first temperature measuring element 62A of the microchip 8A illustrated in FIG. 1 and FIG. 2 outputs an electric signal S_{I} that is dependent on the temperature of the gas that is measured. Following this, the heater element 61A applies driving powers P_{H1}, P_{H2}, and P_{H3} from the driving circuit 303 illustrated in FIG. 32. When the driving powers P_{H1}, P_{H2}, and P_{H3} are applied, the heater element 61A that is in contact with the mixed gas being measured produces heat at a temperature T_{H1} of 100° C., a temperature T_{H2} of 150° C., and a temperature T_{H3} of 200° C., for example, to output an electric signal S_{H1} (T_{H1}) at the heat producing temperature T_{H1}, an electric signal S_{H2} (T_{H2}) at the heat producing temperature T_{H2}, and an electric signal S_{H3} (T_{H3}) at the heat producing temperature T_{H3}.

The measuring portion 321 measures the value of the electric signal S_{I} from the first temperature measuring element 62A, which is in contact with the mixed gas being measured, and, from the heater element 61A, which is in contact with the mixed gas being measured, the values of the electric signal S_{H1} (T_{H1}) at the heat producing temperature T_{H1}, the electric signal S_{H2} (T_{H2}) at the heat producing temperature T_{H2}, and the electric signal S_{H3} (T_{H3}) at the heat producing temperature T_{H3}, and stores the measured values in the electric signal storing device 421.

The specific heat capacity calculating portion 365 substitutes the respected respective measured values into the independent variables of the electric signal S_{I} from the first temperature measuring element 62A and the electric signals S_{H1} (T_{H1}), S_{H2} (T_{H2}), and S_{H3} (T_{H3}) from the heater element 61A in the specific heat capacity calculating equation that is stored in the specific heat capacity calculating equation storing device 462, to calculate the value of the specific heat capacity Cp divided by the thermal conductivity k of the mixed gas being measured. The other structural elements of the specific heat capacity measuring system 25B illustrated in FIG. 32 are identical to those of the specific heat capacity measuring system 25A that is illustrated in FIG. 27, so explanations thereof are omitted.

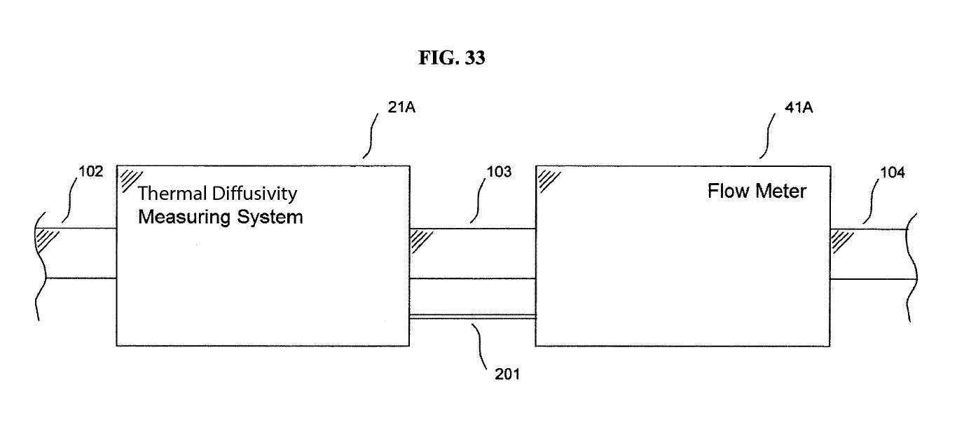

The flow rate measuring system as set forth in FIG. 33, includes a thermal diffusivity measuring system 21A; and a flow meter 41A for measuring a flow rate Q of the mixed gas being measured, for which the thermal diffusivity was measured by the thermal diffusivity measuring system 21A. The thermal diffusivity measuring system 21A and the flow meter 41A are connected by a flow path 103 wherein flows the mixed gas being measured. The thermal diffusivity measuring system 21A was explained above, and thus the description thereof will be omitted. The thermal diffusivity measuring system 21A and the flow meter 41A are connected electrically by an interconnection 201.

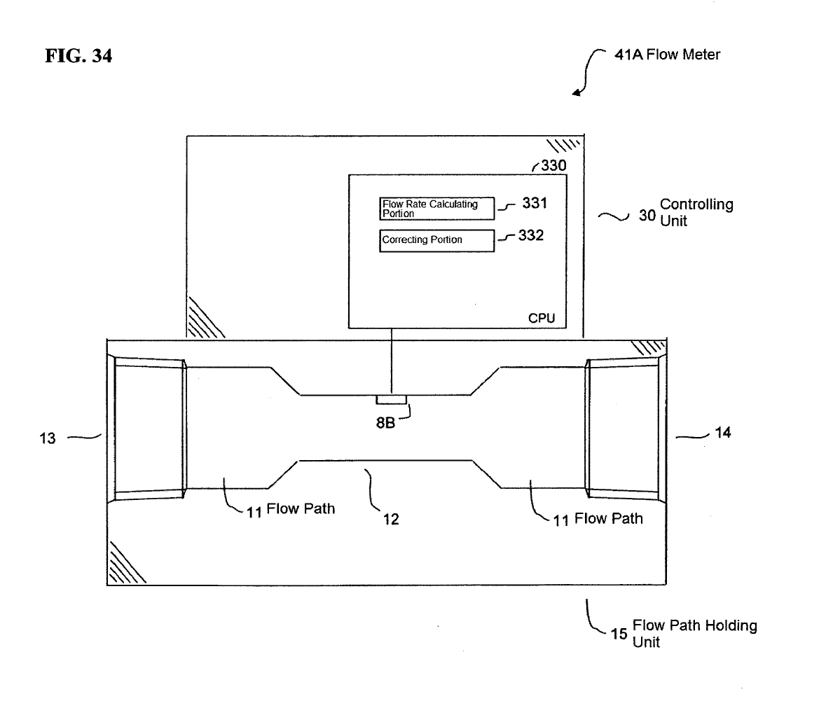

The flow meter 41A, as illustrated in FIG. 34, which is a cross-sectional diagram, has a flow path holding unit 15 that is provided with a flow path 11 wherein flows the mixed gas being measured, and a controlling unit 30, disposed on the flow path holding unit 15. The controlling unit 30 comprises a CPU 330. Note that while FIG. 34 is a cross-sectional diagram, the interior of the controlling unit 30 is drawn schematically, and actually a microprocessor, a random access memory (RAM), a read-only memory (ROM), I/O circuitry, and the like, are disposed within the controlling, unit 30.

A filling opening 13 and a discharge opening 14 are provided in the flow path holding unit 15, and a flow path 11 passes through the interior of the flow path holding unit 15 from the filling opening 13 to the discharge opening 14. A flow path 103, illustrated in FIG. 33, passes through the filling opening 13. The microchip 8B is disposed on an inner wall of the flow path 11.

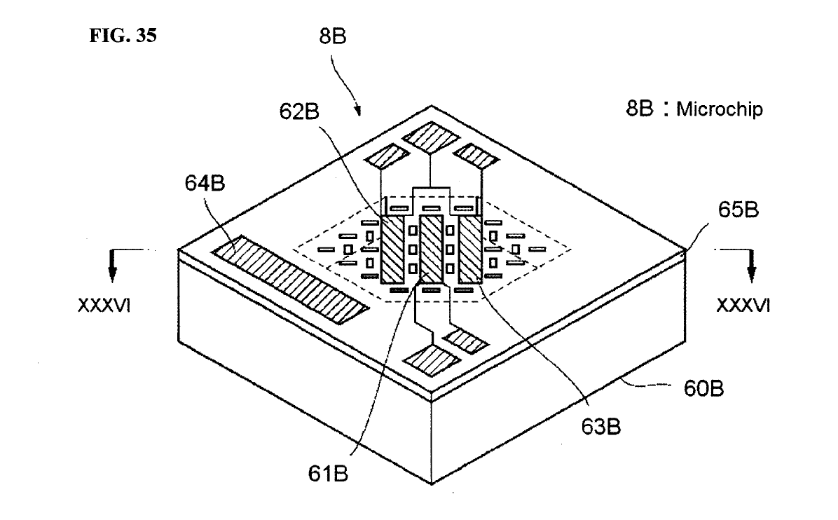

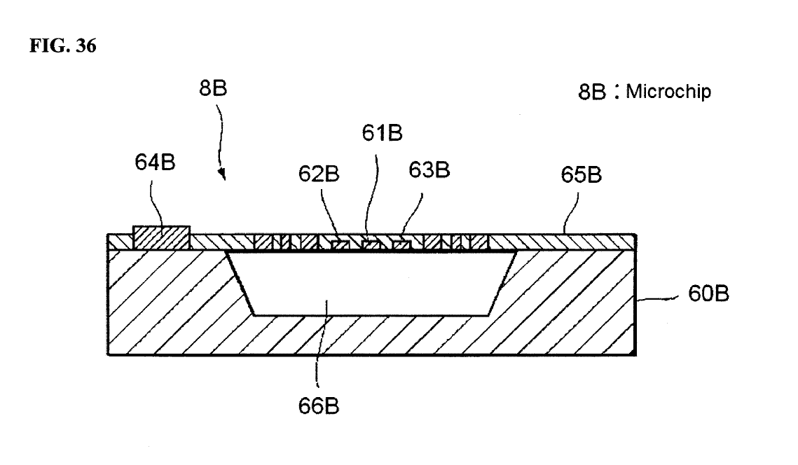

The microchip 8B, as illustrated in FIG. 35, which is a perspective view, and in FIG. 36, which is a cross-sectional diagram unit from the direction of section XXXVI-XXXVI, has a structure that is identical to that of the microchip 8A that was explained above. The microchip 8B has a substrate 60B, which is provided with a cavity 66B, a dielectric layer 65B, which is disposed so as to cover the cavity 66B on the substrate 60B, and a heater 61B that is disposed on the dielectric layer 65B, Furthermore, the microchip 8B comprises an upstream temperature measuring resistive element 62B, illustrated in FIGS. 35 and 36, that is positioned on the upstream side of the heater 61B in the flow path 11 that is illustrated in FIG. 4, a downstream temperature measuring resistive element 63B that is positioned on the downstream side of the heater 61B, and a peripheral temperature sensor 64B that is disposed on the upstream side of the upstream temperature measuring resistive element 62B.

The portion of the dielectric layer 65B that covers the cavity 66B forms a thermally insulating diaphragm. The peripheral temperature sensor 64B measures the temperature of the mixed gas being measured that has flowed into the flow path 11, illustrated in FIG. 34. The heater 61B, illustrated in FIGS. 35 and 36, is disposed in the center of the dielectric layer 65B that covers the cavity 66B, and heats the mixed gas being measured, which flows in the flow path 11, so as to be constant temperature higher, such as, for example, 10° C. higher, than the temperature measured by the peripheral temperature sensor 64B. The upstream temperature measuring resistive element 62B is used to detect the temperature on the upstream side of the heater 61B, and the downstream temperature measuring resistive element 63B is used to detect the temperature on the downstream side of the heater 61B.

Here, when the mixed gas being measured is stationary within the flow path 11 that is illustrated in FIG. 34, the heat that is added by the heater 61B, illustrated in FIG. 35 and FIG. 36, diffuses symmetrically to the upstream side and the downstream side. Consequently, the temperatures of the upstream temperature measuring resistive element 62B and the downstream temperature measuring resistive element 63B are be equal, and thus the electrical resistance of the upstream temperature measuring resistive element 62B and the downstream temperature measuring resistive element 63B are equal.

In contrast, when the mixed gas being measured flows from upstream to downstream within the flow path 11 that is illustrated in FIG. 34, the heat that is added by the heater 61B, illustrated in FIG. 35 and FIG. 36, is carried in the downstream direction. Consequently, the temperature of the downstream temperature measuring resistive element 63B is higher than that of the upstream temperature measuring resistive element 62B. Because of this, there is a difference between the electrical resistance of the upstream temperature measuring resistive element 62B and the electrical resistance of the downstream temperature measuring resistive element 63B. The difference between the electrical resistance of the downstream temperature measuring resistive element 63B and the electrical resistance of the upstream temperature measuring resistive element 62B has a correlation relationship with the flow rate Q of the mixed gas being measured within the flow path 11 illustrated in FIG. 34. Because of this, it is possible to calculate the flow rate Q of the mixed gas flowing within the flow path 11 illustrated in FIG. 34 from the difference between the electrical resistance of the downstream temperature measuring resistive element 63B, illustrated in FIG. 35 and FIG. 36, and the electrical resistance of the upstream temperature measuring resistive element 62B. Note that the units for the flow rate Q are, for example, m³/s or m³/h.

An orifice 12 for narrowing the inner diameter of the flow path 11 is provided in a portion of the flow path 11. The cross-sectional area of the flow path 11 in the orifice 12 is set appropriately to cause the speed of flow of the mixed gas that is being measured in the flow path 11 to be within the measurement range of the microchip 8B. Additionally, the microchip SB is connected electrically to the CPU 330 of the controlling unit 30.

The flow rate calculating portion 331 of the CPU 330 receives, from the microchip 8B, the value of the electrical resistance of the downstream temperature measuring resistive element 63B, illustrated in FIG. 35 and FIG. 36, and the value of the electrical resistance of the upstream temperature measuring resistive element 62B. Furthermore, the flow rate calculating portion 331, illustrated in FIG. 34, calculates the value of the flow rate Q of the mixed gas being measured, which flows in the flow path 11, illustrated in FIG. 34, based on the difference between the value of the electrical resistance of the downstream temperature measuring resistive element 63B, illustrated in FIG. 35 and FIG. 36, and the value of the electrical resistance of the upstream temperature measuring resistive element 62B. Note that it the correlation relationship between the flow rate Q of the mixed gas within the flow path 11 illustrated in FIG. 34 and the difference between the electrical resistance of the downstream temperature measuring resistive element 63B, illustrated in FIG. 35 and FIG. 36, and the electrical resistance of the upstream temperature measuring resistive element 62B is calibrated in advance using a calibration gas.

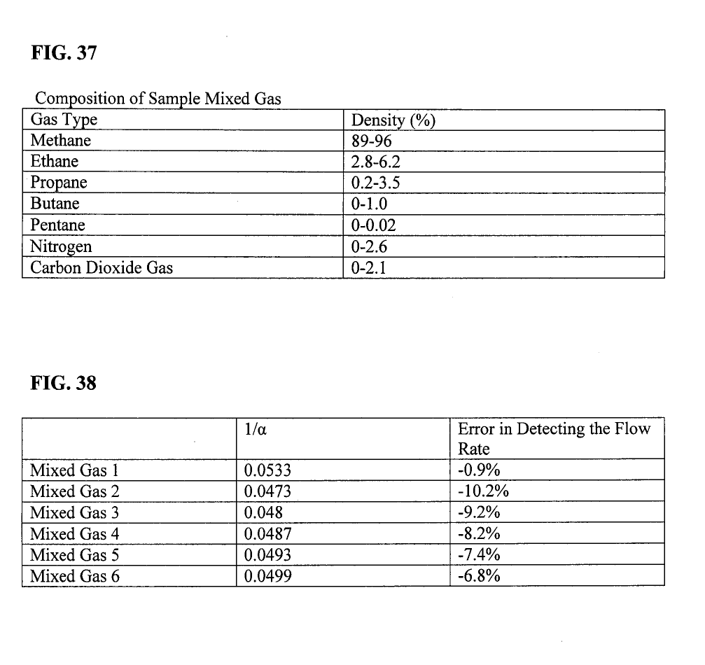

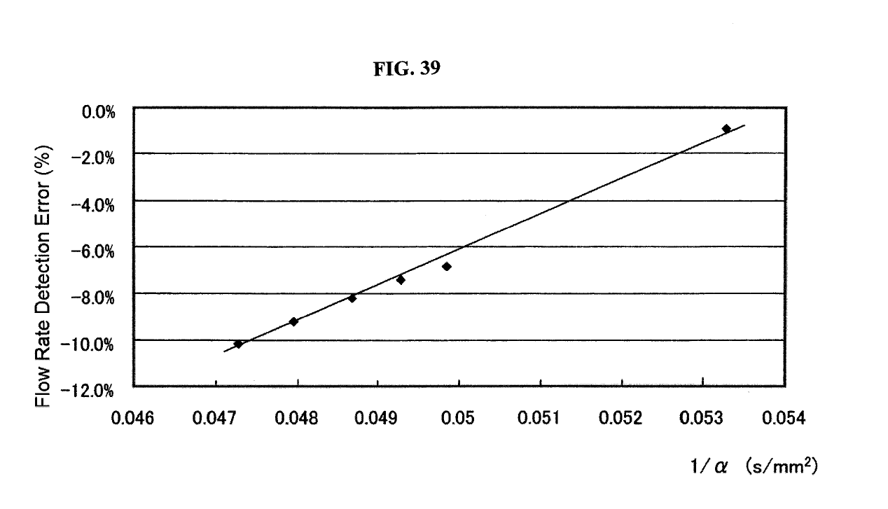

Here the flow rate Q of the gas, detected using the flow rate sensor that includes the microchip SB and the flow rate calculating portion 331, tends to have error that increases with the inverse 1/α of the thermal diffusivity of the gas. As an example, the flow rate sensor was first calibrated using, as the calibration gas, a public utility gas 13A wherein the calorific value was adjusted to 45 MJ/m³. Following this, the first through sixth mixed gases, having the components presented in FIG. 37 were prepared. The first through sixth mixed gases, as illustrated in FIG. 38, had different inverse 1/α thermal diffusivities. Following this when the first through sixth mixed gases were caused to flow through the flow meter 41A at same flow rates as the flow rate of the calibration gas, error occurred proportional to the inverse 1/α thermal diffusivities.

Consequently, if there is a difference between the inverse 1/α₀ of the thermal diffusivity of the calibration gas and the inverse 1/α₁ of the thermal diffusivity of the mixed gas being measured, then there may be error in the detected value for the flow rate Q of the mixed gas being measured. In this regard, the CPU 330, illustrated in FIG. 34, is provided with a correcting portion 332 to correct the error in the detected value for the flow rate Q of the mixed gas being measured, based on the difference between the inverse 1/α₀ of the thermal diffusivity of the calibration gas and the inverse 1/α₁ of the thermal diffusivity of the mixed gas being measured. The correcting portion 332 receives the detected value for the flow rate Q of the mixed gas being measured, calculated by the flow rate calculating portion 331. Moreover, the correcting portion 332 receives the measured value for the inverse 1/α of the thermal diffusivity of the mixed gas being measured, from the thermal diffusivity measuring system 21A, through the interconnection 201 illustrated in FIG. 33.

Furthermore, the correcting portion 332, illustrated in FIG. 34, divides the detected value for the flow rate Q for the mixed gas being measured by the inverse 1/α₀ of the thermal diffusivity of the calibration gas and then multiplies by the inverse 1/α₁ of the thermal diffusivity of the mixed gas being measured, as shown by Equation (55), below. An accurate flow rate Q of the mixed gas being measured, wherein the error is corrected based on difference between the inverse 1/α₀ of the thermal diffusivity of the calibration gas and the inverse 1/α₁ of the thermal diffusivity of the mixed gas being measured, is thus calculated.

Q_{C}=Q×(1/α)/(1/α₀)=Q×α₀/α (55)

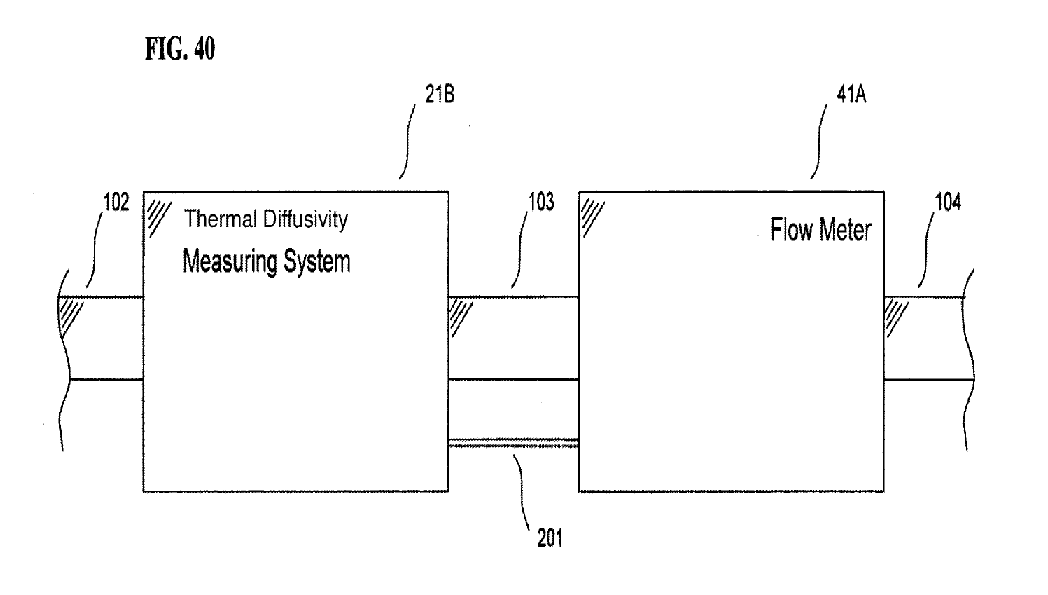

The flow rate measuring system as set forth and illustrated in FIG. 40 has a thermal diffusivity measuring system 21B; and a flow meter 41A for measuring a flow rate Q of the mixed gas being measured, for which the thermal diffusivity was measured by the thermal diffusivity measuring system 21B. The thermal diffusivity measuring system 21B is identical to that above. Additionally, because, in the flow meter 41A, the method for correcting the detected value for the flow rate Q of the mixed gas being measured using the measured value of the inverse 1/α of the thermal diffusivity of the mixed gas being measured, measured by the thermal diffusivity measuring system 21B, is identical to that above as welt, the explanation thereof will be omitted.

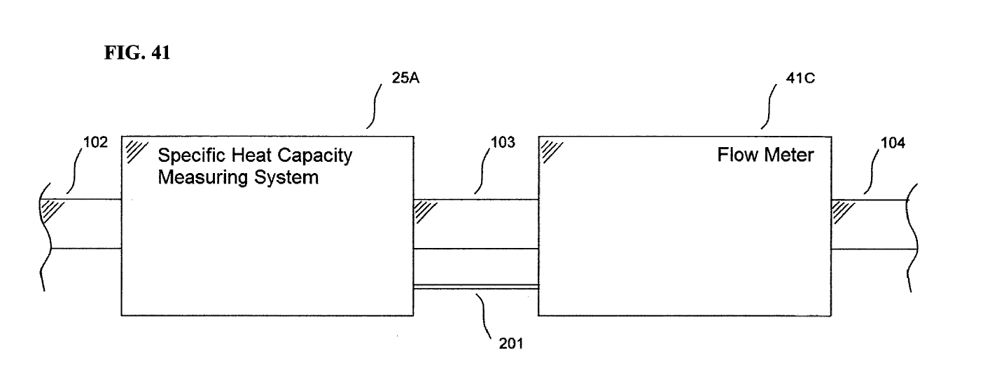

A flow rate measuring system as illustrated in FIG. 41, has a specific heat capacity measuring system 25A; and a flow meter 41C for measuring a flow rate Q of the mixed gas being measured, for which the specific heat capacity Cp divided by the thermal conductivity k was measured by the specific heat capacity measuring system 25A. The specific heat capacity measuring system 25A and the flow meter 41C are connected by a flow path 103 wherein flows the mixed gas being measured. The specific heat capacity measuring system 25A was explained above, and thus the description thereof will be omitted. The specific heat capacity measuring system 25A and the flow meter 41C are connected electrically by an interconnection 201.

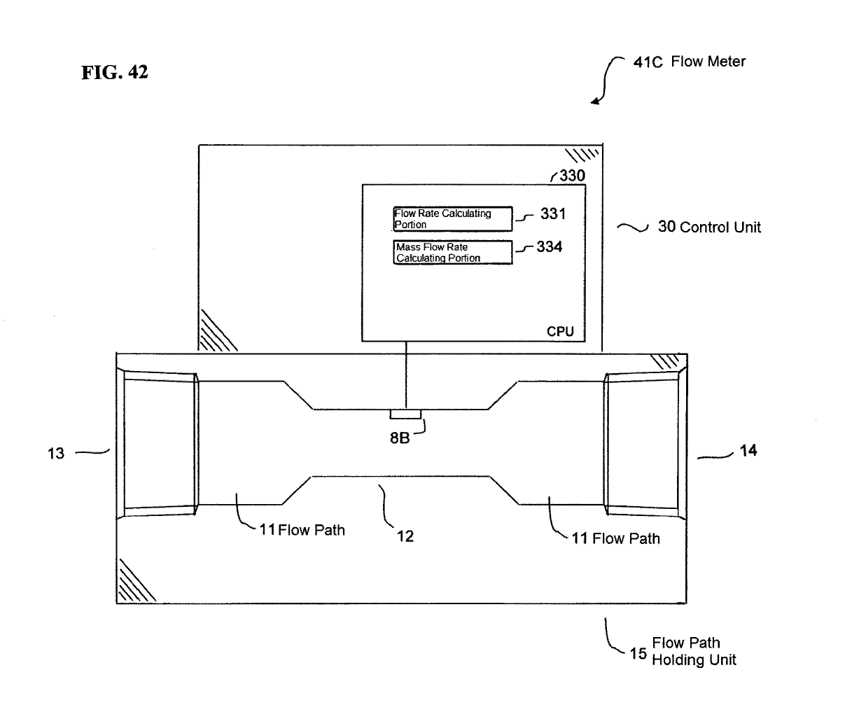

The CPU 330 of the flow meter 41C, as illustrated in FIG. 42, is provided with a mass flow rate calculating portion 334 for calculating the mass flow rate Qm of the mixed gas being measured, based on the detected value for the volumetric flow rate Q of the mixed gas being measured and the measured value for the specific heat capacity Cp divided by the thermal conductivity k of the mixed gas being measured. The mass flow rate calculating portion 334 receives the detected value for the volumetric flow rate Q of the mixed gas being measured, calculated by the flow rate calculating portion 331. Moreover, the mass flow rate calculating portion 334 receives the measured value for the specific heat capacity Cp divided by the thermal conductivity k of the mixed gas being measured, from the specific heat capacity measuring system 25A, through the interconnection 201 illustrated in FIG. 41.

Here the detected value for the volumetric flow rate Q of the mixed gas being measured, calculated by the flow rate calculating portion 331, as shown by Equation (56), below, is proportional to the product of the thermal diffusivity a and the flow speed d. Here A is a constant.

Q=A×(1/α)×d=A×ρCp/k×d (56)

The mass flow rate calculating portion 334, illustrated in FIG. 42, obtains the product of the density ρ and the flow speed d by dividing the detected value for the volumetric flow rate Q of the mixed gas being measured by the specific heat capacity Cp divided by the thermal conductivity k, and by the constant A, as shown in Equation (57), below.

Q/(ACp/k)=ρ×d (57)

Moreover, the mass flow rate calculating portion 334, as shown in Equation (58), below, calculate the mass flow rate m of the mixed gas being measured by multiplying the product of the density ρ and the flow speed d, thus obtained, by the cross-sectional area u of the orifice 12. Note that the units for the mass flow rate Qm are, for example, kg/s or kg/h.

Qm×ρ×d×u (58)

The other structural elements of the flow meter 41C are identical to those of the flow meter 41A that is illustrated in FIG. 34, so explanations thereof are omitted.

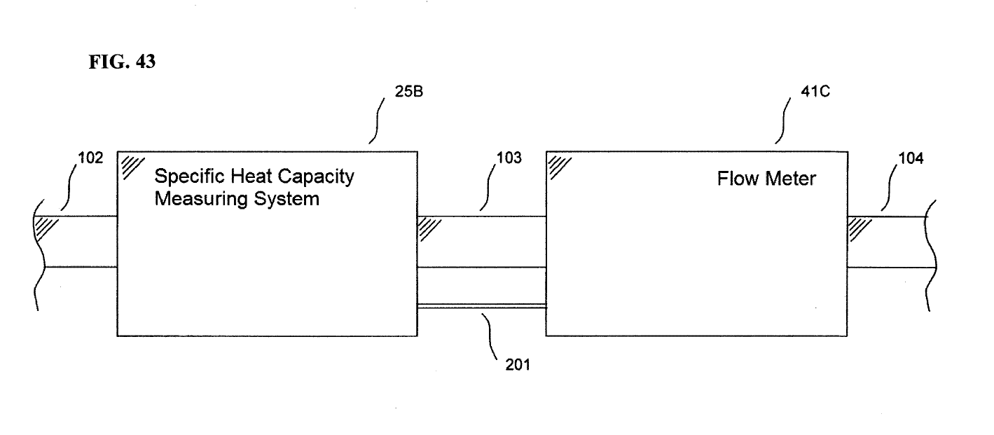

A flow rate measuring system as illustrated in FIG. 43, has a specific heat capacity measuring system 25B; and a flow meter 41C for measuring a flow rate Q of the mixed gas being measured, for which the specific heat capacity Cp divided by the thermal conductivity k was measured by the specific heat capacity measuring system 25B. The specific heat capacity measuring system 25B is identical to that above. In the flow meter 41C, the method for calculating the mass flow rate Qm is the same as other examples above, so the explanation thereof is omitted.

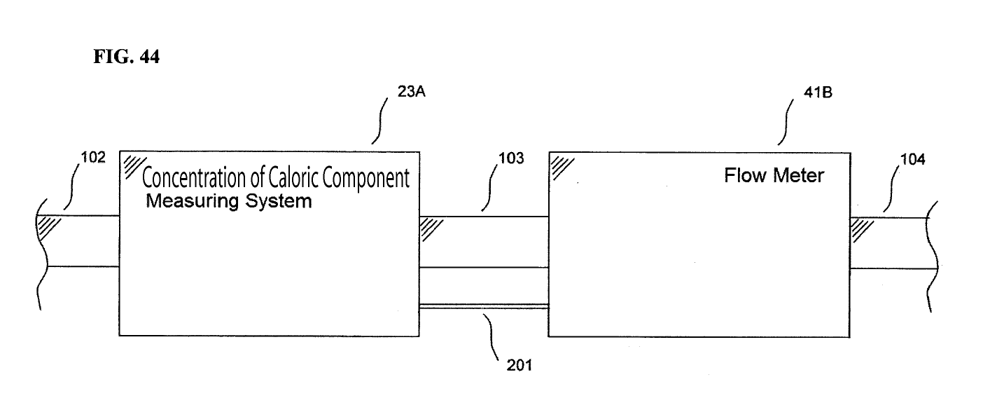

The flow rate measuring system as set forth and illustrated in FIG. 44, includes a concentration of caloric component measuring system 23A; and a flow meter 41B for measuring a flow rate Q of the mixed gas being measured, for which the concentration of caloric component C₀ was measured by the concentration of caloric component measuring system 23A. The concentration of caloric component measuring system 23A and the flow meter 41B are connected by a flow path 103 wherein flows the mixed gas being measured. The concentration of caloric component measuring system 23A was explained, and thus the description thereof will be omitted. The concentration of caloric component measuring system 23A and the flow meter 41B are connected electrically by an interconnection 201.

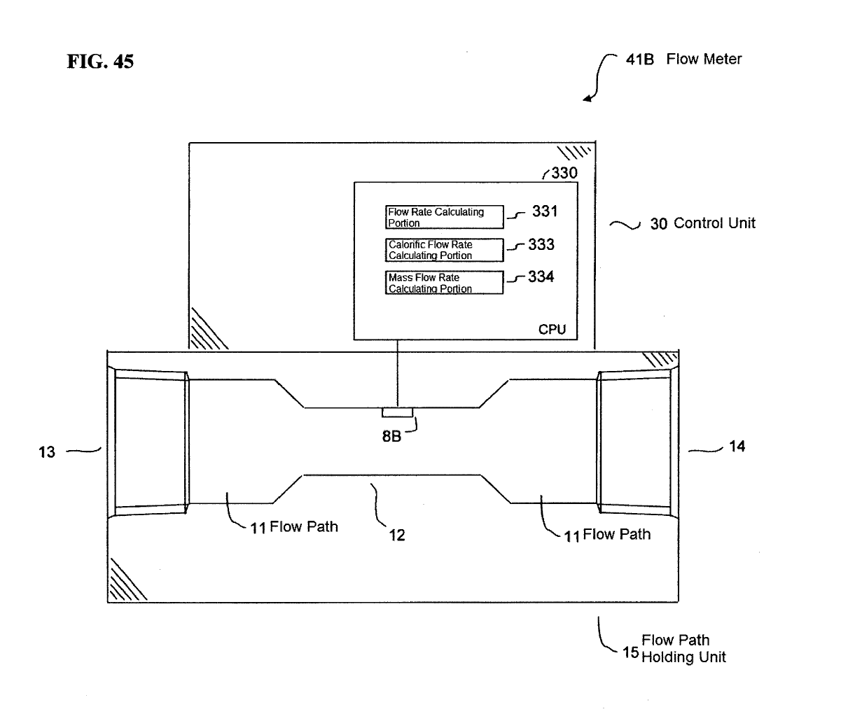

The CPU 330 of the flow meter 41B, as illustrated in FIG. 45, is provided with a calorific flow rate calculating portion 333 for calculating the calorific flow rate Q_{C} of the caloric components of the mixed gas being measured, based on the detected value for the flow rate Q of the mixed gas being measured and the measured value for the concentration of caloric component C₀ of the mixed gas being measured. The calorific flow rate calculating portion 333 receives the value for the mass flow rate Qm of the mixed gas being measured, calculated by the mass flow rate calculating portion 334. Moreover, the calorific flow rate calculating portion 333 receives the measured value for the concentration of caloric component of the mixed gas being measured, from the concentration of caloric component measuring system 23A, through interconnection 201 illustrated in FIG. 44.

Moreover, the calorific flow rate calculating portion 333, illustrated in FIG. 45 calculates the flow rate Q_{C} of the caloric component within the mixed gas being measured, as shown in Equation (59), below, by multiplying the concentration of caloric component C₀ of the mixed gas being measured by the mass flow rate Qm of the mixed gas being measured.

Q_{C}=Qm×C_{O} (59)

When non-caloric components are included in a mixed gas being measured, such as natural gas, sometimes it is desirable to measure the flow rate of the caloric components, excluding the non-caloric components. In this regard, the flow rate measuring system enables the accurate measurement of the flow rate of the caloric components of the mixed gas being measured. The other structural elements of the flow meter 41B are identical to those of the flow meter 41A that is illustrated in FIG. 34, so explanations thereof are omitted.

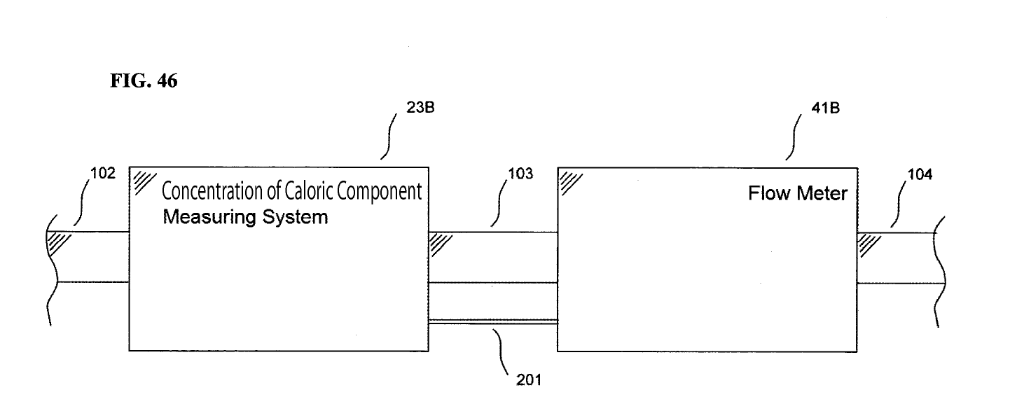

The flow rate measuring system as set forth in a 18th form of embodiment, as illustrated in FIG. 46 has a concentration of caloric component measuring system 23B; and a flow meter 41B for measuring a flow rate Q of the mixed gas being measured, for which the concentration of caloric component C₀ was measured by the concentration of caloric component measuring system 23B. The concentration of caloric component measuring system 23B is identical to that above. Additionally, because, in the flow meter 41B, the method for calculating the flow rate Q_{C} of the caloric component of the mixed gas being measured using the detected values for the concentration of caloric component C₀ and for the flow rate Q of the mixed gas being measured is identical to that in other examples, the explanation thereof will be omitted.

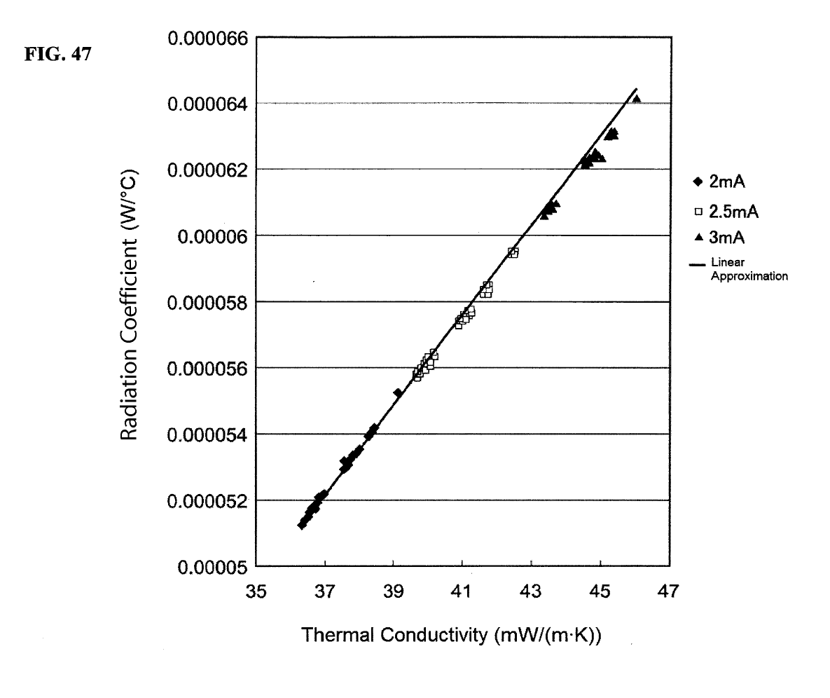

While there are descriptions of example as set forth above, the descriptions and drawings that form a portion of the disclosure are not to be understood to limit the present invention. A variety of alternate examples and operating technologies should be obvious to those skilled in the art. For example, FIG. 47 shows the relationship between the radiation coefficient and the thermal conductivity in a mixed gas when electric currents of 2 mA, 2.5 mA, and 3 mA are applied to the heat producing resistor. As illustrated in FIG. 47, typically there is a proportional relationship between the radiation coefficient and the thermal conductivity of the mixed gas. Consequently, white in certain example the values of the radiation coefficients of the mixed gasses at a plurality of heat producing temperatures of the heat producing resistor were used, instead the generation of the calorific value calculating equation and the calculation of the calorific value may be performed using the thermal conductivities at a plurality of measurement temperatures of the mixed gasses. In this way, the present invention should be understood to include a variety of forms not set forth herein.

1. A thermal diffusivity calculating equation generating system, comprising:
a heater element heating each of a plurality of mixed gases;
a measuring mechanism measuring at least one of a radiation coefficient or a value for thermal conductivity for each of the plurality of mixed gases when the heater element has produced heat at a plurality of heat producing temperatures; and
a thermal diffusivity calculating equation generating portion generating a thermal diffusivity calculating equation, based on known values for thermal diffusivities for each of the plurality of mixed gases and on values for radiation coefficients and thermal conductivities measured at the plurality of heat producing temperatures, using the at least one of the radiation coefficients or the thermal conductivities for the plurality of heat producing temperatures as independent variables and using the thermal diffusivity as a dependent variable.

2. The thermal diffusivity calculating equation generating system as set forth in claim 1, wherein the thermal diffusivity calculating equation generating portion generates the thermal diffusivity calculating equation using support vector regression.

3. A flow rate measuring system as set forth in claim 1, wherein:
a measuring mechanism measuring at least one of a radiation coefficient or a value for thermal conductivity for a mixed gas measured when a heater element has produced heat at a plurality of heat producing temperatures;
a thermal diffusivity calculating equation storing device storing a thermal diffusivity calculating equation that uses at least one of the radiation coefficients or the thermal conductivities for the plurality of heat producing temperatures as independent variables and uses a thermal diffusivity as a dependent variable;
a thermal diffusivity calculating portion calculating a value for the thermal diffusivity of the mixed gas measured through substituting the values of at least one of the radiation coefficients or the thermal conductivities of the mixed gas measured, for the plurality of heat producing temperatures, for the independent variables of at least one of the radiation coefficients or thermal conductivities, for the plurality of heat producing temperatures, in the thermal diffusivity calculating equation;
a flow rate sensor detecting a flow rate of the mixed gas measured, calibrated using a calibration gas; and
a correcting portion correcting detection error in the flow rate due to a difference between the value for the thermal diffusivity of the calibration gas and the value for the thermal diffusivity of the mixed gas measured.

4. The flow rate measuring system as set forth in claim 3, wherein:
the correcting portion corrects the detection error in the flow rate by the flow rate sensor based on a ratio of the value for the thermal diffusivity of the calibration gas and the value for the thermal diffusivity of the mixed gas measured.

5. A concentration of caloric component calculating equation generating system, comprising:
a heater element heating each of a plurality of mixed gases;
a measuring mechanism measuring at least one of a radiation coefficient or a value for thermal conductivity for each of the plurality of mixed gases when the heater element has produced heat at a plurality of heat producing temperatures; and
a concentration of caloric component calculating equation generating portion generating a concentration of caloric component calculating equation, based on known values for caloric component densities for each of the plurality of mixed gases and on values for radiation coefficients and thermal conductivities measured at the plurality of heat producing temperatures, using at least one of the radiation coefficients or the thermal conductivities for the plurality of heat producing temperatures as independent variables and using the concentration of caloric component as a dependent variable.

6. The concentration of caloric component calculating equation generating system as set forth in claim 5, wherein:
the concentration of caloric component calculating equation generating portion generates the concentration of caloric component calculating equation using support vector regression.

7. A flow rate measuring system as set forth in claim 5, wherein:
a measuring mechanism measuring at least one of a radiation coefficient or a value for thermal conductivity for a mixed gas being measured when a heater element has produced heat at a plurality of heat producing temperatures;
a concentration of caloric component calculating equation storing device storing a concentration of caloric component calculating equation using at least one of the radiation coefficients or the thermal conductivities for the plurality of heat producing temperatures as independent variables and uses the caloric component as a dependent variable;
a concentration of caloric component calculating portion calculating a value for the thermal concentration of caloric component of the mixed gas measured by substituting the values of the radiation coefficients or the thermal conductivities of the mixed gas being measured, for the plurality of heat producing temperatures, for the independent variables of the radiation coefficients or thermal conductivities, for the plurality of heat producing temperatures, in the concentration of caloric component calculating equation;
a flow rate sensor, detecting a flow rate of a mixed gas being measured; and
a calorific flow rate calculating portion calculating the flow rate of a caloric component in the mixed gas measured, based on a detection value for the flow rate of the mixed gas measured and a calculated value for the concentration of caloric component of the mixed gas measured.

8. The flow rate measuring system as set forth in claim 7, wherein the caloric component is an alkane.

9. The flow rate measuring system as set forth in claim 7, wherein the mixed gas measured includes nitrogen.

10. The flow rate measuring system as set forth in claim 7, wherein the mixed gas measured includes carbon dioxide.

11. The flow rate measuring system as set forth in claim 7, wherein the mixed gas measured is natural gas.

12. A specific heat capacity calculating equation generating system, comprising:
a heater element heating each of a plurality of mixed gases;
a measuring mechanism measuring at least one of a radiation coefficient or a value for thermal conductivity for each of the plurality of mixed gases when the heater element has produced heat at a plurality of heat producing temperatures; and
a specific heat capacity calculating equation generating portion generating a specific heat capacity calculating equation, based on known values for specific heat capacities divided by thermal conductivities for each of the plurality of mixed gases and on values for radiation coefficients and thermal conductivities measured at the plurality of heat producing temperatures, using at least one of the radiation coefficients or the thermal conductivities for the plurality of heat producing temperatures as independent variables and using the specific heat capacity divided by the thermal conductivity as a dependent variable.

13. The specific heat capacity calculating equation generating system as set forth in claim 12, wherein the specific heat capacity calculating equation generating portion generates the specific heat capacity calculating equation using support vector regression.

14. A flow rate measuring system as set forth in claim 12, wherein:
a measuring mechanism measuring at least one of a radiation coefficient or a value for thermal conductivity for a mixed gas being measured when the heater element has produced heat at a plurality of heat producing temperatures;
a specific heat capacity calculating equation storing device storing a specific heat capacity calculating equation that uses at least one of the radiation coefficients or the thermal conductivities for the plurality of heat producing temperatures as independent variables and uses the specific heat capacity, divided by the thermal conductivity, as a dependent variable;
a specific heat capacity calculating portion calculating a value for the specific heat capacity divided by the thermal conductivity of the mixed gas being measured through substituting the values of at least one of the radiation coefficients or the thermal conductivities of the mixed gas being measured, for the plurality of heat producing temperatures, for the independent variables of at least one of the radiation coefficients or thermal conductivities, for the plurality of heat producing temperatures, in the specific heat capacity calculating equation;
a flow rate sensor detecting a volumetric flow rate of the mixed gas measured; and
a mass flow rate calculating portion calculating a mass flow rate of the mixed gas measured, based on the calculated value for the specific heat capacity divided by the thermal conductivity and the detected value for the volumetric flow rate of the mixed gas being measured.
